(19) United States
(12) Patent Application Publication
(10) Pub. No.: US 2012/0086628 A1
(43) Pub. Date: Apr. 12, 2012

(54) LIQUID CRYSTAL DISPLAY DEVICE AND LIGHT SOURCE CONTROL METHOD

(75) Inventors: Hideki Ichioka, Osaka-shi (JP); Takayuki Murai, Osaka-shi (JP); Kohji Fujiwara, Osaka-shi (JP)

(73) Assignee: SHARP KABUSHIKI KAISHA, Osaka-shi, Osaka (JP)

(21) Appl. No.: 13/378,872

(22) PCT Filed: Mar. 26, 2010
(86) PCT No.: PCT/JP2010/055347

§ 371 Date: Dec. 16, 2011

(30) Foreign Application Priority Data
Jul. 3, 2009 (JP) 2009-159119

(51) Int. Cl. G09G 3/36

(52) U.S. Cl. 345/102

(57) ABSTRACT

Disclosed is a liquid crystal display device including: a liquid crystal display panel; a backlight unit incorporating a PWM dimming type light source; and a control unit that controls the liquid crystal display panel and the backlight unit. The control unit obtains response speed data of orientation change of liquid crystal molecules, and changes a duty factor of a PWM dimming signal according to the response speed data. In a case where the response speed of the liquid crystal molecules is relatively high, LEDs are driven with a relatively small duty factor. In a case where the response speed of the liquid crystal molecules is relatively low, the LEDs are driven with a relatively large duty factor, and black insertion is not performed. The liquid crystal display device prevents an image quality malfunction that is apt to occur depending on the degrees of inclination of the liquid crystal molecules.

### 1. TECHNICAL FIELD

The present invention relates to a liquid crystal display device as a display device, and a method of controlling a light source incorporated in the liquid crystal display device.

### 2. BACKGROUND ART

A liquid crystal display device (display device) equipped with a non-emission type liquid crystal display panel (display panel) is usually equipped also with a backlight unit (illumination device) for supplying light to the liquid crystal display panel. There are various kinds of light sources for the backlight unit. For instance, in the case of the backlight unit disclosed in Patent Literature 1, the light source is a light emitting diode (LED).

Then, the LED is driven by known pulse width modulation (PWM) control. In particular, the LED is set to be turned on and off in time sequence during one frame period (one vertical period).

Usually, in the case of a so-called hold-type display device such as a liquid crystal display device, the same image is displayed over one frame period of a continuous frame image. Then, a person continuously views the image without interruption and may feel an afterimage or a blur.

Therefore, the liquid crystal display device disclosed in Patent Literature 1 is turned on and off in time sequence in one frame period so that an image of one frame is displayed in a pseudo-discontinuous manner (this setting of a light-off time is referred to as black insertion). In other words, the liquid crystal display device disclosed in Patent Literature 1 is driven like an impulse-type display device (for example, a display device equipped with a cathode ray tube (CRT)). Thus, this liquid crystal display device aims to improve motion picture performance, for instance.

### CITATION LIST

### Patent Literature

[PTL 1] JP 2006-53520 A

### SUMMARY OF INVENTION

### Technical Problem

However, when aiming to improve motion picture performance by the black insertion, the device is more affected by various characteristics of liquid crystal. For instance, the liquid crystal display panel changes transmittance for light from the backlight unit by inclination of liquid crystal molecules to display an image. Therefore, image quality is easily affected by inclination speed (response speed) of liquid crystal molecules. Then, depending on the response speed, an afterimage cannot be eliminated merely by changing light-on time and light-off time of the LED uniformly, and further image quality deterioration such as multiple outlines may occur.

The present invention has been made to solve the above-mentioned problem. It is an object of the present invention to provide a liquid crystal display device and the like that improves image quality by controlling a light source in consideration of characteristics of liquid crystal.

### Solution to Problem

A liquid crystal display device according to the present invention includes: a liquid crystal display panel that displays an image using liquid crystal whose orientation is changed in response to voltage application; a backlight unit incorporating a PWM dimming type light source that emits light to be supplied to the liquid crystal display panel; and a control unit that controls the liquid crystal display panel and the backlight unit. Further, in the liquid crystal display device, the control unit obtains response speed data of orientation change of the liquid crystal molecules in the liquid crystal and changes a duty factor of a PWM dimming signal according to the response speed data.

With this structure, light emission control of the light source is performed considering the response speed of the liquid crystal molecules, namely an inclination state of the liquid crystal molecules. Therefore, in this liquid crystal display device, it is possible to prevent a malfunction of image quality (such as multiple outlines) that is apt to occur according to an inclination degree of the liquid crystal molecules.

Note that, it is desired that the control unit have at least one arbitrary response speed data threshold value, set a plurality of arbitrary response speed data ranges with respect to the at least one response speed data threshold value as a boundary, and change the duty factor for each of the plurality of response speed data ranges. With this structure, the duty factor is changed in a multi-step manner, and hence it is possible to prevent a malfunction of image quality more.

In particular, it is desired that the duty factor be changed for the each of the plurality of response speed data ranges so as to have an opposite relationship to a magnitude relationship of data values in the plurality of response speed data ranges.

Specifically, when the control unit sets two response speed data ranges with respect to one response speed data threshold value, it is desired that the control unit perform the following control. That is, the control unit is configured to: drive the light source at a duty factor of arbitrary X % or smaller if the response speed data is contained in higher one of the two response speed data ranges which is equal to or larger than the response speed data threshold value; and drive the light source at a duty factor of more than the arbitrary X % if the response speed data is contained in lower one of the two response speed data ranges which is smaller than the response speed data threshold value. Note that, it is desired that the X % be 50%.

With this structure, liquid crystal having relatively high response speed is supplied with short-time light continuously with a predetermined interval corresponding to a relatively small duty factor. Then, in this case, the liquid crystal display device performs image display similar to an impulse-type display device so that the image quality can be improved. On the other hand, if short-time light is supplied to liquid crystal having relatively low response speed continuously with a predetermined interval, light is supplied to liquid crystal molecules that have not reached a predetermined angle. As a result, a malfunction of image quality may occur.

However, for such liquid crystal having relatively low response speed, the light source is driven with a relatively large duty factor in order to prevent a malfunction of image quality. Therefore, in this liquid crystal display device, image quality can be improved according to the response speed of the liquid crystal.

Further, it is desired that the light source be of PWM dimming type and be also of current dimming type, and that the control unit change a current value according to the duty factor to drive the light source. With this structure, a difference between luminance corresponding to a duty factor before the change and luminance corresponding to a duty factor after the change can be reduced.

For example, it is desired that the control unit change the current value of the PWM dimming signal in a case of driving at a duty factor other than 100%, so that an integrated amount of light emission in one cycle period of the PWM dimming signal is equal to an integrated amount of light emission at a duty factor of 100% in a period corresponding to the one cycle period. With this structure, the liquid crystal display device can change the duty factor according to the response speed of the liquid crystal while maintaining the high luminance, to thereby improve the image quality.

Note that, it is desired that the liquid crystal display device further include a first temperature sensor that measures temperature of the liquid crystal, and that the control unit include a storing portion that stores the response speed data of the liquid crystal molecules depending on liquid crystal temperature and stores at least one piece of the response speed data as a response speed data threshold value, and associate temperature data of the first temperature sensor with the liquid crystal temperature to obtain the response speed data.

By the way, the liquid crystal display device has various functions for improving image quality. Therefore, it is desired that the control unit perform setting of the duty factor corresponding to the functions.

For example, the control unit includes a histogram unit that generates a histogram of video data, to thereby generate histogram data indicating a frequency distribution for gradation. Then, the control unit divides the entire gradation of the histogram data and judges whether or not occupancy of at least one specific gradation range among divided gradation ranges exceeds an occupancy threshold value.

Then, the control unit sets the duty factor in a case where the occupancy threshold value is exceeded to be higher than the duty factor in a case where the occupancy threshold value is not exceeded, and sets the duty factor in the case where the occupancy threshold value is not exceeded to be lower than the duty factor in the case where the occupancy threshold value is exceeded. Alternatively, the control unit sets the duty factor in the case where the occupancy threshold value is exceeded to be higher than the duty factor in the case where the occupancy threshold value is not exceeded, and sets the duty factor in the case where the occupancy threshold value is not exceeded to be lower than the duty factor in the case where the occupancy threshold value is exceeded, and further changes a current value of the PWM dimming signal according to the duty factor. With this structure, the duty factor is set corresponding to a function of improving image quality using the histogram data, and hence the image quality is further improved.

Note that, it is desired that the liquid crystal display device further include a first temperature sensor that measures temperature of the liquid crystal, and that the control unit include a storing portion that stores the occupancy threshold value, and change at least one of the specific gradation range and the occupancy threshold value of the occupancy according to temperature data of the first temperature sensor.

Further, the control unit includes an FRC processing portion that performs frame rate control processing. Then, it is desired that the control unit change the duty factor, or the duty factor and a current value of the PWM dimming signal according to presence or absence of the frame rate control processing of the FRC processing portion. With this structure, the duty factor is set corresponding to ON/OFF of the FRC processing, and hence image quality is further improved.

Note that, it is desired that the duty factor in a case where the frame rate control processing is present be lower than the duty factor in a case where the frame rate control processing is absent.

Further, it is desired that the control unit include a viewing mode setting portion that switches a viewing mode of the liquid crystal display panel, and that when the viewing mode setting portion switches the viewing mode, the control unit change the duty factor, or the duty factor and a current value of the PWM dimming signal according to the selected viewing mode. With this structure, the duty factor is set corresponding to the viewing mode, and hence image quality is further improved.

Note that, in order to enable the PWM setting (setting of the duty factor and the current value of the PWM dimming signal) for each viewing mode, when the viewing mode setting portion sets a high motion picture level viewing mode and a low motion picture level viewing mode according to a motion picture level of video data, it is desired that the duty factor be changed for each of the selected viewing modes so as to have an opposite relationship to a magnitude relationship of the motion picture level in a plurality of the viewing modes.

Further, in order to enable the PWM setting (setting of the duty factor and the current value of the PWM dimming signal) for each viewing mode, when the viewing mode setting portion sets a high contrast level viewing mode and a low contrast level viewing mode according to a contrast level of video data, it is desired that the duty factor be changed for each of the selected viewing modes so as to have an opposite relationship to a magnitude relationship of the contrast level in a plurality of the viewing modes.

Further, it is desired that the control unit obtain external illuminance data and change the duty factor, or the duty factor and a current value of the PWM dimming signal according to the external illuminance data. With this structure, the duty factor is set corresponding to brightness of the environment in which the liquid crystal display device is placed, and hence image quality can be further improved.

Note that, it is desired that the duty factor be changed for each of a plurality of the illuminance data ranges so as to have an opposite relationship to a magnitude relationship of a data value of each of the plurality of illuminance data ranges.

Further, it is desired that the liquid crystal display device further include an illuminance sensor that measures external illuminance, and that the illuminance data be illuminance measured by the illuminance sensor.

By the way, the liquid crystal display panel has various different structures. For example, there is a liquid crystal display panel as follows. That is, in the liquid crystal display panel, liquid crystal is interposed between two substrates included in the liquid crystal display panel, and one of the substrates has one surface facing the liquid crystal side, on which a first electrode is mounted, and the other substrate has one surface facing the liquid crystal side, on which a second electrode is mounted.

In this case, liquid crystal molecules contained in the liquid crystal are of negative type. Further, it is desired that at least a part of the liquid crystal molecules be oriented so that a major axis direction thereof is along a direction perpendicular to the two substrates when no voltage is applied to the electrodes, and that the major axis direction thereof cross a direction of an electric field between the electrodes when a voltage is applied to the electrodes.

Note that, in the liquid crystal display device equipped with the liquid crystal display panel described above, if the duty factor is set corresponding to the function of improving the image quality using the histogram data, when the temperature data is 20° C., it is desired that a specific gradation range be from 0th or larger and 128th or smaller in the entire gradation range of 0th or larger to 255th or smaller, and that the occupancy threshold value be 50%.

Further, in the liquid crystal display device equipped with the liquid crystal display panel described above, it is desired that the first electrode have a first slit or a first rib formed therein, that the second electrode have a second slit or a second rib formed therein, and that the direction of the electric field between the electrodes cross the direction perpendicular to the two substrates.

In addition, there is another liquid crystal display panel as follows. That is, in the liquid crystal display panel, liquid crystal is interposed between two substrates included in the liquid crystal display panel, and one of the substrates has one surface facing the liquid crystal side, on which a first electrode and a second electrode are arranged to be opposed to each other.

In this case, it is desired that liquid crystal molecules contained in the liquid crystal be of positive type and be oriented so that a major axis direction thereof is along an in-plane direction of the one surface and crosses a direction in which the first electrode and the second electrode are disposed in parallel when no voltage is applied to the electrodes.

By the way, it is desired that the control unit synchronize a last timing of one frame period with a last timing of a high level period of the PWM dimming signal. With this structure, light is not supplied at an early stage of inclination of the liquid crystal molecules. In other words, light is not supplied to liquid crystal molecules that have not reached a predetermined angle, and as a result, a malfunction of image quality hardly occurs.

Further, it is desired that the control unit match a low level period of the PWM dimming signal with a period of at least one frame in continuous frames.

Further, in the liquid crystal display device, a plurality of the light sources are arranged so as to be capable of supplying light to a part of a surface of the liquid crystal display panel. Then, it is supposed that the plurality of the light sources are divided into sections so that one or more light sources in the divided section are regarded as divided section of light sources. In this case, it is desired that the control unit change the duty factor, or the duty factor and the current value of the PWM dimming signal for each divided section of light sources.

With this structure, all the light sources are not controlled entirely, but partial control can be performed so that power consumption can be reduced. In addition, the duty factor, or the duty factor and the current value can be changed locally so that partial light intensity control is realized. Therefore, a variation of luminance level is reduced so that optimal image quality can be provided.

For example, when a number of light sources in the divided section is plural, it is desired that the divided section of light sources emit light in a line in a plane of the liquid crystal display panel, in a block divided regularly in the plane, or in a part area in the plane.

Further, it is desired that the control unit have a function of performing an overdrive of an applied voltage to the liquid crystal, and change the duty factor, or the duty factor and a current value of the PWM dimming signal according to presence or absence of the overdrive. It is because even this control can realize improvement of image quality of the liquid crystal display device.

Note that, in the liquid crystal display device including: a liquid crystal display panel including liquid crystal whose orientation is changed in response to voltage application; and a backlight unit incorporating a PWM dimming type light source that emits light to be supplied to the liquid crystal display panel as described above, the light source is controlled by the following control method. That is, the control method includes the step of obtaining response speed data of orientation change of the liquid crystal molecules in the liquid crystal and changing a duty factor of a PWM dimming signal according to the response speed data.

Further, in the liquid crystal display device including: a liquid crystal display panel including liquid crystal whose orientation is changed in response to voltage application; a backlight unit incorporating a PWM dimming type light source that emits light to be supplied to the liquid crystal display panel; and a control unit that controls the liquid crystal display panel and the backlight unit as described above, the light source is controlled by the following light source control program. That is, the light source control program causes the control unit to execute the step of obtaining response speed data of orientation change of the liquid crystal molecules in the liquid crystal and changing a duty factor of a PWM dimming signal according to the response speed data.

Note that, a computer-readable recording medium that has the light source control program described above recorded thereon can be said to be included in the present invention.

### Advantageous Effects of Invention

According to the present invention, the light source is controlled to emit light according to the inclination state of the liquid crystal molecules that controls transmittance of the liquid crystal display panel. Therefore, it is possible to prevent a malfunction of image quality (such as multiple outlines) that is apt to occur according to the inclination degree of the liquid crystal molecules.

### BRIEF DESCRIPTION OF DRAWINGS

FIG. 1A block diagram of a liquid crystal display device.

FIG. 2 A detailed block diagram of a part extracted from the block diagram of the liquid crystal display device.

FIG. 3 A detailed block diagram of a part extracted from the block diagram of the liquid crystal display device.

FIG. 4 A partial cross-sectional view of a liquid crystal display panel.

FIG. 5 A perspective view indicating orientation of liquid crystal molecules when no voltage is applied to an MVA mode (slit type) liquid crystal (in the case of OFF).

FIG. 6 A perspective view indicating orientation of liquid crystal molecules when a voltage is applied to the MVA mode (slit type) liquid crystal (in the case of ON).

FIG. 7 A perspective view indicating orientation of liquid crystal molecules when no voltage is applied to an MVA mode (rib type) liquid crystal (in the case of OFF).

FIG. 8 A perspective view indicating orientation of liquid crystal molecules when a voltage is applied to the MVA mode (rib type) liquid crystal (in the case of ON).

FIG. 9 A perspective view indicating orientation of liquid crystal molecules when no voltage is applied to an IPS mode liquid crystal (in the case of OFF).

FIG. 10 A perspective view indicating orientation of liquid crystal molecules when a voltage is applied to the IPS mode liquid crystal (in the case of ON).

FIG. 11 A perspective view illustrating a comb-like pixel electrode and a comb-like counter electrode.

FIG. 12A A plan view illustrating a screen of the liquid crystal display panel displaying a person image.

FIG. 12B A plan view illustrating a screen of the liquid crystal display panel displaying a black image and a white image.

FIG. 12C A plan view illustrating a screen of the liquid crystal display panel displaying a black image and a white image.

FIG. 12D A plan view illustrating a screen of the liquid crystal display panel displaying a black image and a white image.

FIG. 12E A plan view illustrating a screen of the liquid crystal display panel displaying a black image and a white image.

FIG. 13A A graph illustrating an inclination amount of liquid crystal molecules, a waveform of a PWM dimming signal, and a luminance variation with respect to time, when liquid crystal having relatively low response speed is supplied with light from an LED driven by a PWM dimming signal with a duty factor of 100%.

FIG. 13B A graph illustrating an inclination amount of liquid crystal molecules, a waveform of a PWM dimming signal, and a luminance variation with respect to time, when liquid crystal having relatively low response speed is supplied with light from an LED driven by a PWM dimming signal with a duty factor of 50%.

FIG. 13C A graph illustrating an inclination amount of liquid crystal molecules, a waveform of a PWM dimming signal, and a luminance variation with respect to time, when liquid crystal having relatively high response speed is supplied with light from an LED driven by a PWM dimming signal with a duty factor of 100%.

FIG. 13D A graph illustrating an inclination amount of liquid crystal molecules, a waveform of a PWM dimming signal, and a luminance variation with respect to time, when liquid crystal having relatively high response speed is supplied with light from an LED driven by a PWM dimming signal with a duty factor of 50%.

FIG. 14 A graph illustrating integrated luminance at a vicinity of a boundary between a black image and a white image, and an image diagram of a boundary image (in a case where the liquid crystal has relatively low response speed, and the PWM dimming signal has a duty factor of 100%).

FIG. 15 A graph illustrating integrated luminance at a vicinity of a boundary between a black image and a white image, and an image diagram of a boundary image (in a case where the liquid crystal has relatively low response speed, and the PWM dimming signal has a duty factor of 50%).

FIG. 16 A graph illustrating integrated luminance at a vicinity of a boundary between a black image and a white image, and an image diagram of a boundary image (in a case where the liquid crystal has relatively high response speed, and the PWM dimming signal has a duty factor of 100%).

FIG. 17 A graph illustrating integrated luminance at a vicinity of a boundary between a black image and a white image, and an image diagram of a boundary image (in a case where the liquid crystal has relatively high response speed, and the PWM dimming signal has a duty factor of 50%).

FIG. 18 A table showing image quality evaluation that can be derived from FIGS. 14 to 17.

FIG. 19 A table showing a relationship between a response speed of liquid crystal molecules and a duty factor of the PWM dimming signal (black insertion ratio).

FIG. 20 A table showing with arrows a relationship between a data value at the response speed of the liquid crystal molecules and a data value at the duty factor of the PWM dimming signal (black insertion ratio).

FIG. 21A table showing with arrows a relationship between a data value at the response speed of the liquid crystal molecules and a data value at the duty factor of the PWM dimming signal (black insertion ratio).

FIG. 22 A table showing with arrows a relationship among a data value of liquid crystal temperature, a data value at the response speed of the liquid crystal molecules, and a data value at the duty factor of the PWM dimming signal (black insertion ratio).

FIG. 23A An explanatory diagram illustrating a relationship between the luminance and the waveform of the PWM dimming signal having the same current value (where the duty factor is 100% and 50%).

FIG. 23B An explanatory diagram illustrating a relationship between the luminance and the waveform of the PWM dimming signal having a current value adjusted to be the same luminance as the luminance at the duty factor of 100% illustrated in FIG. 23A (where the duty factor is 80%).

FIG. 23C An explanatory diagram illustrating a relationship between the luminance and the waveform of the PWM dimming signal having a current value adjusted to be the same luminance as the luminance at the duty factor of 100% illustrated in FIG. 23A (where the duty factor is 60%).

FIG. 23D An explanatory diagram illustrating a relationship between the luminance and the waveform of the PWM dimming signal having a current value adjusted to be the same luminance as the luminance at the duty factor of 100% illustrated in FIG. 23A (where the duty factor is 50%).

FIG. 24 A table showing with arrows a relationship among a data value of liquid crystal temperature, a data value at the response speed of the liquid crystal molecules, a data value at the duty factor of the PWM dimming signal (black insertion ratio), and a data value at the current value of the PWM dimming signal.

FIG. 25 A flowchart in a case where the duty factor of the PWM dimming signal is set considering that there is FRC processing.

FIG. 26 A table showing a relationship between presence or absence of the FRC processing and the duty factor of the PWM dimming signal (black insertion ratio).

FIG. 27 A flowchart in a case where the duty factor of the PWM dimming signal is set considering a viewing mode (change of motion picture level).

FIG. 28 A table showing a relationship between the motion picture level and the duty factor of the PWM dimming signal (black insertion ratio).

FIG. 29 A flowchart in a case where the duty factor of the PWM dimming signal is set considering the viewing mode (change of contrast ratio).

FIG. 30 A table showing a relationship between the contrast ratio and the duty factor of the PWM dimming signal (black insertion ratio).

FIG. 31A flowchart in a case where the duty factor of the PWM dimming signal is set considering the viewing mode (both the motion picture level and the contrast ratio).

FIG. 32 A flowchart in a case where the duty factor of the PWM dimming signal is set considering an environmental support function.

FIG. 33 A table showing a relationship between illuminance data that is used for the environmental support function and the duty factor of the PWM dimming signal (black insertion ratio).

FIG. 34 A graph illustrating a relationship between a gradation value and a response time of the liquid crystal molecules (in the case of the MVA mode liquid crystal where liquid crystal temperature is relatively high).

FIG. 35 A graph illustrating a relationship between a gradation value and a response time of the liquid crystal molecules (in the case of the MVA mode liquid crystal where liquid crystal temperature is relatively low).

FIG. 36 A flowchart in a case where the duty factor of the PWM dimming signal is set considering a video signal support function.

FIG. 37 A table showing a relationship among occupancy of a specific gradation range used in the video signal support function, the gradation value, and the duty factor of the PWM dimming signal (black insertion ratio) (where the liquid crystal is of the MVA mode).

FIG. 38 A graph illustrating a relationship between the gradation value and the response time of the liquid crystal molecules (in the case where liquid crystal temperature is relatively high in the IPS mode liquid crystal).

FIG. 39 A graph illustrating a relationship between the gradation value and the response time of the liquid crystal molecules (in the case where liquid crystal temperature is relatively low in the IPS mode liquid crystal).

FIG. 40 A flowchart in a case where the duty factor of the PWM dimming signal is set considering various functions.

FIG. 41A graph illustrating integrated luminance at a vicinity of a boundary between a black image and a white image (in the case where the liquid crystal has relatively low response speed and the PWM dimming signal has a duty factor of 70%).

FIG. 42 A graph illustrating integrated luminance at a vicinity of a boundary between a black image and a white image (in the case where the liquid crystal has relatively low response speed and the PWM dimming signal has a duty factor of 30%).

FIG. 43 A graph illustrating integrated luminance at a vicinity of a boundary between a black image and a white image (in the case where the liquid crystal has relatively high response speed and the PWM dimming signal has a duty factor of 70%).

FIG. 44 A graph illustrating integrated luminance at a vicinity of a boundary between a black image and a white image (in the case where the liquid crystal has relatively high response speed and the PWM dimming signal has a duty factor of 30%).

FIG. 45 A block diagram of a liquid crystal display device.

FIG. 46 A detailed block diagram of a part extracted from the block diagram of the liquid crystal display device.

FIG. 47 A detailed block diagram of a part extracted from the block diagram of the liquid crystal display device.

FIG. 48A A graph illustrating an inclination amount of liquid crystal molecules, a waveform of a PWM dimming signal, and a luminance variation with respect to time, when liquid crystal having relatively low response speed is supplied with light from an LED driven by a PWM dimming signal having a duty factor of 50% (where a drive frequency of the PWM dimming signal is 120 Hz).

FIG. 48B A graph illustrating an inclination amount of liquid crystal molecules, a waveform of a PWM dimming signal, and a luminance variation with respect to time, when liquid crystal having relatively low response speed is supplied with light from an LED driven by a PWM dimming signal having a duty factor of 50% (where a drive frequency of the PWM dimming signal is 480 Hz).

FIG. 49 A graph illustrating integrated luminance at a vicinity of a boundary between a black image and a white image, and an image diagram of a boundary image (in the case where the liquid crystal has relatively low response speed, and the PWM dimming signal has a drive frequency of 480 HZ and a duty factor of 50%).

FIG. 50 A table showing a relationship between a response speed of the liquid crystal molecules and a drive frequency of the PWM dimming signal.

FIG. 51 A table showing with arrows a relationship between a data value at the response speed of the liquid crystal molecules and a data value at the drive frequency of the PWM dimming signal.

FIG. 52 A table showing with arrows a relationship between a data value at the response speed of the liquid crystal molecules and a data value at the drive frequency of the PWM dimming signal.

FIG. 53 A table showing with arrows a relationship among a data value at liquid crystal temperature, a data value at the response speed of the liquid crystal molecules, and a data value at the drive frequency of the PWM dimming signal.

FIG. 54 A flowchart in a case where the drive frequency of the PWM dimming signal is set considering that there is a video signal support function.

FIG. 55 A table showing a relationship among occupancy of a specific gradation range that is used in the video signal support function, luminance, the duty factor of the PWM dimming signal, and the drive frequency of the PWM dimming signal (where the liquid crystal is of the MVA mode).

FIG. 56 A flowchart in a case where the drive frequency of the PWM dimming signal is set considering that there is FRC processing.

FIG. 57 A table showing a relationship between presence or absence of the FRC processing and the drive frequency of the PWM dimming signal.

FIG. 58 A flowchart in a case where the drive frequency of the PWM dimming signal is set considering a viewing mode (change of motion picture level).

FIG. 59 A table showing a relationship between the motion picture level and the drive frequency of the PWM dimming signal.

FIG. 60 A flowchart in a case where the drive frequency of the PWM dimming signal is set considering the viewing mode (change of contrast ratio).

FIG. 61 A table showing a relationship between the contrast ratio and the drive frequency of the PWM dimming signal.

FIG. 62 A flowchart in a case where the drive frequency of the PWM dimming signal is set considering the viewing mode (both the motion picture level and the contrast ratio).

FIG. 63 A flowchart in a case where the drive frequency of the PWM dimming signal is set considering an environmental support function.

FIG. 64 A table showing a relationship between illuminance data that is used in the environmental support function and the drive frequency of the PWM dimming signal.

FIG. 65 A flowchart in a case where the drive frequency of the PWM dimming signal is set considering various functions.

FIG. 66 A flowchart in a case where the drive frequency of the PWM dimming signal is set considering various functions.

FIG. 67 A signal waveform diagram in which waveforms of the PWM dimming signals at 120 Hz, 480 Hz, and 60 Hz are arranged in parallel.

FIG. 68A A graph illustrating an inclination amount of liquid crystal molecules, a waveform of a PWM dimming signal, and a luminance variation with respect to time, when liquid crystal having relatively low response speed is supplied with light from an LED driven by a PWM dimming signal having a duty factor of 50% (where a drive frequency of the PWM dimming signal is 120 Hz, and a voltage applied to the liquid crystal is not overdrive).

FIG. 68B A graph illustrating an inclination amount of liquid crystal molecules, a waveform of a PWM dimming signal, and a luminance variation with respect to time, when liquid crystal having relatively low response speed is supplied with light from an LED driven by a PWM dimming signal having a duty factor of 50% (where a drive frequency of the PWM dimming signal is 120 Hz, and a voltage applied to the liquid crystal is overdrive).

FIG. 69 A graph illustrating integrated luminance at a vicinity of a boundary between a black image and a white image.

FIG. 70 An exploded perspective view of a liquid crystal display device.

FIG. 71 A plan view illustrating in parallel a liquid crystal display panel that displays a white image in the middle and a black image around the white image, and a backlight unit corresponding to the images of the liquid crystal display panel.

FIG. 72 An exploded perspective view of a liquid crystal display device.

FIG. 73 A perspective view indicating orientation of liquid crystal molecules when no voltage is applied to a VA-IPS mode liquid crystal (in the case of OFF).

FIG. 74 A perspective view indicating orientation of liquid crystal molecules when a voltage is applied to the VA-IPS mode liquid crystal (in the case of ON).

FIG. 75 A graph illustrating a relationship between a gradation value and a response time of the liquid crystal molecules (in the case of the VA-IPS mode liquid crystal where liquid crystal temperature is relatively high).

FIG. 76 A graph illustrating a relationship between a gradation value and a response time of the liquid crystal molecules (in the case of the VA-IPS mode liquid crystal where liquid crystal temperature is relatively low).

FIG. 77 A graph illustrating a relationship between a gradation value and a response time of the liquid crystal molecules (in the cases of the MVA mode, IPS mode, and VA-IPS mode liquid crystals where liquid crystal temperature is relatively high).

FIG. 78 A graph illustrating a relationship between a gradation value and a response time of the liquid crystal molecules (in the cases of the MVA mode, IPS mode, and VA-IPS mode liquid crystals where liquid crystal temperature is relatively high).

FIG. 79 A table showing a relationship among occupancy of a specific gradation range that is used in the video signal support function, the gradation value, and the duty factor of the PWM dimming signal (black insertion ratio) (where the liquid crystal is of the VA-IPS mode).

FIG. 80 A table showing a relationship among occupancy of the specific gradation range that is used in the video signal support function, luminance, the duty factor of the PWM dimming signal, and the drive frequency of the PWM dimming signal (where the liquid crystal is of the VA-IPS mode).

### DESCRIPTION OF EMBODIMENTS

### First Embodiment

Embodiments are described below with reference to the drawings. Note that, symbols of some members are omitted for convenience sake, and other diagram should be referred to in such case. In addition, a symbol indicating a signal type may be attached to an arrow indicating propagation of signal, and the arrow does not mean propagation of only the signal type. In addition, a flowchart illustrating action steps is an example and is not limited to only the flow of action.

In addition, numerical examples and graphs that are described herein are merely examples, and are not limited to the values and graph lines. Note that, hereinafter, a liquid crystal display device is described as an example of a display device, but the present invention is not limited thereto. The display device may be other type of display device.

<In Regard to Liquid Crystal Display Device>

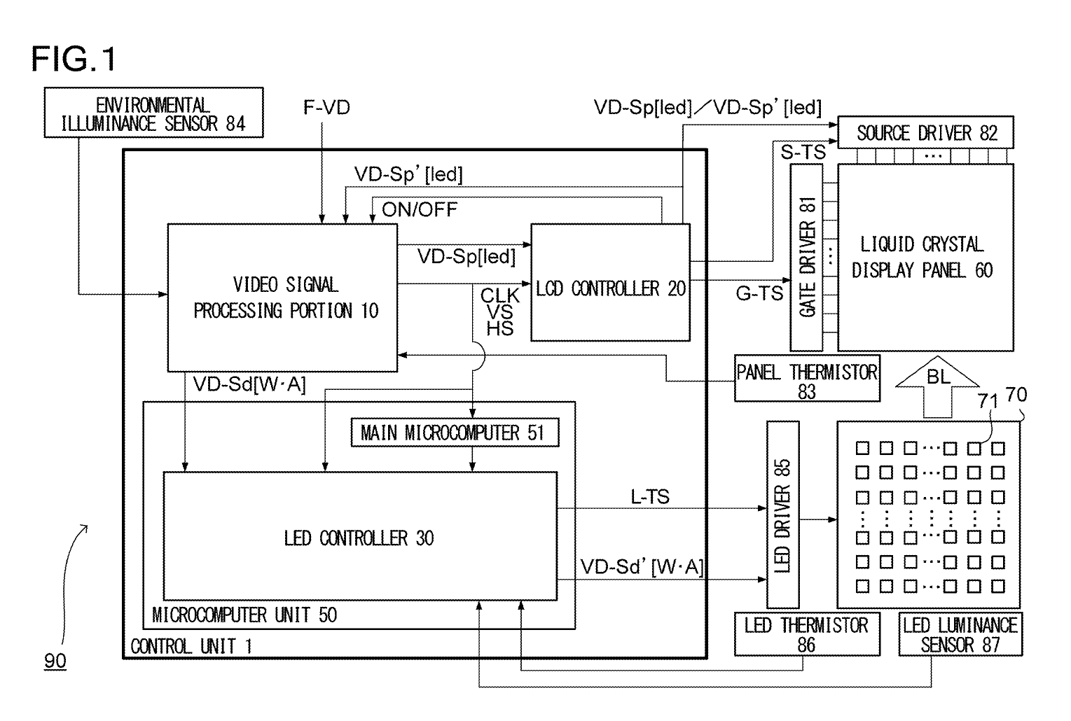

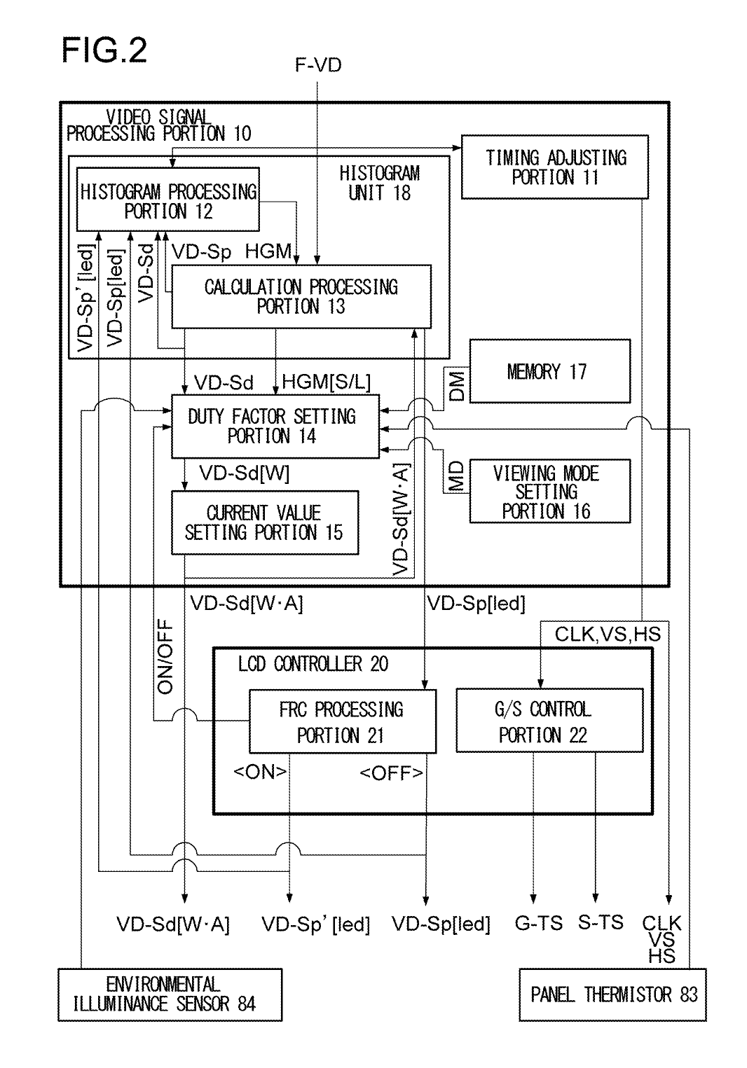

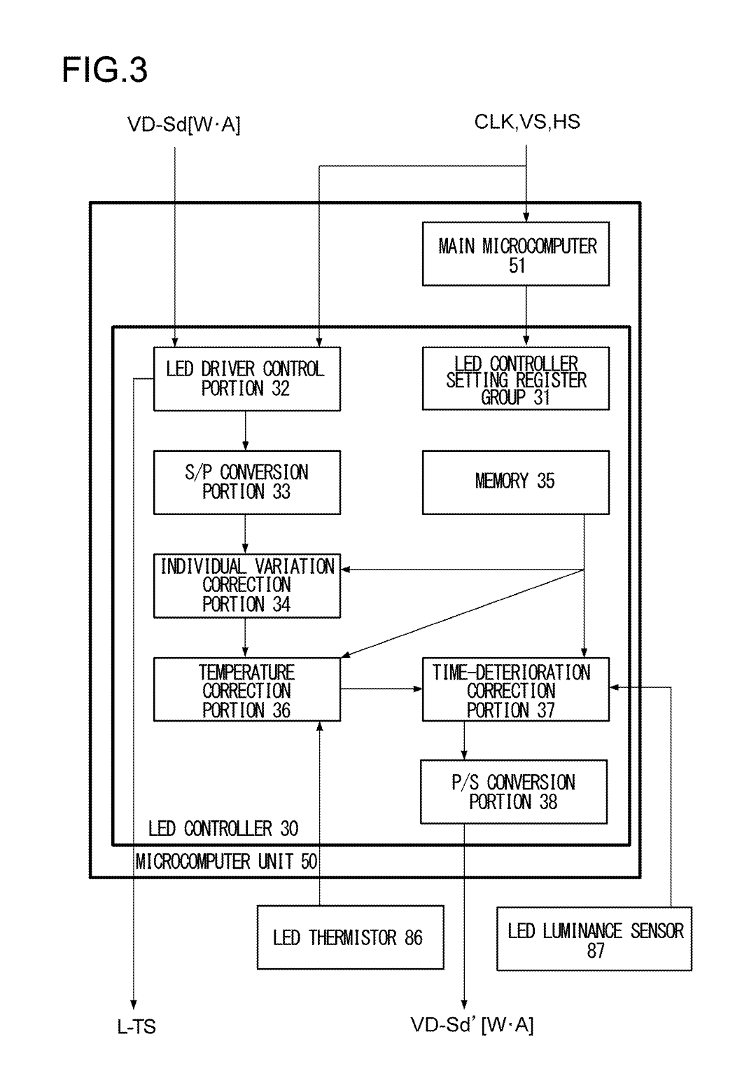

FIGS. 1 to 3 are block diagrams illustrating various members concerning a liquid crystal display device 90 (note that, FIGS. 2 and 3 are detailed block diagrams of parts extracted from FIG. 1). As illustrated in FIG. 1, the liquid crystal display device 90 includes a liquid crystal display panel 60, a backlight unit 70, a gate driver 81, a source driver 82, a panel thermistor 83, an environmental illuminance sensor 84, an LED driver 85, an LED thermistor 86, an LED luminance sensor 87, and a control unit 1.

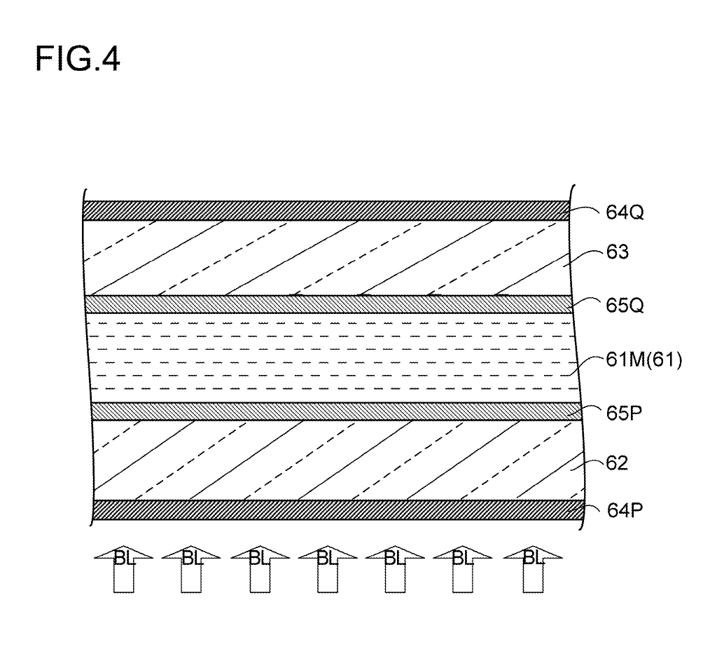

In the liquid crystal display panel 60, liquid crystal 61 (liquid crystal molecules 61M) is sandwiched between an active matrix substrate 62 and a counter substrate 63 (see FIG. 4 to be referred to later), and the liquid crystal 61 is sealed using a sealing member (not shown). Note that, on the active matrix substrate 62, gate signal lines and source signal lines are arranged to cross each other, and further at intersections of the signal lines, there are disposed switching elements (for example, thin film transistors) for adjusting an applied voltage to the liquid crystal 61.

The backlight unit 70 includes, for example, light sources (light emitting elements) such as light emitting diodes (LEDs) 71 as illustrated in FIG. 1. Light from the LEDs 71 is supplied to the non-emission type liquid crystal display panel 60. Then, in the liquid crystal display device 90, orientation of the liquid crystal molecules 61M is adjusted according to the applied voltage, and hence transmittance of the liquid crystal 61 is partially changed (namely, light intensity of light transmitted to the outside from the backlight unit 70 is changed). Thus, a displayed image is changed.

Note that, there are various types of LEDs 71 included in the backlight unit 70. Examples of the LEDs 71 include LEDs that emit white color light, red color light, green color light, or blue color light.

However, in a case of the LED 71 that emits white color light, because all the LEDs 71 of the backlight unit 70 are the white color emission type, the backlight has also white color. Note that, there are various methods of generating white color. For instance, the LED 71 may include a red color LED chip, a green color LED chip, and a blue color LED chip so as to generate white color as the mixed color. Alternatively, the LED 71 may use fluorescent light emission to generate white color.

On the contrary, in a case of the LED 71 that emits light other than white color light, because the white color backlight is generated as the mixed color, the LEDs 71 included in the backlight unit 70 are red color emission type LEDs 71, green color emission type LEDs 71, and blue color emission type LEDs 71.

Note that, the arrangement of the LEDs 71 is not limited regardless of the type of the LEDs 71. An example of the arrangement is a matrix arrangement as illustrated in FIG. 1. In addition, the LED 71 is driven by known pulse width modulation (PWM) control.

The gate driver 81 is a driver that supplies the gate signal lines of the liquid crystal display panel 60 with a gate signal G-TS as a control signal (timing signal) for the switching elements. Note that, the gate signal G-TS is generated by the control unit 1.

The source driver 82 is a driver that supplies the source signal lines of the liquid crystal display panel 60 with a write signal for the pixel as an example of image data (LCD video signal VD-Sp′[led] or LCD video signal VD-Sp[led] to be described later in detail). Specifically, the source driver 82 supplies the write signal to the source signal lines based on a timing signal S-TS generated by the control unit 1 (note that, the write signal and the timing signal S-TS are generated by the control unit 1).

The panel thermistor (first temperature sensor) 83 is a temperature sensor that measures temperature of the liquid crystal display panel 60, specifically, temperature of the liquid crystal 61 included in the liquid crystal display panel 60. Details of use of this panel thermistor 83 are described later.

The environmental illuminance sensor 84 is a photometric sensor that measures illuminance of the environment in which the liquid crystal display device 90 is placed. Details of use of this environmental illuminance sensor 84 are described later.

The LED driver 85 supplies a control signal for the LED (VD-Sd′[W·A]) to the LED 71 based on a timing signal (L-TS) generated by the control unit 1 (note that, the control signal for the LED 71 is generated by the control unit 1). Specifically, the LED driver 85 controls lighting of the LED 71 in the backlight unit 70 based on signals from an LED controller 30 (PWM dimming signal VD-Sd′[W·A] and timing signal L-TS).

The LED thermistor 86 is a temperature sensor that measures temperature of the LED 71 incorporated in the backlight unit 70. Details of use of this LED thermistor 86 are described later.

The LED luminance sensor 87 is a photometric sensor that measures luminance of the LED 71. Details of use of this LED luminance sensor 87 are described later.

<In Regard to Control Unit>

The control unit 1 is a control unit that generates the above-mentioned various signals and includes a main microcomputer 51, a video signal processing portion 10, a liquid crystal display panel controller (LCD controller) 20, and the LED controller 30.

<<Main Microcomputer>>

The main microcomputer 51 performs various controls concerning the video signal processing portion 10, the liquid crystal display panel controller 20, and the LED controller 30 included in the control unit 1 (note that, the main microcomputer 51 and the LED controller 30 controlled by the main microcomputer 51 may be referred to generically as microcomputer unit 50).

<<Video Signal Processing Portion>>

The video signal processing portion 10 includes, as illustrated in FIG. 2, a timing adjusting portion 11, a histogram processing portion 12, a calculation processing portion 13, a duty factor setting portion 14, a current value setting portion 15, a viewing mode setting portion 16, and a memory 17.

The timing adjusting portion 11 receives an initial image signal (initial image signal F-VD) from an external signal source. The initial image signal F-VD is, for example, a television signal containing a video signal and a synchronizing signal that synchronizes with the video signal (note that, the video signal consists of a red color video signal, a green color video signal, a blue color video signal, and a luminance signal, for example).

Therefore, the timing adjusting portion 11 generates, from the synchronizing signal, new synchronizing signals necessary for image display of the liquid crystal display panel 60 (clock signal CLK, vertical synchronizing signal VS, horizontal synchronizing signal HS, and the like). Then, the timing adjusting portion 11 transmits the generated new synchronizing signals to the liquid crystal display panel controller 20 and the microcomputer unit 50 (see FIGS. 1 and 2).

The histogram processing portion 12 receives the initial image signal F-VD and generates a histogram of the video signal (video data) included in the initial image signal F-VD. Specifically, the histogram processing portion 12 obtains a frequency distribution of each gradation in the initial image signal F-VD for each frame.

However, the data from which a histogram is generated is not limited to the initial image signal F-VD. For instance, a histogram may be generated from a separator LED signal VD-Sd, a separator LCD signal VD-Sp, the LCD video signal VD-Sp[led], or the LCD video signal VD-Sp′[led] subjected to frame rate control processing, which are described later (in other words, a histogram can be generated from those various video signals (video data)). Note that, data of the histogram is referred to as histogram data HGM. Then, the histogram data HGM is transmitted to the calculation processing portion 13 by the histogram processing portion 12.

The calculation processing portion 13 receives the initial image signal F-VD and splits the initial image signal F-VD into a signal suitable for driving the backlight unit 70 (specifically, the LED 71) and a signal suitable for driving the liquid crystal display panel 60. Then, the calculation processing portion 13 transmits the separator LED signal VD-Sd suitable for the LED 71 in the initial image signal F-VD to the duty factor setting portion 14.

In addition, the calculation processing portion 13 corrects the separator LCD signal VD-Sp suitable for the liquid crystal display panel 60 in the initial image signal F-VD and then transmits the corrected signal to the liquid crystal display panel controller 20. Note that, this correction processing is performed considering a control signal for the LED 71 to be described later (PWM dimming signal VD-Sd[W·A]) (the corrected separator LED signal VD-Sp is the LCD video signal VD-Sp[led]).

In addition, the calculation processing portion 13 may transmit the separator LCD signal VD-Sp to the histogram processing portion 12 to generate a histogram therefrom.

Further, the calculation processing portion 13 uses the histogram data HGM to determine at least one of histogram data HGM [S] of an average signal level (ASL) and histogram data HGM [L] of an average luminance level (ALL).

In other words, the calculation processing portion 13 can determine the histogram data HGM of at least one of the average signal level ASL and the average luminance level ALL from the initial image signal F-VD, the separator LED signal VD-Sd, the separator LCD signal VD-Sp, the LCD video signal VD-Sp[led], or the LCD video signal VD-Sp′[led], and further transmits the determined histogram data HGM to the duty factor setting portion 14.

In addition, the calculation processing portion 13 can determine at least one of an average value of the average signal level ASL and an average value of the average luminance level ALL, and further transmits the resultant to the duty factor setting portion 14. Note that, the histogram processing portion 12 and the calculation processing portion 13 perform various kinds of processing concerning the various pieces of histogram data HGM, and hence are referred to as histogram unit 18.

The duty factor setting portion 14 receives the separator LED signal VD-Sd. Further, the duty factor setting portion 14 receives the histogram data HGM from the calculation processing portion 13. In addition, the duty factor setting portion 14 receives a signal (memory data DM) from the memory 17 to be described later, and also receives at least one signal of the viewing mode setting portion 16, the panel thermistor 83, the LED controller 30 (specifically, FRC processing portion 21 to be described later), and the environmental illuminance sensor 84.

Then, the duty factor setting portion 14 generates a PWM dimming signal suitable for controlling the LED 71 from at least one of those signals and the separator LED signal VD-Sd (details are described later). Specifically, the duty factor setting portion 14 sets the duty factor of the PWM dimming signal (note that, the PWM dimming signal whose duty factor has been set by the duty factor setting portion 14 is referred to as PWM dimming signal VD-Sd[W]).

Note that, the duty factor is a ratio of a period of lighting the LED 71 in one cycle of the PWM dimming signal (AC signal). In other words, if the duty factor is 100%, it means that the LED 71 is lit continuously during one cycle (on the contrary, if the duty factor is 60%, the LED 71 is off in a period of 40% of the cycle).

The current value setting portion 15 receives the PWM dimming signal VD-Sd[W] from the duty factor setting portion 14, and changes a current value of the PWM dimming signal VD-Sd[W]. Details of this changing of the current value are described later. Note that, the PWM dimming signal VD-Sd[W] whose current value has been set appropriately is referred to as PWM dimming signal VD-Sd[W·A]. Then, this PWM dimming signal VD-Sd[W·A] is transmitted by the current value setting portion 15 to the microcomputer unit 50 (specifically, the LED controller 30) and is also transmitted to the calculation processing portion 13.

The viewing mode setting portion 16 determines a display form of an image (viewing mode), depending on the type of an image displayed on the liquid crystal display panel 60, the environment where the liquid crystal display device 90 is placed, or the preference of the viewer (desired contrast ratio or the like). The viewing mode setting portion 16 can set the viewing mode as described below, for example.

Sports Mode, which is a viewing mode suitable for displaying an image with fast movement, such as a football player, that is, a viewing mode with a relatively high motion picture level.

Natural Mode, which is a viewing mode suitable for displaying an image with slow movement, such as in a news program, that is, a viewing mode with a relatively low motion picture level.

Dynamic Mode, which is a viewing mode in which a contrast between a white image and a black image is enhanced, that is, a viewing mode for relatively increasing the contrast level.

Cinema Mode, which is a viewing mode in which a contrast between a white image and a black image is not enhanced, that is, a viewing mode for relatively decreasing the contrast level.

Standard Mode, which is an intermediate viewing mode between Dynamic Mode and Cinema Mode.

Note that, in view of those viewing modes, in particular, Sports Mode and Natural Mode, the viewing mode setting portion 16 can set a high motion picture level viewing mode or a low motion picture level viewing mode depending on the motion picture level of the video signal (video data), (note that, the setting is not limited to the two-step level setting).

Further, in view of Dynamic Mode, Standard Mode, and Cinema Mode, the viewing mode setting portion 16 can set a high contrast level viewing mode, an intermediate contrast level viewing mode, or a low contrast level viewing mode depending on the contrast level of the video signal (video data) (note that, the setting is not limited to the three-step level setting).

The memory (storing portion) 17 stores various data tables, various threshold data (threshold values), and the like that are necessary for setting the duty factor by the duty factor setting portion 14. To give an example, the memory 17 stores a temperature-speed data table in which temperature of the panel thermistor 83 and response speed Vr of the liquid crystal molecules 61M are associated to each other. Further, the memory 17 stores a certain response speed Vr in the temperature-speed data table as a threshold value (response speed data threshold value). Note that, the number of the threshold values may be one or more.

In addition, the memory 17 stores a threshold value (gradation threshold value data) for dividing all gradations in the histogram data HGM generated by the average signal level ASL or the average luminance level ALL. In other words, the histogram data HGM is divided into at least two or more gradation ranges by the gradation threshold value. Further, the memory 17 stores a threshold value (occupancy threshold value) for judging whether occupancy of a specific gradation range in the histogram data HGM (at least one divided gradation range) is larger than a predetermined value or not.

<<LCD Controller>>

The LCD controller 20 includes the frame rate control processing (FRC processing portion) 21 and a gate/source driver control portion (G/S control portion) 22.

The FRC processing portion 21 receives the LCD video signal VD-Sp[led] transmitted from the video signal processing portion 10 (specifically, the calculation processing portion 13). Then, the FRC processing portion 21 performs FRC processing of switching the frame rate of the LCD video signal VD-Sp[led] at high speed in order to display the image in a pseudo manner by an afterimage effect (note that, the LCD video signal VD-Sp[led] after the FRC processing is the LCD video signal VD-Sp′[led]).

Note that, the FRC processing portion 21 can switch between ON and OFF. Therefore, when the FRC processing portion 21 is performing the FRC processing for realizing double speed, if the LCD video signal VD-Sp′[led] is at 120 Hz, the LCD video signal VD-Sp[led] is at 60 Hz (the signals can be regarded as frame frequencies).

Then, the FRC processing portion 21 transmits the LCD video signal VD-Sp′[led] after the FRC processing or the LCD video signal VD-Sp[led] without the FRC processing to the source driver 82 (see FIG. 1).

The G/S control portion 22 generates timing signals for controlling the gate driver 81 and the source driver 82 from the clock signal CLK, the vertical synchronizing signal VS, the horizontal synchronizing signal HS, and the like that are transmitted from the video signal processing portion 10 (specifically, the timing adjusting portion 11) (note that, the timing signal corresponding to the gate driver 81 is the timing signal G-TS, and the timing signal corresponding to the source driver 82 is the timing signal S-TS). Then, the G/S control portion 22 transmits the timing signal G-TS to the gate driver 81 and transmits the timing signal S-TS to the source driver 82 (see FIG. 1).

In other words, the LCD controller 20 transmits the LCD video signal VD-Sp′[led] (or LCD video signal VD-Sp[led]) and the timing signal S-TS to the source driver 82, and transmits the timing signal G-TS to the gate driver 81. Then, the source driver 82 and the gate driver 81 control an image on the liquid crystal display panel 60 using both the timing signals G-TS and S-TS.

<<LED Controller>>

The LED controller 30 transmits various control signals to the LED driver 85 under control of the main microcomputer 51. Further, this LED controller 30 includes, as illustrated in FIG. 3, an LED controller setting register group 31, an LED driver control portion 32, a serial to parallel conversion portion (S/P conversion portion) 33, an individual variation correction portion 34, a memory 35, a temperature correction portion 36, a time-deterioration correction portion 37, and a parallel to serial conversion portion (P/S conversion portion) 38.

The LED controller setting register group 31 temporarily stores the various control signals from the main microcomputer 51. In other words, the main microcomputer 51 controls the various members inside the LED controller 30 via the LED controller setting register group 31.

The LED driver control portion 32 transmits the PWM dimming signal VD-Sd[W·A] from the video signal processing portion 10 (specifically, the current value setting portion 15) to the S/P conversion portion 33. In addition, the LED driver control portion 32 generates a lighting timing signal L-TS for the LED 71 based on the synchronizing signals (clock signal CLK, vertical synchronizing signal VS, horizontal synchronizing signal HS, and the like) from the video signal processing portion 10, and transmits the generated signal to the LED driver 85.

The S/P conversion portion 33 converts the PWM dimming signal VD-Sd[W·A], which is transmitted from the LED driver control portion 32 in the form of serial data, into parallel data.

The individual variation correction portion 34 checks individual performances of the LEDs 71 in advance and performs correction for eliminating individual errors. For instance, luminance of the LED 71 is measured in advance by a specific PWM dimming signal value. Specifically, for example, the LED chip of red color light emission, the LED chip of green color light emission, and the LED chip of blue color light emission of each LED 71 are lit on, and the specific PWM dimming signal value corresponding to each LED chip is corrected so that white color light having desired tint can be generated.

Next, a plurality of the LEDs 71 are lit on, and the PWM dimming signal value corresponding to each LED 71 (each LED chip) is further corrected so as to eliminate luminance unevenness as planar light. Thus, the individual differences of the plurality of LEDs 71 (individual variation of luminance, and by extension luminance unevenness of the planar light) can be corrected.

Note that, there are various ways of the correction processing, but correction processing using an ordinary lookup table (LUT) is adopted. In other words, the individual variation correction portion 34 performs the correction processing with an individual variation LUT of the LEDs 71 stored in the memory 35.

The memory 35 stores the individual variation LUT of the LEDs 71 as described above, for example. In addition, the memory 35 also stores the LUT that is necessary for the temperature correction portion 36 and the time-deterioration correction portion 37 provided at subsequent stages of the individual variation correction portion 34.

The temperature correction portion 36 performs correction considering a luminance decrease of the LED 71 due to a temperature increase accompanying light emission of the LED 71. For instance, the temperature correction portion 36 obtains temperature data of the LED 71 (namely, the LED chip of each color) with the LED thermistor 86 once every second, and obtains the LUT corresponding to the temperature data from the memory 35. Then, the temperature correction portion 36 performs correction processing of suppressing the luminance unevenness of the planar light (namely, change of the PWM dimming signal value corresponding to the LED chip).

The time-deterioration correction portion 37 performs correction considering a luminance decrease of the LED 71 due to time-deterioration of the LED 71. For instance, the time-deterioration correction portion 37 obtains luminance data of the LED 71 (namely, the LED chip of each color) with the LED luminance sensor 87 once every year, and obtains the LUT corresponding to the luminance data from the memory 35. Then, the time-deterioration correction portion 37 performs correction processing of suppressing luminance unevenness of the planar light (namely, change of the PWM dimming signal value corresponding to the LED chip of each color).

The P/S conversion portion 38 converts the PWM dimming signal after various kinds of correction processing transmitted as the parallel data (the PWM dimming signal after the correction processing by the LED controller 30 is the PWM dimming signal VD-Sd′[W·A]) into serial data, and transmits the converted data to the LED driver 85. Then, the LED driver 85 controls lighting of the LED 71 in the backlight unit 70 based on the PWM dimming signal VD-Sd′[W·A] and the timing signal L-TS.

<In Regard to PWM Dimming Signal for Light Emission Control of LED>

Here, the PWM dimming signal VD-Sd[W] for controlling light emission of the LED 71 is described. The duty factor of the PWM dimming signal VD-Sd[W] is changed according to the response speed Vr of the orientation change of the liquid crystal molecules 61M (note that, considering not only the response speed Vr but also various correction results by the LED controller 30 and the like, the duty factor of the PWM dimming signal that is directly input to the LED 22 is set to be a desired value).

<<Response Speed of Liquid Crystal Molecules>>

Now, first, the response speed Vr of the liquid crystal molecules 61M is described with reference to FIGS. 4 to 8. FIG. 4 is a partial cross-sectional view of the liquid crystal display panel 60. As illustrated in the figure, in the liquid crystal display panel 60, the active matrix substrate 62 on which switching elements such as thin film transistors (not shown) and pixel electrodes 65P are arranged and the counter substrate 63 on which counter electrodes 65Q are arranged and which is opposed to the active matrix substrate 62 are bonded to each other via a sealing member (not shown). Then, the liquid crystal 61 is sealed in a gap between the substrates 62 and 63 (specifically, between the electrodes 65P and 65Q).

In addition, in the liquid crystal display panel 60, polarizing films 64P and 64Q are attached to sandwich the active matrix substrate 62 and the counter substrate 63. Then, the polarizing film 64P transmits specific polarized light of backlight BL from the backlight unit 70 and guides the light to the liquid crystal (liquid crystal layer) 61. The polarizing film 64Q transmits specific polarized light of light passing through the liquid crystal layer 61 and guides the light to the outside.

However, the light passing through the liquid crystal display panel 60 is affected, during the passing, by the orientation of the liquid crystal molecules 61M corresponding to voltage application, namely the inclination of the liquid crystal molecules 61M. Specifically, intensity of externally transmitting light changes according to a change of transmittance of the liquid crystal display panel 60 due to the inclination of the liquid crystal molecules 61M. Therefore, the liquid crystal display panel 60 displays an image utilizing the change in transmittance due to the inclination of the liquid crystal molecules 61M corresponding to the voltage application.

The liquid crystal display panel 60 is supposed to have various modes. For instance, there are a twist nematic (TN) mode, a vertical alignment (VA) mode, an in-plane switching (IPS) mode, and an optically compensated bend (OCB) mode. However, in any mode, the intensity of light entering the liquid crystal 61 is changed by the orientation of the liquid crystal molecules 61M.

(MVA Mode)

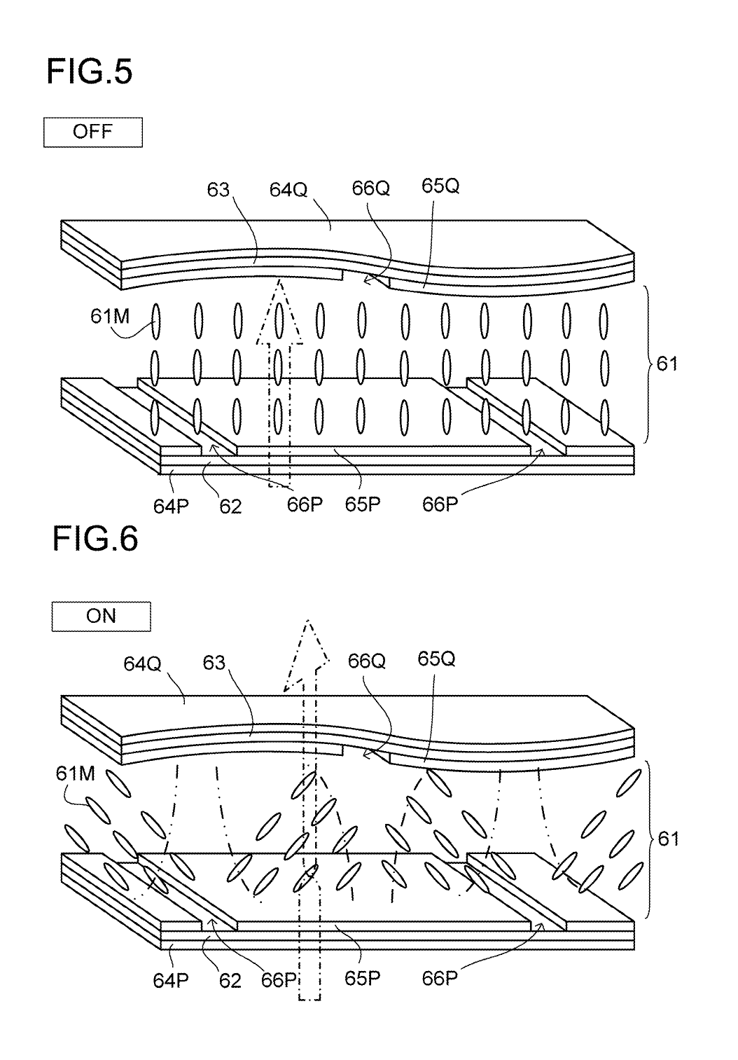

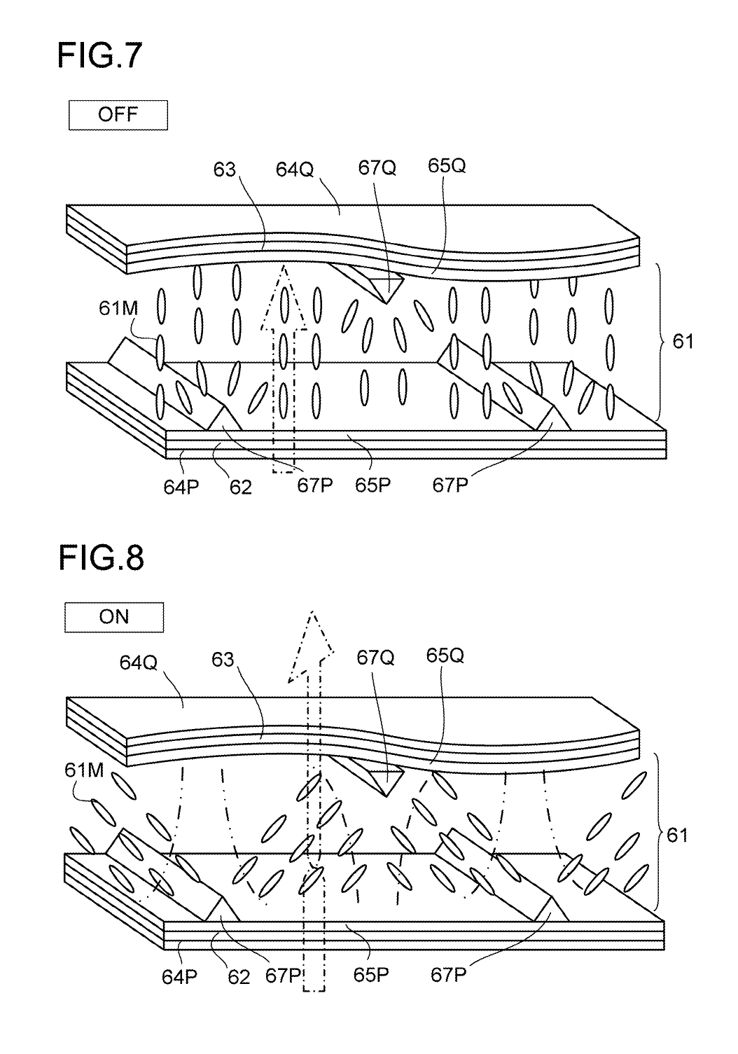

For instance, a multi-domain vertical alignment (MVA) mode as one type of the VA mode is described below with reference to FIGS. 5 and 6 (note that, in the figures and FIGS. 7 to 10 to be referred to later, an arrow formed of a dotted dashed line means light).

The liquid crystal 61 including the liquid crystal molecules 61M illustrated in FIGS. 5 and 6 is a negative type liquid crystal having negative dielectric anisotropy. Further, on one surface of the active matrix substrate 62 facing the liquid crystal 61, the pixel electrodes (first electrodes/second electrodes) 65P are formed. On one surface of the counter substrate 63 facing the liquid crystal 61, the counter electrodes (second electrodes/first electrodes) 65Q are formed.

In addition, the pixel electrode 65P has slits 66P (first slits/second slits) formed therein, and the counter electrode 65Q also has slits 66Q (second slits/first slits) formed therein (note that, the slits 66P and the slits 66Q have the same direction). However, the slit 66P and the slit 66Q are not opposed to each other along the direction in which the electrodes 65P and 65Q are arranged in parallel (for example, in the direction perpendicular to the substrates 62 and 63), but are shifted from each other.

Further, if no voltage is applied between the pixel electrode 65P and the counter electrode 65Q (in the case of OFF), as illustrated in FIG. 5, the major axis direction of the liquid crystal molecules 61M is oriented to be along the direction perpendicular to the substrates 62 and 63 (for example, the orientation film material (not shown) having an orientation regulating force is applied to the electrodes 65P and 65Q so that initial orientation in no electric field is designed).

Then, if the polarizing film 64P and the polarizing film 64Q are in cross-Nicol arrangement, the backlight BL that has passed through the active matrix substrate 62 does not exit to the outside (namely, the liquid crystal display panel 60 is in a normally black mode).

On the other hand, if a voltage is applied between the pixel electrode 65P and the counter electrode 65Q (in the case of ON), the liquid crystal molecules 61M tend to incline along the direction of the electric field generated between the electrodes 65P and 65Q. However, this electric field direction is not along the direction perpendicular to the substrates 62 and 63 (direction in which the substrates 62 and 63 are arranged in parallel) but is inclined. It is because the slit 66P formed in the pixel electrode 65P and the slit 66Q formed in the counter electrode 65Q cause a distortion in the electric field so that a diagonal electric field is formed.

Further, the negative type liquid crystal molecules 61M are inclined as illustrated in FIG. 6 so that the minor axis direction thereof is along the electric field direction (see electric flux lines illustrated in FIG. 6 with double dotted dashed lines). In other words, if no voltage is applied to the electrodes 65P and 65Q, the negative type liquid crystal molecules 61M in the liquid crystal display panel 60 cause the major axis direction thereof to be along the direction perpendicular to the two substrates 62 and 63 (to be homeotropic orientation). On the other hand, if a voltage is applied to the electrodes 65 and 65Q, the major axis direction of the liquid crystal molecules 61M crosses the direction of the electric field between the electrodes 65P and 65Q. Then, a part of the backlight BL that has passed through the active matrix substrate 62 exits to the outside as light along a transmission axis of the polarizing film 64Q due to the inclination of the liquid crystal molecules 61M.

Note that, the liquid crystal display panel 60 in the MVA mode is not limited to the type as illustrated in FIGS. 5 and 6 (referred to as slit type MVA mode), namely, the type causing the diagonal electric field using the slits 66P and 66Q. For instance, as illustrated in FIGS. 7 and 8, there is an MVA mode in which ribs 67P and 67Q are used instead of the slits 66P and 66Q (this MVA mode is referred to as rib type).

Specifically, in this liquid crystal display panel 60, ribs 67P (first ribs/second ribs) are formed on the pixel electrode 65P, and ribs 67Q (second ribs/first ribs) are formed on the counter electrode 65Q (note that, the ribs 67P and the ribs 67Q are formed in the same direction). Further, the rib 67P and the rib 67Q are not opposed to each other along the direction in which the electrodes 65P and 65Q are arranged in parallel (direction perpendicular to the two substrates 62 and 63), but are shifted from each other.

Further, the rib 67P has a shape like a triangular prism for example, and is arranged so that one side surface faces the electrode 65P while another side surface contacts with the liquid crystal 61. In the same manner, the rib 67Q has a shape like a triangular prism for example, and is arranged so that one side surface faces the electrode 65Q while another side surface contacts with the liquid crystal 61 (note that, the side surface of the rib 67 contacting with the liquid crystal 60 is referred to as slant surface).

Then, if no voltage is applied between the pixel electrode 65P and the counter electrode 65Q (in the case of OFF), as illustrated in FIG. 7, the major axis direction of the liquid crystal molecules 61M is oriented to be along the direction perpendicular to the substrates 62 and 63 (for example, the orientation film material (not shown) having an orientation regulating force is applied to the pixel electrode 65P and the rib 67P, and to the counter electrode 65Q and the rib 67Q so that initial orientation in no electric field is designed). However, the liquid crystal molecules 61M facing the slant surfaces of the ribs 67P and 67Q are inclined to the direction perpendicular to the substrates 62 and 63 (thickness direction of the substrates 62 and 63).

However, most of the liquid crystal molecules 61M are along the direction perpendicular to the substrates 62 and 63, and hence if the polarizing film 64P and the polarizing film 64Q are in cross-Nicol arrangement, the backlight BL that has passed through the active matrix substrate 62 does not exit to the outside.

On the other hand, if a voltage is applied between the pixel electrode 65P and the counter electrode 65Q (in the case of ON), the liquid crystal molecules 61M tend to incline along the direction of the electric field generated between the electrodes 65P and 65Q. However, this electric field direction is not along the direction perpendicular to the substrates 62 and 63 but is inclined. It is because the rib 67P formed on the pixel electrode 65P and the rib 67Q formed on the counter electrode 65Q cause a distortion in the electric field so that a diagonal electric field (see double dotted dashed lines in FIG. 8) is formed.

In addition, because the liquid crystal molecules 61M on the slant surfaces of the ribs 67P and 67Q are inclined, other liquid crystal molecules 61M are apt to be inclined diagonally along the electric field direction. As a result, as illustrated in FIG. 8, the liquid crystal molecules 61M are inclined so that the minor axis direction thereof is along the electric field direction.

In other words, if no voltage is applied to the electrodes 65P and 65Q, most of the negative type liquid crystal molecules 61M (most of the liquid crystal molecules 61M not facing the ribs 67P and 67Q) in the liquid crystal display panel 60 cause the major axis direction thereof to be along the direction perpendicular to the two substrates 62 and 63. On the other hand, if a voltage is applied to the electrodes 65P and 65Q, the major axis direction of the liquid crystal molecules 61M crosses the direction of the electric field between the electrodes 65P and 65Q. Then, a part of the backlight BL that has passed through the active matrix substrate 62 exits to the outside as light along a transmission axis of the polarizing film 64Q due to the inclination of the liquid crystal molecules 61M.

In summary, the liquid crystal molecules 61M are of the negative type in the slit type and rib type MVA modes, and at least a part of the liquid crystal molecules 61M (namely all the liquid crystal molecules 61M or a part of the liquid crystal molecules 61M) are oriented so that the major axis direction thereof is along the direction perpendicular to the two substrates 62 and 63 when no voltage is applied to the electrodes 65P and 65Q. Then, when a voltage is applied to the electrodes 65P and 65Q, the major axis direction of the liquid crystal molecules 61M crosses the direction of the electric field between the electrodes 65P and 65Q.

Note that, the slit type and rib type MVA modes are described above, but another MVA mode having slits and ribs is available. An example thereof is a liquid crystal display panel 60 in which the slits 66P are formed in the pixel electrode 65P and the ribs 67Q are formed on the counter electrode 65Q.

Therefore, the following liquid crystal mode can be said to be the MVA mode. That is, the slits 66P or the ribs 67P are formed on the pixel electrode 65P while the slits 66Q or the ribs 67Q are formed on the counter electrode 65Q, and due to the slits 66P and 66Q, the ribs 67P and 67Q, or a combination of the slits 66P and the ribs 67P (or slits 66Q and ribs 67Q), the direction of the electric field between the electrodes 65P and 65Q crosses the direction perpendicular to the two substrates 62 and 63 (namely the diagonal electric field is generated).

(IPS Mode)

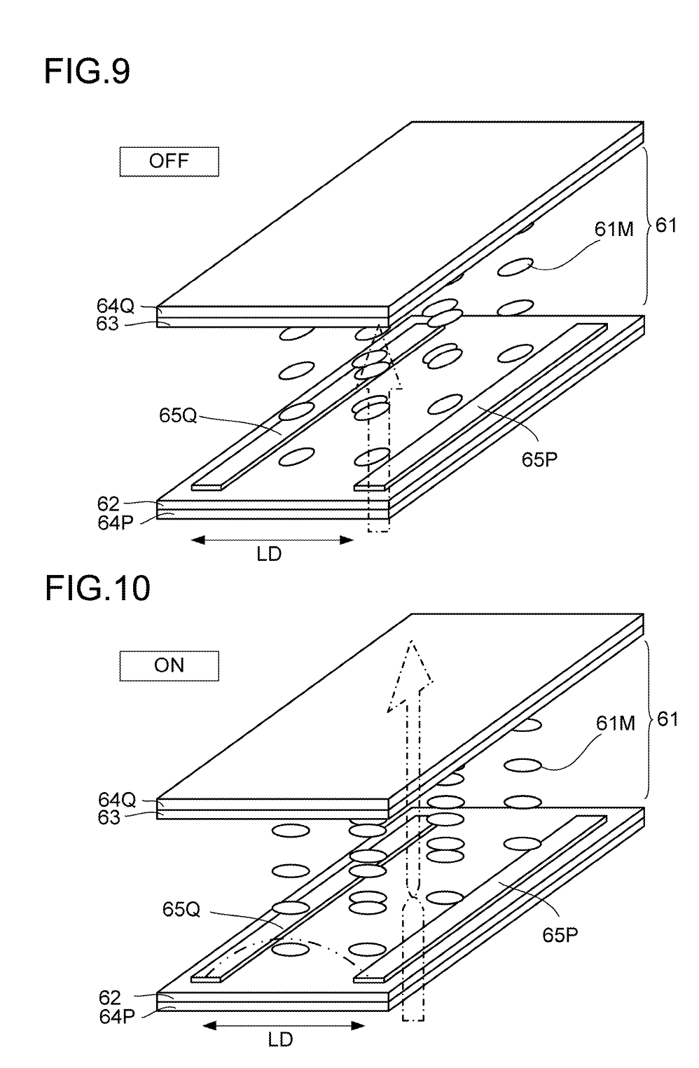

In addition, the case where the liquid crystal display panel 60 is of the IPS mode is described as follows. First, the liquid crystal 61 including the liquid crystal molecules 61M illustrated in FIGS. 9 and 10 is a positive type liquid crystal having positive dielectric anisotropy. Then, the pixel electrodes 65P and the counter electrodes 65Q are formed on the entire surface of the active matrix substrate 62 facing the liquid crystal 61 side. In particular, the electrodes 65P and 65Q are arranged to face each other.

Further, if no voltage is applied between the pixel electrode 65P and the counter electrode 65Q (in the case of OFF), as illustrated in FIG. 9, the major axis direction (director direction) of the liquid crystal molecules 61M is oriented so as to be along the in-plane direction of the substrate surface (horizontal direction of the substrate surface) of the active matrix substrate 62 and so as to cross the direction LD in which the pixel electrode 65P and the counter electrode 65Q are disposed in parallel (for example, the orientation film material (not shown) having an orientation regulating force is applied to the electrodes 65P and 65Q so that initial orientation in no electric field is designed).

Then, if the polarizing film 64P and the polarizing film 64Q are in cross-Nicol arrangement, the backlight BL that has passed through the active matrix substrate 62 does not exit to the outside (namely, the liquid crystal display panel 60 is in a normally black mode).

On the other hand, if a voltage is applied between the pixel electrode 65P and the counter electrode 65Q (in the case of ON), the liquid crystal molecules 61M tend to incline along the electric field generated between the electrodes 65P and 65Q. Then, the electric field direction is arcuate along the direction LD in which the pixel electrode 65P and the counter electrode 65Q are disposed in parallel (namely, an arcuate electric flux line is generated along the direction in which the pixel electrode 65P and the counter electrode 65Q are disposed in parallel, with extension of the curve directed to the counter substrate 63; see double dotted dashed line in FIG. 10).

Then, the liquid crystal molecules 61M whose initial orientation is set to be along the in-plane direction of the substrate surface of the active matrix substrate 62 are rotated because of influence of the arcuate electric field direction so that the major axis direction thereof is along the in-plane direction of the substrate surface and along the direction of the electric field between the electrodes 65P and 65Q as illustrated in FIG. 10. Then, a part of the backlight BL that has passed through the active matrix substrate 62 exits to the outside as light along a transmission axis of the polarizing film 64Q due to the inclination of the liquid crystal molecules 61M.

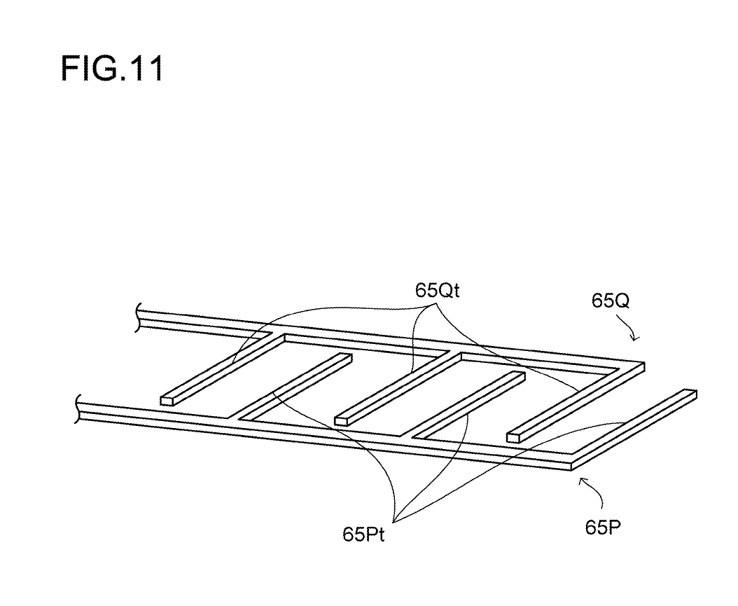

Note that, the pixel electrode 65P and the counter electrode 65Q are linear in FIGS. 9 and 10, but this is not a limitation. For instance, as illustrated in FIG. 11, the comb-like pixel electrode 65P and the comb-like counter electrode 65Q may be formed on one surface of the active matrix substrate 62 facing the liquid crystal 61 side.

Further, in the case of the comb-like pixel electrode 65P and counter electrode 65Q, the electrodes 65P and 65Q are arranged so that the comb teeth thereof are engaged with each other. Thus, teeth 65Pt of the pixel electrode 65P and teeth 65Qt of the counter electrode 65Q are arranged alternately. Then, between the teeth 65Pt of the pixel electrode 65P and the teeth 65Qt of the counter electrode 65Q, an arcuate electric field (lateral electric field) is generated, and the liquid crystal molecules 61M are inclined according to the electric field.

<<Afterimage and Multiple Outlines>>

Here, in any mode of the liquid crystal display panel 60, for displaying an image, the liquid crystal molecules 61M are inclined from the initial position (for example, the initial orientation position of the liquid crystal molecules 61M when no voltage is applied). Then, the inclination speed of the liquid crystal molecules 61M (response speed Vr) is important. It is because an “afterimage” or “multiple outlines” may occur in the image on the liquid crystal display panel 60 due to a relationship between the response speed Vr of the liquid crystal molecules 61M and incidence of the backlight BL on the liquid crystal display panel 60.

Usually, a human eye (retina) feels light by the integral value of light intensity. Therefore, the afterimage is caused by a phenomenon that when a person sees light, the light looks to remain after the light is extinguished. In particular, when a moving object is displayed on the liquid crystal display panel 60 as a so-called hold type display, the line of sight follows the moving object, and further the frame images are displayed continuously. As a result, the afterimage is apt to occur more easily.

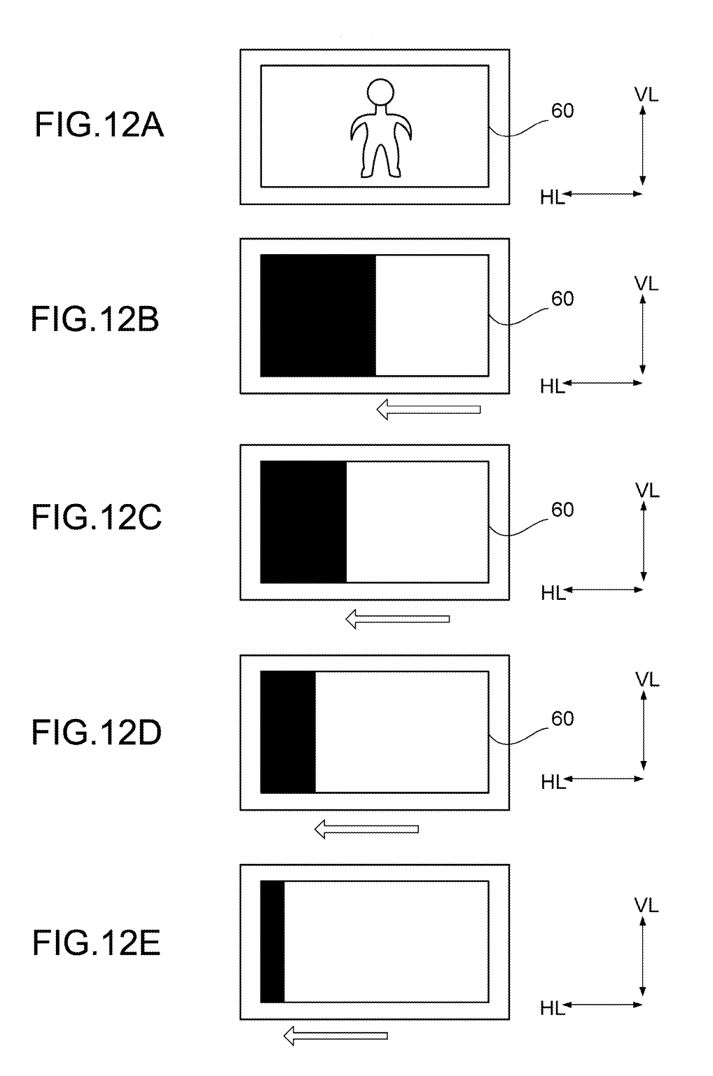

Then, if an image in which a black image and a white image are disposed side by side as illustrated in FIG. 12B is displayed on the liquid crystal display panel 60 as illustrated in FIG. 12A, there can be a state where the afterimage is apt to occur (note that, HL denotes the horizontal direction of the liquid crystal display panel 60, and VL denotes the direction perpendicular to the liquid crystal display panel 60). Specifically, if a boundary between the black image and the white image moves as illustrated in FIGS. 12B to 12E, the afterimage is apt to occur in a vicinity of the boundary. Then, in the liquid crystal 61 corresponding to the boundary between the black image and the white image, the liquid crystal molecules 61M need to be inclined.

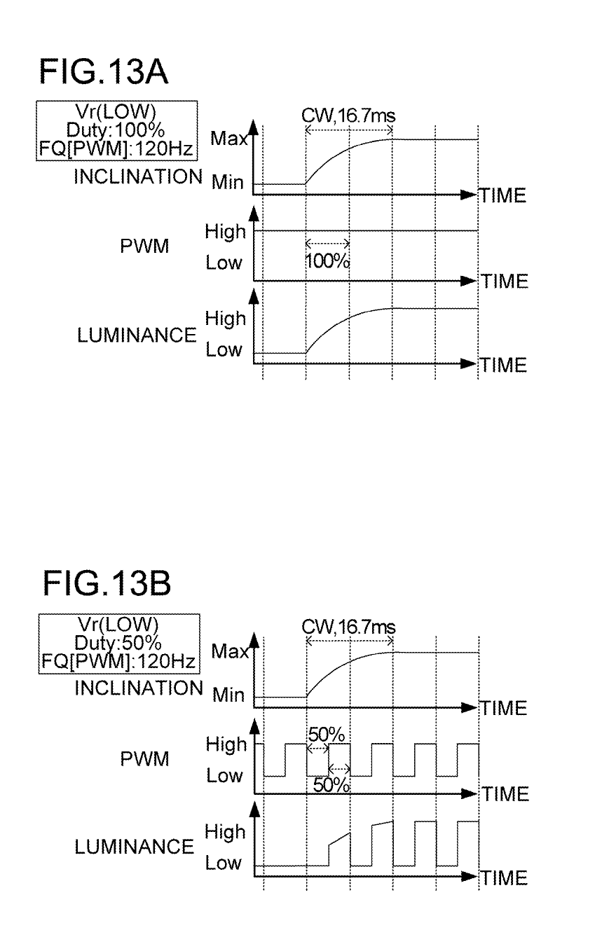

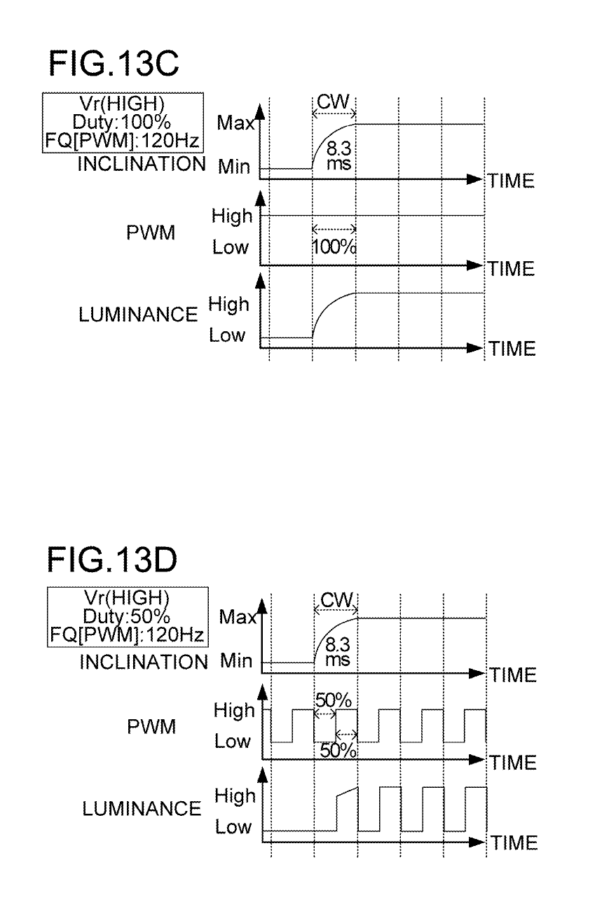

For instance, in the normally black mode liquid crystal display panel 60, it is supposed that positions of the liquid crystal molecules 61M for black image display are initial positions (see FIGS. 5, 7, and 9). Then, for the white image display, the liquid crystal molecules 61M are inclined from the initial position (see FIGS. 6, 8, and 10). Here, upper graphs in FIGS. 13A to 13D are graphs illustrating examples of the relationship between the inclination amount of the liquid crystal molecules 61M and time. Note that, in those figures, “Min” means the initial position of the liquid crystal molecules 61M in the black image display, and “Max” means a state where the liquid crystal molecules 61M are inclined most for the white image display.

Note that, time necessary for the liquid crystal molecules 61M to be inclined most is different between FIGS. 13A and 13B and FIGS. 13C and 13D. Specifically, time necessary for the liquid crystal molecules 61M to be inclined most (response time) is approximately 16.7 ms in the case of FIGS. 13A and 13B, and is approximately 8.3 ms in the case of FIGS. 13C and 13D (note that, the data value of the response speed Vr becomes small if the data value of the response time is as large as approximately 16.7 ms, and that the data value of the response speed Vr becomes large if the data value indicating the response time is as small as approximately 8.3 ms).

Then, it can be said that the liquid crystal molecules 61M illustrated in FIGS. 13A and 13B are inclined at relatively low response speed Vr(LOW) (namely, the liquid crystal molecules 61M are inclined at such a speed that the data value of the response speed Vr becomes small). On the other hand, it can be said that the liquid crystal molecules 61M illustrated in FIGS. 13C and 13D are inclined at a relatively high response speed Vr (HIGH) (namely, the liquid crystal molecules 61M are inclined at such a speed that the data value of the response speed Vr becomes large).

In addition, because the liquid crystal display panel 60 is irradiated with the backlight BL, the PWM dimming signal for the LED 71 for generating the backlight BL is also illustrated in the middle graphs of FIGS. 13A to 13D. Note that, the liquid crystal display panels 60 illustrated in FIGS. 13A and 13C are supplied with light having a duty factor of 100%, and the liquid crystal display panels 60 illustrated in FIGS. 13B and 13D are supplied with light having a duty factor of 50%. Note that, the drive frequency of the PWM dimming signal is 120 Hz, and the frame frequency of the liquid crystal display panel 60 (drive frequency of the liquid crystal display panel 60) is also 120 Hz. In addition, one section divided by dotted lines along the time axis in the figures means one frame.

In addition, lower graphs in FIGS. 13A to 13D are graphs illustrating luminance change of light passing through the liquid crystal display panel 60 when the backlight BL is supplied to the liquid crystal display panel 60 based on the PWM dimming signal.

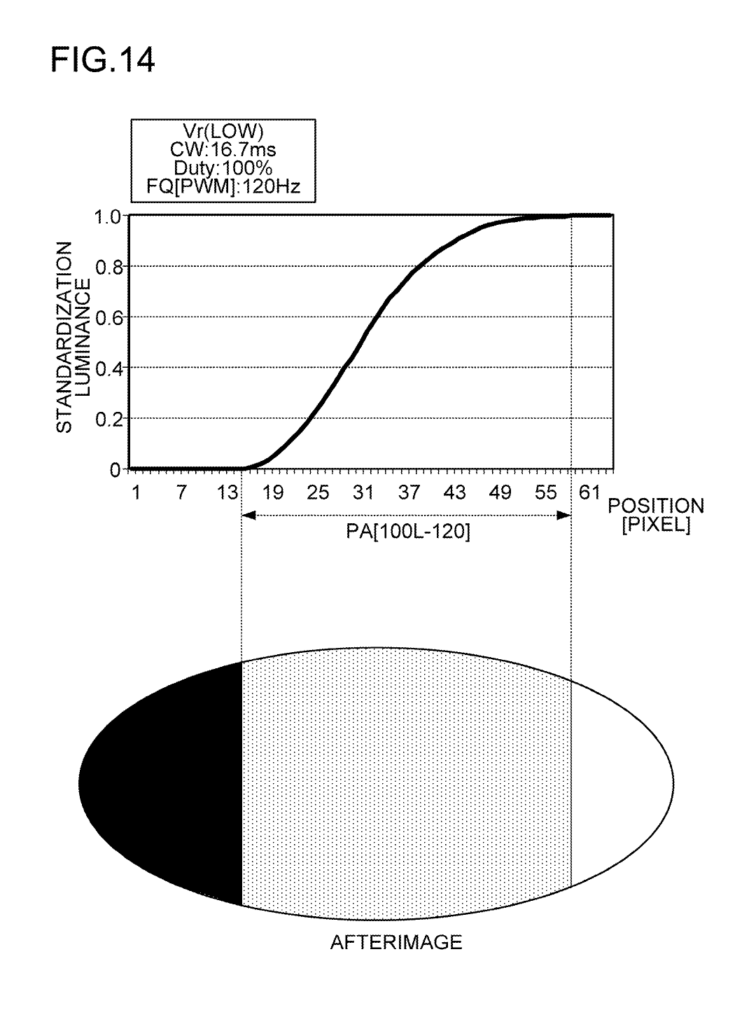

Under those conditions illustrated in FIGS. 13A to 13D, when the boundary between the black image and the white image moves (is scrolled) as illustrated in FIGS. 12B to 12E, the resultants are as illustrated in FIGS. 14 to 17 (note that, the scroll speed is 32 pixel/16.7 ms). Note that, in the graphs illustrated in FIGS. 14 to 17, the horizontal axis represents a pixel position in the liquid crystal display panel 60 in the horizontal direction HL, and the vertical axis represents normalized luminance of the integrated luminance normalized by the highest value. In addition, under the graph, there is illustrated an image diagram of a vicinity of the boundary between the black image and the white image.

First, a case where the liquid crystal molecules 61M are inclined at relatively low response speed Vr (LOW) is described. As illustrated in the upper graph of FIG. 13A, if the liquid crystal molecules 61M are inclined most from the initial position, a time period CW occurs in which the liquid crystal molecules 61M are gradually inclined. Then, the entire light should intrinsically be transmitted in this time period CW, but actually only a part of the light is transmitted in this time period (referred to as response process time period CW).

Then, as illustrated in the middle graph of FIG. 13A, when light from the LED 71 based on the PWM dimming signal with a duty factor of 100% is supplied to the liquid crystal molecules 61M in the response process time period CW, the luminance variation in the response process time period CW reflects time characteristics of the liquid crystal molecules 61M in the inclination illustrated in the upper graph of FIG. 13A. In other words, transmitted light in proportion to the inclination degree exits from the liquid crystal display panel 60 (see the lower graph of FIG. 13A). Specifically, if the duty factor is 100%, light whose intensity increases gradually (as monotonous increase) exits from the liquid crystal display panel 60 in the entire time range from the beginning to end of the response process time period CW.

Then, as illustrated in FIGS. 12B to 12E, when the boundary between the black image and the white image moves, exiting light from the liquid crystal display panel 60 corresponding to the response process time period CW moves. Therefore, the integrated luminance corresponding to the vicinity of the boundary becomes as illustrated in the graph of FIG. 14. In other words, pixels that receive light insufficient for forming a complete white color image appear in the vicinity of the boundary.

Then, a pixel range PA [100L-120] in which such pixels are continuous is recognized as pixels having a problem (see the image diagram). Specifically, switching from the black image to the white image is not performed at high speed (the black image is not switched vividly to the white image), and the afterimage is generated because there are continuous pixels having substantially the same integrated luminance change degree (namely, substantially the same inclination of the graph line of FIG. 14) in the pixel range PA [100L-120].

On the other hand, it is supposed that, when the liquid crystal molecules having relatively low response speed Vr are inclined (see the upper graph of FIG. 13B), as illustrated in the middle graph of FIG. 13B, the light from the LED 71 based on the PWM dimming signal having a duty factor of 50% is supplied to the liquid crystal molecules 61M in the response process time period CW.

If the duty factor is 50%, there exists a light-off time period and a light-on time period of the LED 71 in one frame period (note that, the last timing in one frame period is synchronized with the last timing of a high level period of the PWM dimming signal). Therefore, the light exits from the liquid crystal display panel 60 not in the entire time range from the beginning to end of the response process time period CW.

Specifically, when the response process time period CW is divided into four periods, light is not supplied to the liquid crystal molecules 61M in the first period, and light is supplied to the liquid crystal molecules 61M in the second period. Then, the first period becomes a time period indicating a minimum luminance value as illustrated in the lower graph of FIG. 13B.

On the other hand, the second period becomes a time period in which only a part of the light is transmitted because the inclination degree of the liquid crystal molecules 61M is relatively small, though the entire light should intrinsically be transmitted. Then, the luminance value corresponding to the second period is lower than the maximum luminance value.

Further, when the response process time period CW is divided into four periods, light is not supplied to the liquid crystal molecules 61M in the third period, and light is supplied to the liquid crystal molecules 61M in the fourth period. Then, the third period becomes a time period indicating the minimum luminance value similarly to the first period.

On the other hand, in the fourth period, the inclination degree of the liquid crystal molecules 61M is relatively large, but the liquid crystal molecules 61M are not completely inclined (to an angle necessary for forming the white color image). Therefore, similarly to the second period, the fourth period is a time period in which only a part of the light is transmitted, though the entire light should intrinsically be transmitted. Then, the luminance value corresponding to the fourth period is also lower than the maximum luminance value (however, the luminance value is higher than the luminance corresponding to the second period).

In other words, as illustrated in FIG. 13B, if the response speed Vr of the liquid crystal molecules 61M is relatively low (if the response process time period CW is equal to or longer than time corresponding to a plurality of cycles at the drive frequency of the PWM dimming signal), when the LED 71 emits light with the PWM dimming signal having a duty factor other than 100%, light is supplied to the liquid crystal display panel 60 continuously with a predetermined interval in the response process time period CW. Then, the luminance value of the supplied light is lower than the maximum luminance value.

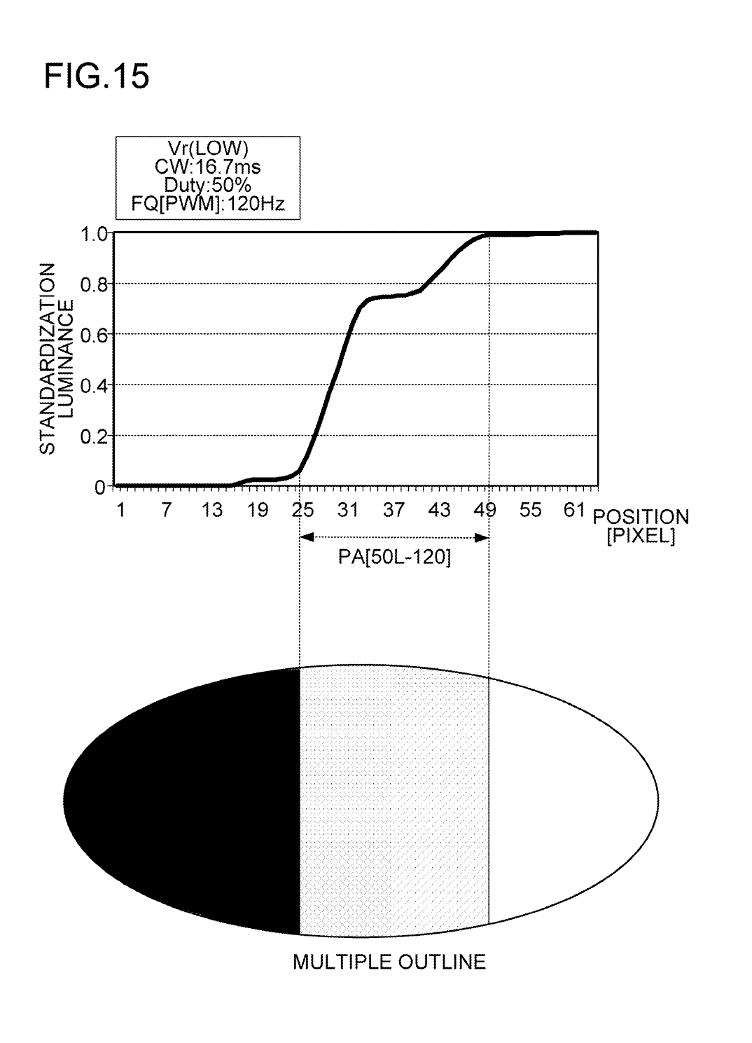

Then, as illustrated in FIGS. 12B to 12E, when the boundary between the black image and the white image moves, the integrated luminance corresponding to the vicinity of the boundary becomes as illustrated in the graph of FIG. 15. In other words, pixels that receive light insufficient for forming a complete white color image appear in the vicinity of the boundary.

Then, a pixel range PA [50L-120] in which such pixels are continuous is recognized as pixels having a problem (see the image diagram). Specifically, switching from the black image to the white image is not performed at high speed, and the multiple outlines are generated because pixels having different integrated luminance change degrees are included in the pixel range PA [50L-120] (note that, the multiple outlines are more responsible for the deterioration in image quality of the liquid crystal display panel 60 than the afterimage).

Next, a case where the liquid crystal molecules 61M are inclined at relatively high response speed Vr (HIGH) is described. It is supposed that, as illustrated in the upper graph of FIG. 13C, when the liquid crystal molecules 61M having relatively high response speed Vr are inclined, the light is supplied from the LED 71 based on the PWM dimming signal having a duty factor of 100% as illustrated in the middle graph of FIG. 13C. Then, as illustrated in the lower graph of FIG. 13C, light whose intensity increases gradually (as monotonous increase) exits from the liquid crystal display panel 60 in the entire time range from the beginning to end of the response process time period CW.

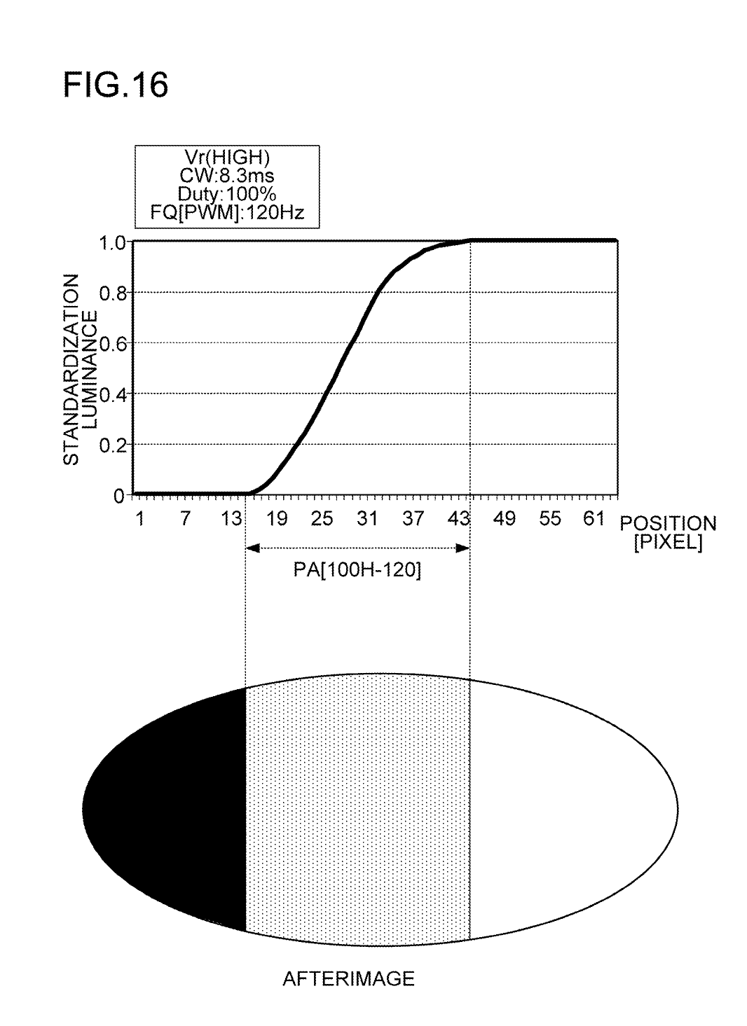

Then, as illustrated in FIGS. 12B to 12E, when the boundary between the black image and the white image moves, the integrated luminance corresponding to the vicinity of the boundary becomes as illustrated in the graph of FIG. 16. In other words, similarly to the case of FIGS. 13A and 14, pixels that receive light insufficient for forming a complete white color image appear in the vicinity of the boundary. Therefore, the pixel range PA [100H-120] is recognized as pixels having a problem (afterimage).

However, the pixel range PA [100H-120] illustrated in FIG. 16 is narrower than the pixel range PA [100L-120] illustrated in FIG. 14. Therefore, a deterioration degree of image quality due to the afterimage is worse in the case of the duty factor of 100% at the response speed Vr (LOW) than in the case of the duty factor of 100% at the response speed Vr (HIGH) (see the image diagram).

On the other hand, it is supposed that, when the liquid crystal molecules 61M having relatively high response speed Vr are inclined (see the upper graph of FIG. 13D), as illustrated in the middle graph of FIG. 13D, the light from the LED 71 based on the PWM dimming signal having a duty factor of 50% is supplied to the liquid crystal molecules 61M in the response process time period CW.

Then, similarly to the middle graph of FIG. 13B, light exits from the liquid crystal display panel 60 not in the entire time range from the beginning to end of the response process time period CW. However, the response process time period CW is shorter than the response process time period CW illustrated in the upper graph of FIG. 13B (note that, the last timing in one frame period is synchronized with the last timing of a high level period in the PWM dimming signal, and further one cycle of the PWM dimming signal is synchronized with the response process time period CW).

Specifically, when the response process time period CW is divided into two periods, light is not supplied to the liquid crystal molecules 61M in the first period, and light is supplied to the liquid crystal molecules 61M in the second period. Then, the first period becomes a time period indicating a minimum luminance value as illustrated in the lower graph of FIG. 13B.

On the other hand, the second period becomes a time period in which the inclination degree of the liquid crystal molecules 61M is relatively large, but the liquid crystal molecules 61M are not completely inclined (to an angle necessary for forming the white color image), and therefore, only a part of the light is transmitted, though the entire light should intrinsically be transmitted. Then, the luminance value corresponding to the second period is lower than the maximum luminance value.

Accordingly, even if the response speed Vr of the liquid crystal molecules 61M is relatively high (if the response process time period CW is time corresponding to one cycle at the drive frequency of the PWM dimming signal), when the LED 71 emits light with the PWM dimming signal having a duty factor other than 100%, as illustrated in the lower graph of FIG. 13D, light is supplied to the liquid crystal display panel 60 continuously with a predetermined interval in the response process time period CW (note that, the luminance value of the supplied light is lower than the maximum luminance value).

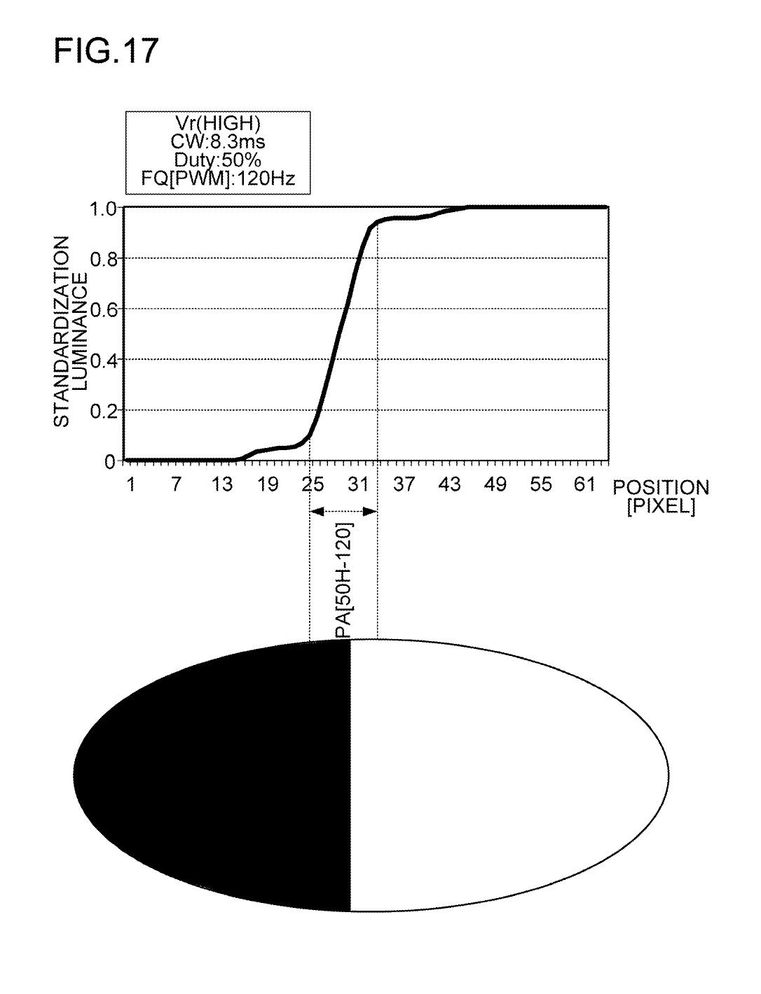

However, because the response speed Vr of the liquid crystal molecules 61M is high, the response process time period CW is short. Therefore, as illustrated in FIGS. 12B to 12E, when the boundary between the black image and the white image moves, only a small number of pixels that receive light insufficient for forming a complete white color image appear in the vicinity of the boundary (see FIG. 17).

Therefore, a pixel range PA [50H-120] in which such pixels are continuous is hardly recognized as pixels having a problem (see the image diagram). Therefore, if the response speed Vr is relatively high and the duty factor is other than 100% (for example, a duty factor of 50% or smaller), switching from the black image to the white image is performed at high speed, and further, pixels having substantially the same integrated luminance change degree are continuous only in the small pixel range PA [50H-120]. Therefore, in this case, the afterimage and the multiple outlines are not generated in the liquid crystal display panel 60.

<In Regard to Improvement of Image Quality Using Duty Factor of PWM Dimming Signal for Light Emission Control of LED>

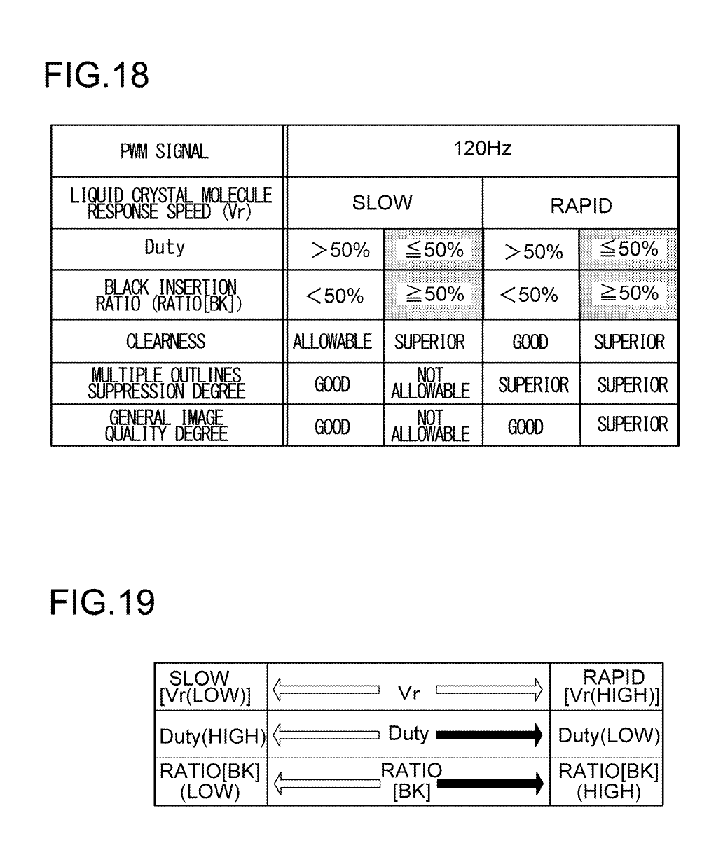

Here, results that can be derived from FIGS. 14 to 17 (image quality evaluation of the liquid crystal display panel 60) are shown in a table of FIG. 18.

Note that, a black insertion ratio (RATIO[BK]) in this table is a ratio of a period in which the LED 71 is turned off in one cycle of the PWM dimming signal (for easy understanding, a part having a high black insertion ratio is colored). In addition, this table shows four-grade evaluation (superior>good>allowable>not allowable) of three evaluation items for the liquid crystal display panel 60, which include whether or not an image is displayed clearly (sharply), whether or not multiple outlines are generated, and whether or not the image quality is generally allowable.

<<Change of Duty Factor in PWM Dimming Signal>>

From this table of FIG. 18, the following can be said. First, the image quality is relatively superior in the case of high response speed Vr of the liquid crystal molecules 61M to the case of low response speed Vr. In particular, if the response speed Vr of the liquid crystal molecules 61M is relatively high, and in addition, if the duty factor of the PWM dimming signal is 50% or smaller, a result of the “superior” is obtained in all the three items of the image quality evaluation (note that, to drive the LED 71 at a duty factor of 50% or smaller may be referred to as “to perform the black insertion”).

However, even if the LED 71 is driven with the PWM dimming signal having a duty factor of 50% or smaller, when the response speed Vr of the liquid crystal molecules 61M is low, the multiple outlines may occur so that general image quality becomes worst. If the response speed Vr of the liquid crystal molecules 61M is low, it is better to drive the LED 71 with the PWM dimming signal having a duty factor of larger than 50% as is clear from FIG. 18.

In view of the above-mentioned results of FIG. 18, if the duty factor of the PWM dimming signal can be changed according to the response speed Vr of the liquid crystal molecules 61M in the liquid crystal display device 90, it is possible to reflect response characteristics of the liquid crystal molecules 61M so that quality of an image displayed on the liquid crystal display panel 60 can be improved (for example, occurrence of multiple outlines can be suppressed, and clearness and the like can be improved).

In other words, as illustrated in the table of FIG. 19, if the response speed Vr of the liquid crystal molecules 61M is relatively high, the LED 71 should be driven with a relatively small duty factor so that the black insertion is performed. On the other hand, if the response speed Vr of the liquid crystal molecules 61M is relatively low, the LED 71 should be driven with a relatively large duty factor so that the black insertion is not performed (note that, coloring of the arrow in FIG. 19 means a tendency of performing the black insertion).

With this structure, the liquid crystal 61 having relatively high response speed Vr is supplied with short-time light continuously with a predetermined interval corresponding to a relatively small duty factor. Then, in this case, the liquid crystal display device 90 performs image display similar to an impulse-type display device so that the image quality can be improved. On the other hand, the liquid crystal 61 having relatively low response speed Vr is supplied with short-time light continuously with a predetermined interval, light is supplied to the liquid crystal molecules 61M that have not reached a predetermined angle. As a result, a malfunction of image quality (such as multiple outlines) may occur.

However, for such liquid crystal 61 having relatively low response speed Vr, the LED 71 is driven at a relatively large duty factor in order to prevent a malfunction of image quality. Therefore, in this liquid crystal display device 90, image quality can be improved according to the response speed Vr of the liquid crystal 61.

Note that, the response speed Vr of the liquid crystal molecules 61M is changed depending not only on temperature but also on material. Therefore, a threshold value for determining whether the response speed Vr is high or low (response speed data threshold value) is set arbitrarily.

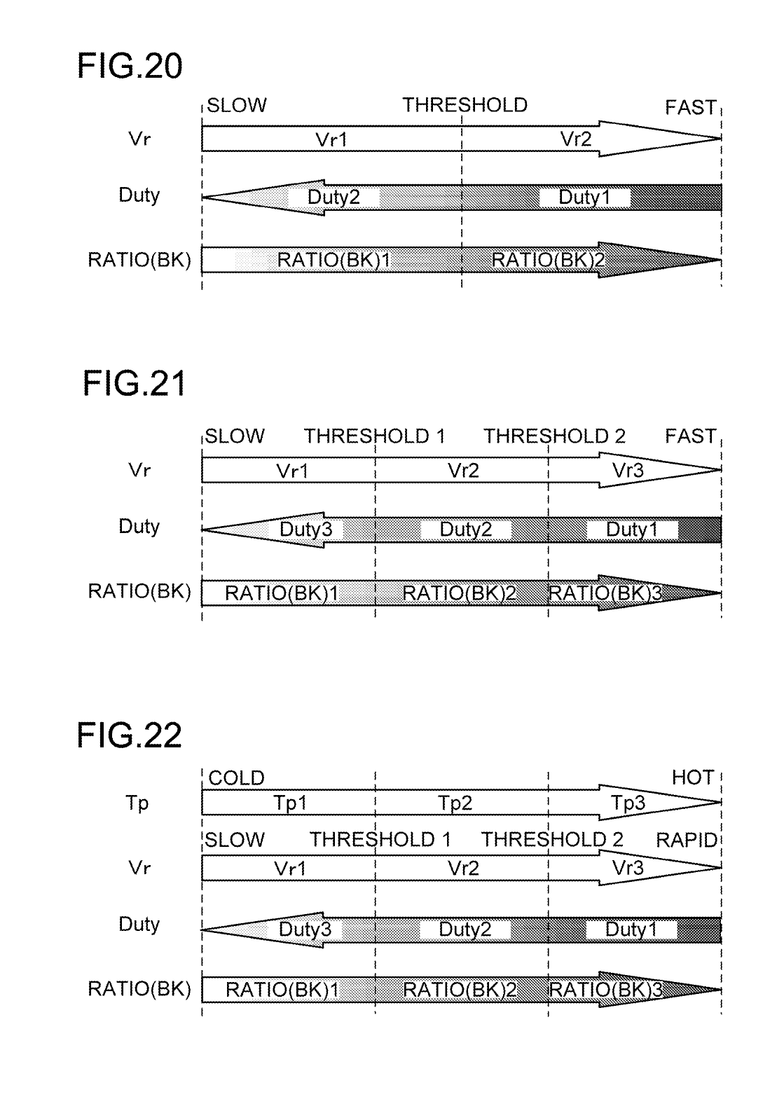

For instance, the magnitude relations of data values of the response speed Vr, the duty factor, and the black insertion ratio are described below with reference to FIG. 20 using arrows. Specifically, a smaller data value is indicated by a proximal side of the arrow, while a larger data value is indicated by a distal side of the arrow (note that, density of the arrow in FIG. 20 means a tendency of performing the black insertion).

In other words, as illustrated in FIG. 20, in the entire range of the assumed response speed Vr, two ranges of the response speed Vr are set with respect to one arbitrary threshold value (a range equal to or higher than the threshold value and a range lower than the threshold value). In the range of the response speed Vr equal to or higher than the threshold value, the liquid crystal molecules 61M are inclined at a high response speed Vr(Vr2). In the range of the response speed Vr lower than the threshold value, the liquid crystal molecules 61M are inclined at a low response speed Vr(Vr1). In this case, the threshold value should be any response speed Vr in the entire range of the response speed Vr. Note that, the number of the set threshold values is not limited to one as illustrated in FIG. 20. In other words, as illustrated in FIG. 21, two or more threshold values may be set, and three or more ranges of the response speed Vr (response speed data ranges) may be set with respect to the threshold values as boundaries.

The point is that there is at least one arbitrary threshold value, and a plurality of arbitrary ranges of the response speed Vr are set with respect to the threshold value as a boundary so that the duty factor can be changed for the individual ranges. With this structure, the response speed Vr of the liquid crystal molecules 61M can be divided in steps, and the image quality can be improved according to the step.

In particular, the duty factor should be changed for each range of the response speed Vr so as to have an opposite relationship to a magnitude relationship concerning the plurality of ranges of the response speed Vr. For instance, as illustrated in FIG. 20, the duty factor should be a large value Duty2 if the response speed Vr is a small value Vr1, while the duty factor should be a small value Duty1 if the response speed Vr is a large value Vr2 (note that, a magnitude relationship of the data value of the response speed Vr is Vr1<Vr2, and a magnitude relationship of the duty factor data value is Duty1<Duty2).

By the way, one of variation factors of the response speed Vr of the liquid crystal molecules 61M in the liquid crystal display device 90 as a product is temperature Tp of the liquid crystal molecules 61M. Therefore, a magnitude relationship of the data value of the temperature Tp is added to the table of FIG. 21, and a table shown in FIG. 22 is obtained (namely, if the temperature rises, the response speed Vr of the liquid crystal molecules 61M increases). Then, in order to obtain the data value of the response speed Vr from the temperature Tp of the liquid crystal molecules 61M, the control unit 1 of the liquid crystal display device 90 operates as follows, for example.

Specifically, as illustrated in FIG. 2, the duty factor setting portion 14 of the video signal processing portion 10 included in the control unit 1 obtains the measured temperature data (temperature data) from the panel thermistor 83. Then, the duty factor setting portion 14 obtains one of the memory data DM stored in the memory 17.

Specifically, the memory data DM is a data table (lookup table) of the response speed Vr of the liquid crystal molecules 61M depending on the temperature of the liquid crystal 61 (liquid crystal temperature Tp). In other words, the duty factor setting portion 14 obtains the response speed Vr by associating the temperature data of the panel thermistor 83 with the liquid crystal temperature Tp of the data table.

Then, the duty factor setting portion 14 sets the duty factor of the PWM dimming signal corresponding to the obtained response speed Vr. Note that, the method of setting the duty factor is not particularly limited. As an example, the data table of the duty factor depending on the response speed Vr is stored in the memory 17, and the duty factor setting portion 14 sets the duty factor using the data table.

<<Current Value Change in PWM Dimming Signal>>

Note that, if the duty factor of the PWM dimming signal is set according to the response speed Vr of the liquid crystal molecules 61M, it is desired to change a current value AM of the PWM dimming signal according to the duty factor (namely, it is preferred that the PWM dimming signal VD-Sd[W] be corrected to be the PWM dimming signal VD-Sd[W·A]). The reason is described below.

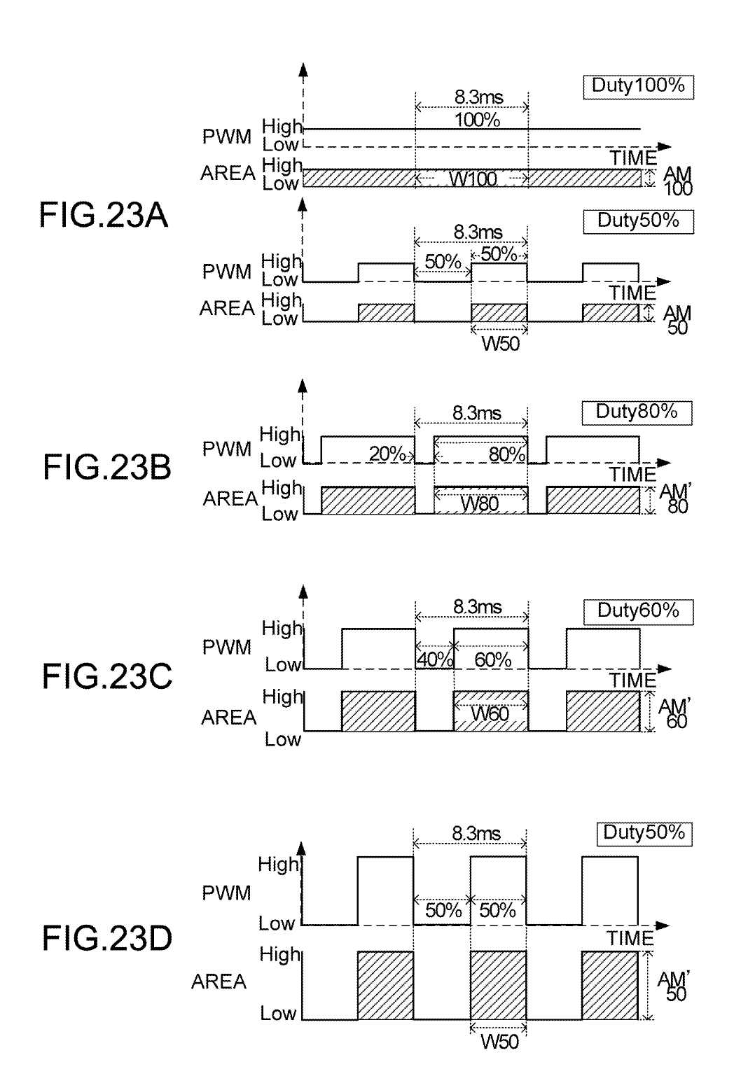

For instance, FIG. 23A illustrates the PWM dimming signal having a duty factor of 100% and the PWM dimming signal having a duty factor of 50% (note that, the PWM dimming signal has 120 Hz, and the section between dotted lines indicates one frame period). Then, the luminance due to those PWM dimming signals can be compared roughly based on the size of the hatched area illustrated under the graph of each PWM dimming signal. In other words, the luminance can be compared roughly based on the area as a product of the light-on period of the PWM dimming signal and the current value thereof.

In a case of FIG. 23A, the duty factor is different between 100% and 50% while the current value AM is the same. Here, in one cycle of the PWM dimming signal, the light-on period and the current value in the case where the duty factor is 100% are denoted by W100 and AM100, respectively, and the light-on period and the current value in the case where the duty factor is 50% are denoted by W50 and AM50, respectively. Then, the luminance is higher in the case of the duty factor of 100% than in the case of the duty factor of 50% (W100×AM100>W50×AM50).

Then, if the duty factor of the PWM dimming signal is changed according to the response speed Vr, a luminance difference occurs according to the duty factor, and hence an image quality deterioration may occur. Therefore, the current value of the PWM dimming signal is changed according to the duty factor. For instance, with reference to the luminance in the case of the duty factor of 100% illustrated in FIG. 23A, as illustrated in FIG. 23B for the duty factor of 80%, FIG. 23C for the duty factor of 60%, and FIG. 23D for the duty factor of 50%, the hatched areas in the figures for discussing the luminance are equalized (W100×AM100=W80×AM′80=W60×AM′60=W50×AM′50).

In other words, the current value setting portion 15 of the calculation processing portion 13 changes the current value AM of the PWM dimming signal in the case of driving with a duty factor other than 100% so that an integrated amount of light emission in one cycle period of the PWM dimming signal is equal to an integrated amount of light emission with a duty factor of 100% in the period corresponding to the one cycle period. Then, with this structure, even if the duty factor is changed according to the response speed Vr of the liquid crystal molecules 61M, the luminance is not changed due to the duty factor (namely, the liquid crystal display device 90 can change the duty factor while maintaining high luminance).

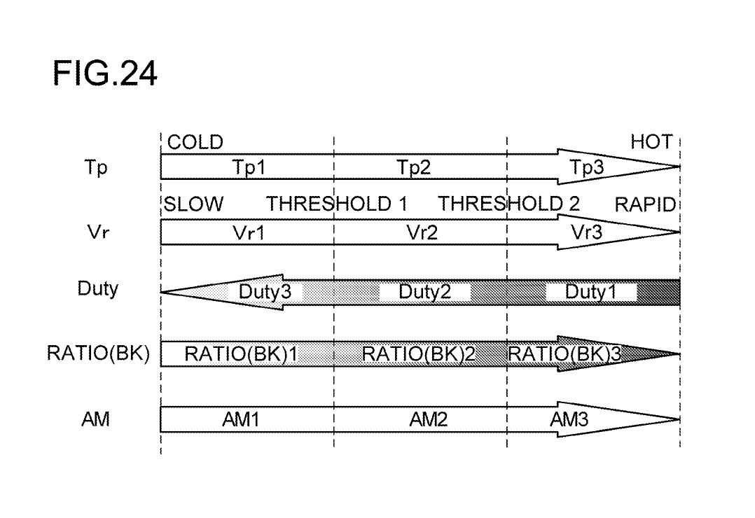

Note that, the change of the current value of the PWM dimming signal according to the duty factor is added to the table of FIG. 22 to obtain the table shown in FIG. 24. In other words, as a degree of the black insertion is higher (as the duty factor is lower), the current value AM becomes larger (AM1<AM2<AM3).

In addition, the method of setting the current value AM by the current value setting portion 15 is not particularly limited. For instance, the current value setting portion 15 may receive the data signal of the duty factor and perform calculating processing so as to set the current value AM, or may store therein a data table of the current value AM depending on the duty factor so as to set the current value AM using the data table.

<<In Regard to Other Factors>>

By the way, the liquid crystal display device 90 has various functions for improving image quality. Examples of the functions are an FRC processing function, and a viewing mode setting function for changing a display form of an image according to the preference of a viewer. In addition, the functions include an environmental support function for adjusting brightness of the liquid crystal display panel 60 according to brightness of the environment where the liquid crystal display device 90 is placed. Further, the functions include a video signal support function for adjusting brightness of the liquid crystal display panel 60 according to luminance or the like of the video signal (average signal level ASL or the like).

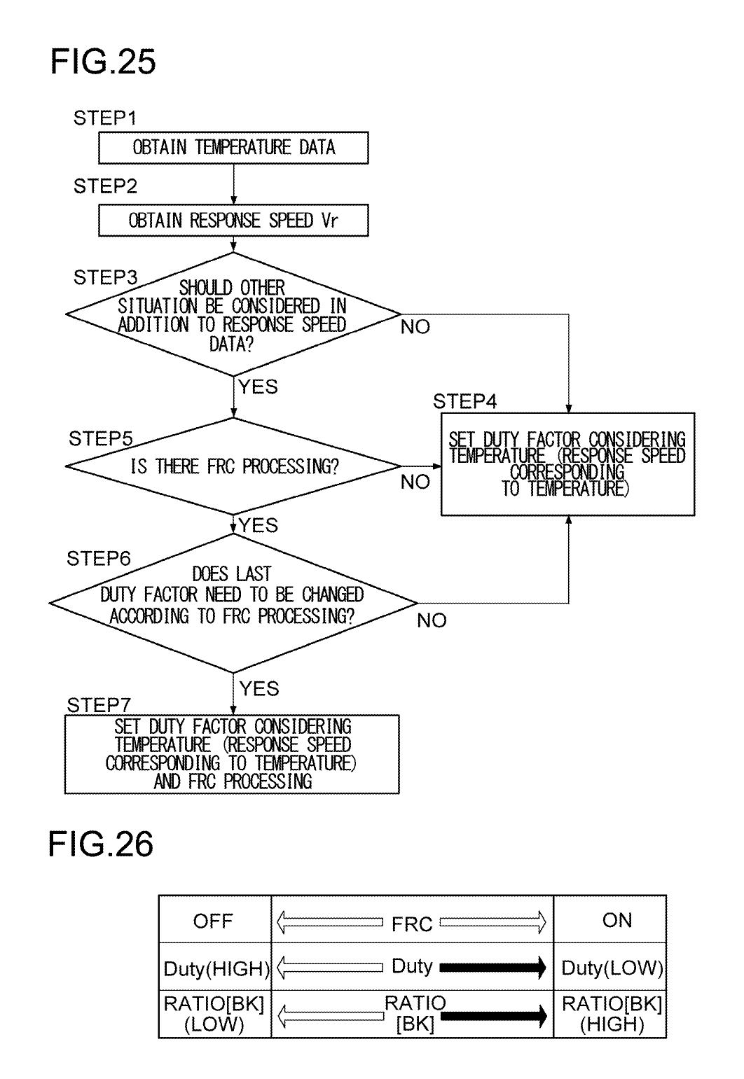

Further, it is often desired that the duty factor of the PWM dimming signal change according to the various functions. For instance, the duty factor setting portion 14 of the calculation processing portion 13 obtains the temperature data of the panel thermistor 83 as illustrated in the flowchart of FIG. 25 (STEP 1), and obtains the response speed Vr of the liquid crystal molecules 61M (STEP 2).

Then, the duty factor setting portion 14 judges the response speed Vr (response speed data). Specifically, the duty factor setting portion 14 judges whether or not setting of the duty factor needs to be changed according to presence or absence of actions of the various functions (STEP 3). For instance, if the response speed Vr is excessively low and if the duty factor is not set to be high regardless of presence or absence of actions of the various functions, in the case where the multiple outlines occur (in the case of NO in STEP 3), the duty factor setting portion 14 sets the duty factor to 100%, for example, considering the response speed Vr corresponding to the liquid crystal temperature Tp (STEP 4). With this structure, occurrence of the multiple outlines is prevented.

However, if the duty factor setting portion 14 judges that it is desired to change setting of the duty factor due to the presence of actions of various functions (in the case of YES in STEP 4), the duty factor setting portion 14 sets the duty factor considering the various functions. It is because image quality can be securely improved with this structure.

(FRC Processing Function)

For instance, the duty factor setting portion 14 judges presence or absence of the FRC processing (STEP 5). Specifically, as illustrated in FIG. 2, the duty factor setting portion 14 receives a signal (ON/OFF signal) indicating presence or absence of the FRC processing from the FRC processing portion 21 of the LCD controller 20. Then, if the FRC processing is not performed (in the case of NO in STEP 5), namely, because the number of frames of the video signal is smaller than a predetermined number, the duty factor setting portion 14 sets a duty factor that is the same as the duty factor considering the response speed Vr corresponding to the liquid crystal temperature Tp, namely, sets a relatively high duty factor (STEP 4).

On the other hand, if the FRC processing is performed (in the case of YES in STEP 5), the duty factor setting portion 14 judges whether or not the last duty factor needs to be changed according to the FRC processing (STEP 6). It is because the last duty factor, namely the duty factor set in STEP 4 may be the same as the duty factor after the FRC processing.

Then, if the duty factor setting portion 14 judges that the last duty factor needs to be changed (in the case of YES in STEP 6), the duty factor is set considering the response speed Vr corresponding to the liquid crystal temperature Tp and the FRC processing (STEP 7). For instance, if there is the FRC processing, the duty factor setting portion 14 decreases the duty factor (note that, a tendency of the magnitude of the duty factor corresponding to presence or absence of the FRC processing is shown in the table of FIG. 26). With this structure, clearness or the like of image quality is improved.

On the other hand, if the duty factor setting portion 14 judges that the last duty factor does not need to be changed (in the case of NO in STEP 6), the duty factor is set considering only the response speed Vr corresponding to the liquid crystal temperature Tp (STEP 4).

In other words, the control unit 1 illustrated in FIG. 1 includes the FRC processing portion 21 that performs the frame rate control processing, and the control unit 1 (specifically, the duty factor setting portion 14) changes the duty factor according to presence or absence of the FRC processing by the FRC processing portion 21 (note that, the current value AM may be changed according to the change of the duty factor). Note that, the duty factor in the case where the FRC processing is performed is smaller than the duty factor in the case where the FRC processing is not performed (see FIG. 26).

(Viewing Mode Setting Function)

In addition, the duty factor setting portion 14 may perform the judgment according to the setting of the viewing mode. Specifically, as illustrated in FIG. 2, the duty factor setting portion 14 receives a mode type signal MD indicating a type of the viewing mode from the viewing mode setting portion 16 of the video signal processing portion 10, for example, a signal indicating Sports Mode having a relatively high motion picture level.

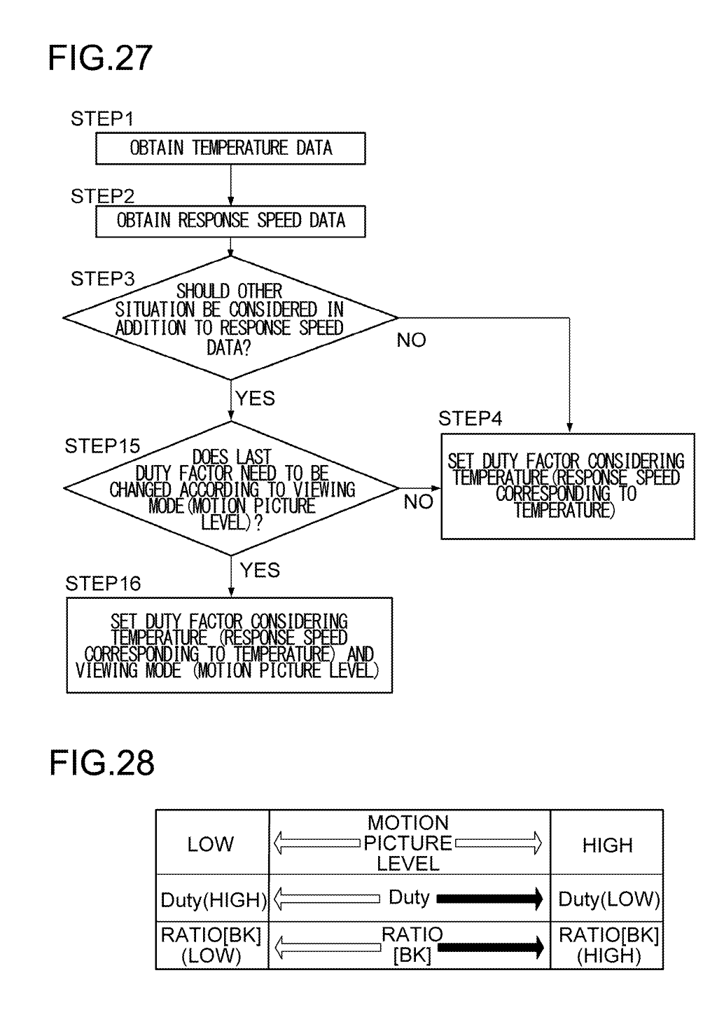

Then, as illustrated in the flowchart of FIG. 27 (STEP 1 to STEP 4 are the same as described above), the duty factor setting portion 14 judges whether or not the last duty factor needs to be changed according to the motion picture level (STEP 15). It is because the last duty factor, namely the duty factor set in STEP 4 may be the same as the duty factor in the case where the motion picture level is high.

Then, if the duty factor setting portion 14 judges that the last duty factor needs to be changed (in the case of YES in STEP 15), the duty factor is set considering the response speed Vr corresponding to the liquid crystal temperature Tp and the motion picture level (STEP 16). For instance, if Sports Mode is set, the duty factor setting portion 14 decreases the duty factor (note that, a tendency of the magnitude of the duty factor corresponding to the magnitude relationship of the motion picture level is shown in the table of FIG. 28). With this structure, clearness or the like of image quality is improved.

On the other hand, if the duty factor setting portion 14 judges that the last duty factor does not need to be changed (in the case of NO in STEP 15), the duty factor is set considering only the response speed Vr corresponding to the liquid crystal temperature Tp (STEP 4).

In other words, the control unit 1 illustrated in FIG. 1 includes the viewing mode setting portion 16 for switching the viewing mode of the liquid crystal display panel 60. When the viewing mode setting portion 16 switches the viewing mode, the control unit 1 (specifically, the duty factor setting portion 14) changes the duty factor according to the selected viewing mode (note that, the current value AM may be changed according to the change of the duty factor).

Then, as an example of the duty factor change, as described above, if the viewing mode setting portion 16 sets the high motion picture level viewing mode and the low motion picture level viewing mode according to the motion picture level of the video data, the duty factor is changed for each selected viewing mode so as to have an opposite relationship to the magnitude relationship of the motion picture level in a plurality of viewing modes (see FIG. 28).

In addition, the duty factor setting portion 14 may perform the judgment according to the setting of the viewing mode of a different contrast ratio. Specifically, the duty factor setting portion 14 receives the signal mode type signal MD indicating a type of the viewing mode from the viewing mode setting portion 16, for example, a signal indicating Dynamic Mode having a relatively high contrast ratio.

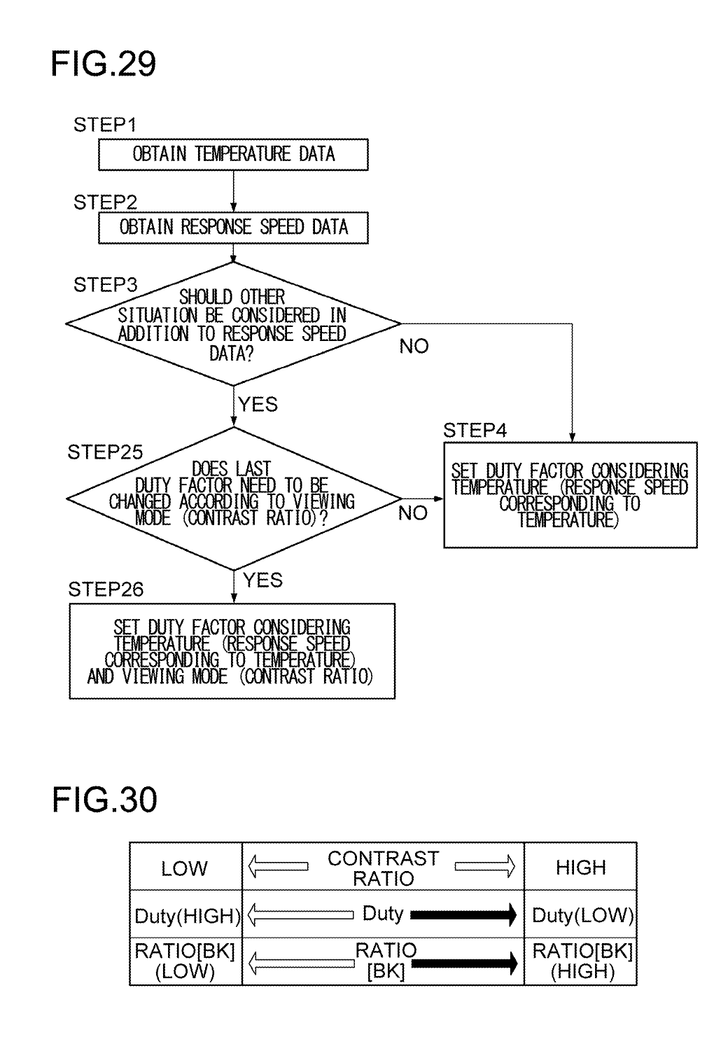

Then, as illustrated in the flowchart of FIG. 29 (STEP 1 to STEP 4 are the same as described above), the duty factor setting portion 14 judges whether or not the last duty factor needs to be changed according to the contrast ratio (STEP 25). It is because the last duty factor, namely the duty factor set in STEP 4 may be the same as the duty factor in the case where the contrast ratio is high.

Then, if the duty factor setting portion 14 judges that the last duty factor needs to be changed (in the case of YES in STEP 25), the duty factor is set considering the response speed Vr corresponding to the liquid crystal temperature Tp and the contrast ratio (STEP 26). For instance, if Dynamic Mode is set, the duty factor setting portion 14 decreases the duty factor (note that, a tendency of the magnitude of the duty factor corresponding to the magnitude relationship of the contrast ratio is shown in the table of FIG. 30). With this structure, clearness or the like of image quality is improved.

On the other hand, if the duty factor setting portion 14 judges that the last duty factor does not need to be changed (in the case of NO in STEP 25), the duty factor is set considering only the response speed Vr corresponding to the liquid crystal temperature Tp (STEP 4).

In other words, if the viewing mode setting portion 16 sets a high contrast level viewing mode and a low contrast level viewing mode according to the contrast level of the video data, the duty factor is changed for each selected viewing mode so as to have an opposite relationship to the magnitude relationship of the contrast level in a plurality of viewing modes (see FIG. 30).

Note that, there are many types of viewing modes, and the duty factor setting portion 14 may set the duty factor in combination of the various modes. For instance, the duty factor setting portion 14 receives the mode type signal MD indicating the type of the viewing mode from the viewing mode setting portion 16, for example, a signal indicating Sports Mode having a relatively high motion picture level and Dynamic Mode having a relatively high contrast ratio.

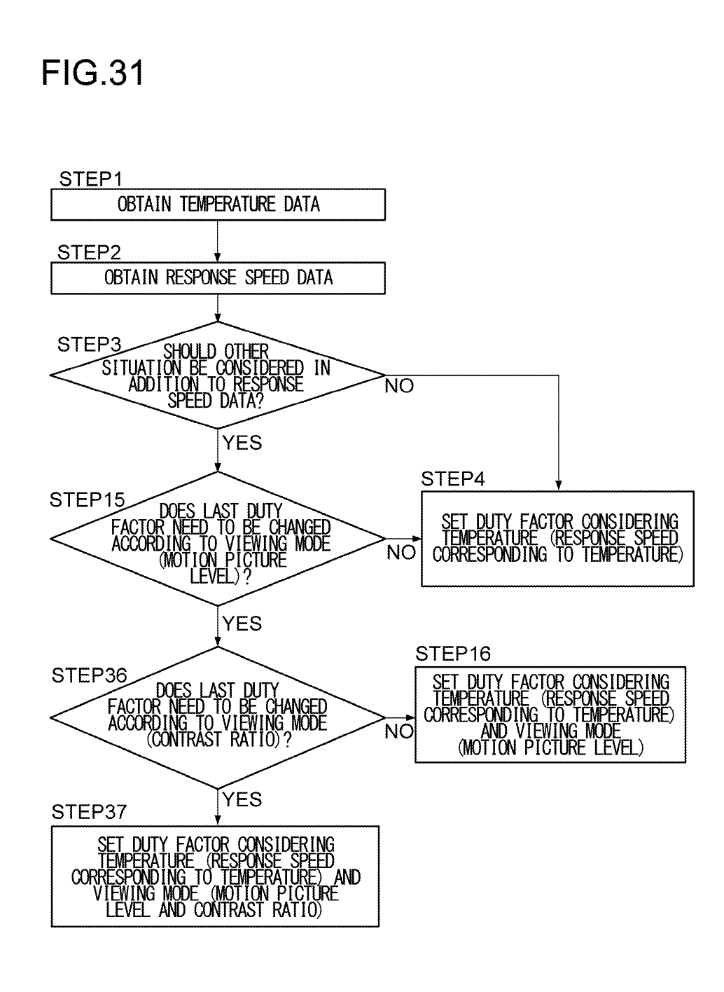

Then, as illustrated in the flowchart of FIG. 31 (STEP 1 to STEP 4 are the same as described above), the duty factor setting portion 14 judges whether or not the last duty factor needs to be changed according to the motion picture level, for example (STEP 15). Then, if it is judged that the last duty factor does not need to be changed (in the case of NO in STEP 15), the duty factor setting portion 14 sets the duty factor considering only the response speed Vr corresponding to the liquid crystal temperature Tp (STEP 4).

On the other hand, if the duty factor setting portion 14 judges that the last duty factor needs to be changed (in the case of YES in STEP 15), it is further judged whether or not the last duty factor needs to be changed according to the contrast ratio (STEP 36). Then, if the duty factor setting portion 14 judges that the last duty factor needs to be changed (in the case of YES in STEP 36), the duty factor is set considering the response speed Vr corresponding to the liquid crystal temperature Tp, the motion picture level, and the contrast ratio (STEP 37).

On the other hand, if the duty factor setting portion 14 judges that the last duty factor does not need to be changed (in the case of NO in STEP 36), the duty factor is set considering the response speed Vr corresponding to the liquid crystal temperature Tp and the motion picture level (STEP 16).

Note that, in the flowchart of FIG. 31, the motion picture level is considered first, and then the contrast ratio is considered, but this order may be different.

(Environmental Support Function)

In addition, the duty factor setting portion 14 may perform the judgment according to brightness of the environment in which the liquid crystal molecules 61M are placed. Specifically, the duty factor setting portion 14 receives illuminance data of the environmental illuminance sensor 84 as illustrated in FIG. 2 (namely, the duty factor setting portion 14 judges brightness of the place where the liquid crystal display device 90 is placed, based on illuminance measured by the environmental illuminance sensor 84 that measures external illuminance).

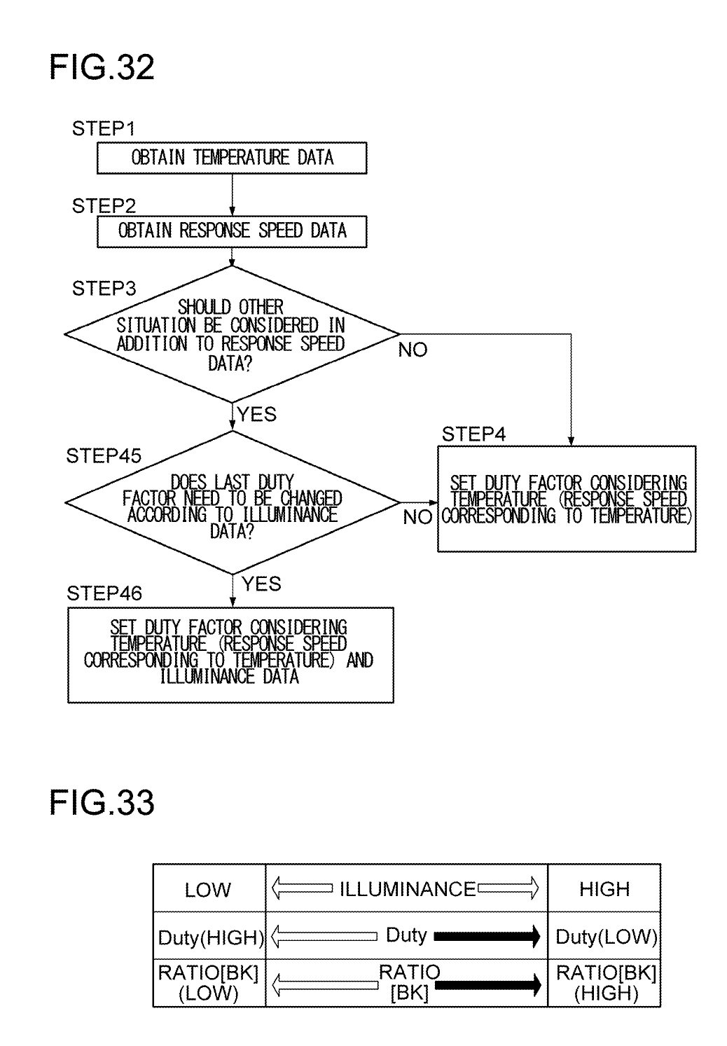

Then, as illustrated in the flowchart of FIG. 32 (STEP 1 to STEP 4 are the same as described above), the duty factor setting portion 14 judges whether or not the last duty factor needs to be changed according to the illuminance data (STEP 45). It is because the last duty factor, namely the duty factor set in STEP 4 may be the same as the duty factor in the case where the illuminance data is high (namely, in the case where the environment is relatively bright).

Then, if the duty factor setting portion 14 judges that the last duty factor needs to be changed (in the case of YES in STEP 45), the duty factor is set considering the response speed Vr corresponding to the liquid crystal temperature Tp and the illuminance data (STEP 46). For instance, if the liquid crystal display device 90 is placed in a relatively bright environment, the duty factor setting portion 14 decreases the duty factor (note that, a tendency of the magnitude of the duty factor corresponding to a magnitude relationship of the illuminance data is shown in the table of FIG. 33). With this structure, clearness or the like of image quality is improved.

On the other hand, if the duty factor setting portion 14 judges that the last duty factor does not need to be changed (in the case of NO in STEP 45), the duty factor is set considering only the response speed Vr corresponding to the liquid crystal temperature Tp (STEP 4).

In other words, the control unit 1 illustrated in FIG. 1 obtains the external illuminance data and changes the duty factor according to the illuminance data (note that, the current value AM may be changed according to the change of the duty factor). Note that, the duty factor is changed for each illuminance data range so as to have an opposite relationship with a magnitude relationship of the data value in each of a plurality of illuminance data ranges (see FIG. 33).

(Video Signal Support Function)

In addition, the duty factor setting portion 14 may perform the judgment according to luminance or the like of the video signal (average signal level ASL or the like). Specifically, the duty factor setting portion 14 receives the histogram data HGM of the histogram processing portion 12 via the calculation processing portion 13 as illustrated in FIG. 2. Then, the duty factor is changed by using the histogram data HGM.

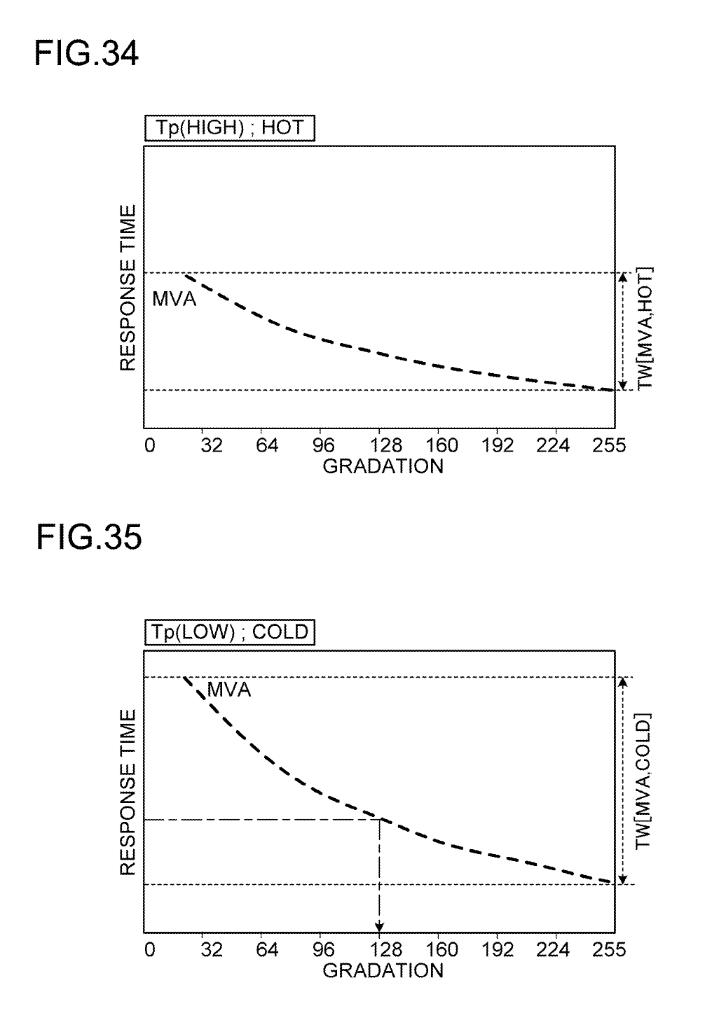

Here, the response speed Vr of the liquid crystal molecules 61M has a dependence on temperature, and also a dependence on a variation between gradations. Examples of the dependences are illustrated in FIGS. 34 and 35. These graphs show the inclined response time of the liquid crystal molecules 61M that is changing its gradation from the 0th gradation level to another gradation level. FIG. 34 corresponds to relatively high liquid crystal temperature Tp, and FIG. 35 corresponds to relatively low liquid crystal temperature Tp (note that, the liquid crystal 61 is the MVA mode).

From comparison between the graph of FIG. 34 and the graph of FIG. 35, it is understood that a difference TW between a maximum value and a minimum value of the response time is different depending on the liquid crystal temperature Tp (the difference TW[MVA, HOT] at high liquid crystal temperature Tp is smaller than the difference TW[MVA, COLD] at low liquid crystal temperature Tp). In addition, in the graph of FIG. 34 and the graph of FIG. 35, the response time is decreased gradually from the 0th gradation level to 255th gradation level (the graph line is monotonously decreased over a wide gradation range).

In the case where the difference TW is large in the graph line, if there is a difference between occupancy of a low gradation range and occupancy of a high gradation range in an image (one frame image), image quality deterioration may occur depending on characteristics of the backlight BL.

For instance, if the occupancy of the low gradation range is high (namely, if the image has relatively low gradation) at the low liquid crystal temperature Tp of approximately 20° C., the response speed Vr of the liquid crystal molecules 61M becomes relatively low. If the duty factor of the PWM dimming signal is set to be low for such liquid crystal molecules 61M, multiple outlines may occur as illustrated in FIG. 15. Therefore, in this case, the duty factor of the PWM dimming signal is set to be high for preventing the multiple outlines.

On the contrary, if the occupancy of the high gradation range is high (namely, if the image has relatively high gradation), the response speed Vr of the liquid crystal molecules 61M becomes relatively high. Therefore, in this case, the duty factor of the PWM dimming signal should be set to be low for improving the clearness or the like of the image quality (namely, so that the black insertion effect of the PWM dimming signal can be obtained conspicuously).

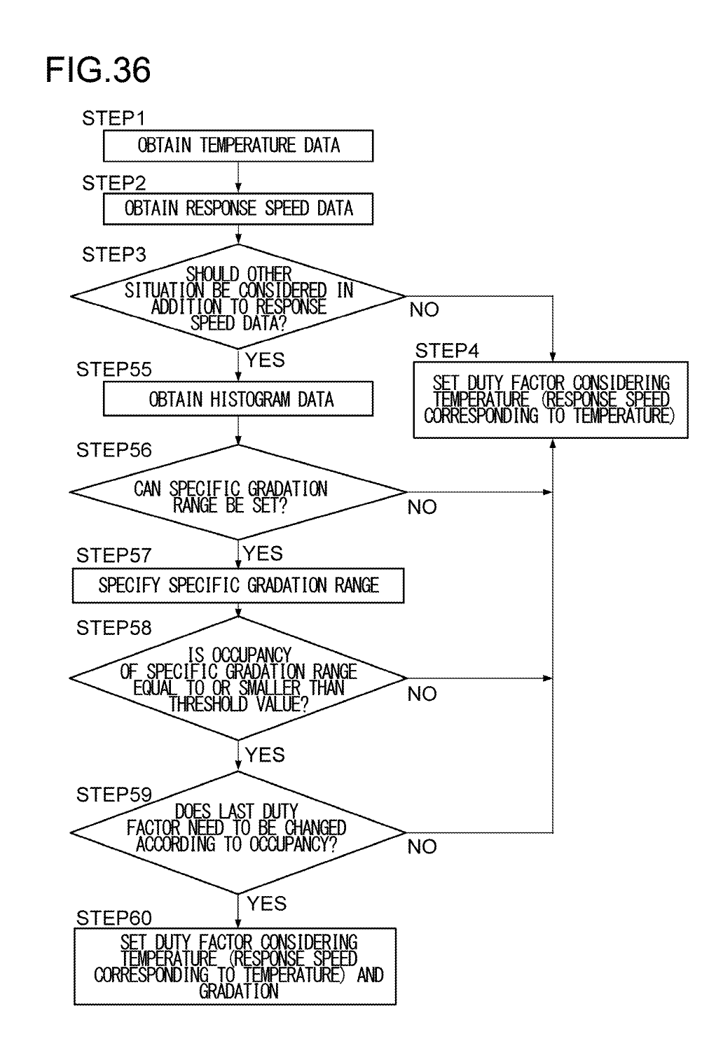

Then, if the duty factor is changed according to the occupancy of the gradation range in the image, as illustrated in the flowchart of FIG. 36 (STEP 1 to STEP 4 are the same as described above), the duty factor setting portion 14 obtains the histogram data HGM from the calculation processing portion 13 (STEP 55). Next, the duty factor setting portion 14 obtains the gradation threshold value (gradation threshold value data) set according to the liquid crystal temperature Tp stored in the memory 17 in advance and judges whether or not the specific gradation range can be set (STEP 56).

For instance, if the liquid crystal temperature Tp is high, the difference TW[MVA, HOT] is relatively small as illustrated in FIG. 34. Then, a difference of the response time due to a gradation change at high liquid crystal temperature Tp is smaller than a difference of the response time due to a gradation change at low liquid crystal temperature Tp.

Therefore, if the difference of the response time due to a gradation change when the liquid crystal temperature Tp is high is set to be an allowable range, when this liquid crystal temperature Tp is high, it is unnecessary to set, using the histogram data HGM, a specific gradation range in which the duty factor should be changed (for example, the low gradation range) (in the case of NO in STEP 56). Therefore, in this case, the duty factor setting portion 14 sets the duty factor considering only the response speed Vr corresponding to the liquid crystal temperature Tp (STEP 4).

On the contrary, as illustrated in FIG. 35, if the difference of the response time due to a gradation change when the liquid crystal temperature Tp is low is set to be outside the allowable range, the duty factor setting portion 14 tries to change the duty factor using the histogram data HGM (in the case of YES in STEP 56). Specifically, the duty factor setting portion 14 sets the specific gradation range in which the duty factor should be changed from the histogram data HGM and the gradation threshold value set corresponding to the liquid crystal temperature Tp stored in the memory 17 (STEP 57). For instance, if the liquid crystal temperature Tp is low (for example, approximately 20° C.) in the MVA mode liquid crystal 61, a range from the 0th gradation level to 128th gradation level is set as the specific gradation range as illustrated in FIG. 35 (namely, the gradation range of 0 or larger and 128 or smaller in the entire gradation range of 0 or larger and 255 or smaller is set as the specific gradation range).

Further, the duty factor setting portion 14 obtains the occupancy of the specific gradation range in the image (one frame image) from the histogram data HGM, and compares the occupancy with the threshold value concerning the occupancy of the specific gradation range (occupancy threshold value; for example, 50%) stored in the memory 17 (STEP 58).

Then, if the occupancy is not equal to or smaller than the threshold value (namely, if the occupancy is larger than the occupancy threshold value; in the case of NO in STEP 58), it can be said that the image is a low gradation image containing a high frequency of gradations in the specific gradation range from the 0th gradation level to 128th gradation level, for example. Then, in order to prevent occurrence of the multiple outlines as illustrated in FIG. 15, the duty factor setting portion 14 sets a large duty factor, for example, 100% considering only the response speed Vr corresponding to the liquid crystal temperature Tp (STEP 4).

On the contrary, if the occupancy is equal to or smaller than the threshold value (in the case of YES in STEP 58), it can be said that the image is a high gradation image containing only a small frequency of gradations in the specific gradation range from the 0th gradation level to 128th gradation level, for example. Then, the duty factor setting portion 14 judges whether or not the last duty factor needs to be changed according to the occupancy (STEP 59). It is because the last duty factor, namely the duty factor set in STEP 4 may not be different from the duty factor in the case where the occupancy is high (namely, in the case of a low gradation image).

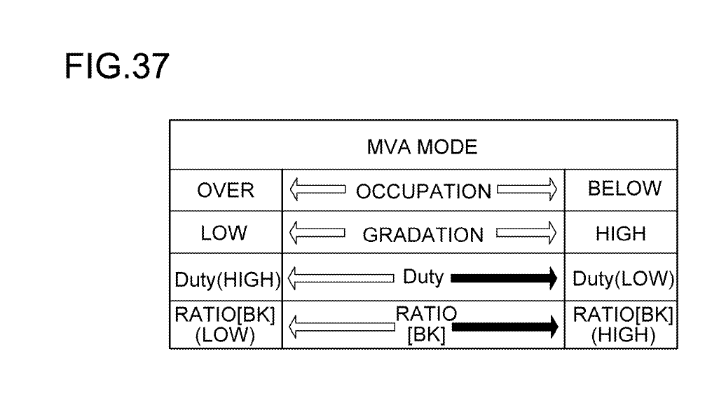

Then, if the duty factor setting portion 14 judges that the last duty factor needs to be changed (in the case of YES in STEP 59), the duty factor is set considering the response speed Vr corresponding to the liquid crystal temperature Tp and the gradations (namely, histogram data HGM) (STEP 60). For instance, if a relatively high gradation image is displayed on the liquid crystal display panel 60 of the MVA mode liquid crystal display device 90, the duty factor setting portion 14 sets a low duty factor, for example, 50% (note that, a tendency of the magnitude of the duty factor corresponding to a magnitude relationship of the occupancy is shown in the table of FIG. 37). With this structure, clearness or the like of image quality is improved.

On the other hand, if the duty factor setting portion 14 judges that the last duty factor does not need to be changed (in the case of NO in STEP 59), the duty factor is set considering only the response speed Vr corresponding to the liquid crystal temperature Tp (STEP 4).

In other words, in the control unit 1, the histogram unit 18 generates a histogram of the video signal so as to generate histogram data HGM of a frequency distribution of the gradation. Further, the control unit 1 divides the entire gradation of the histogram data HGM and judges whether or not occupancy of at least one specific gradation range among the divided gradation ranges exceeds the occupancy threshold value.

Then, the duty factor in the case where the occupancy threshold value is exceeded is set to be higher than the duty factor in the case where the occupancy threshold value is not exceeded. On the other hand, the duty factor in the case where the occupancy threshold value is not exceeded is set to be lower than the duty factor in the case where the occupancy threshold value is exceeded (note that, the current value AM may be changed according to the change of the duty factor).

Note that, in the MVA mode liquid crystal 61, in the case where the liquid crystal temperature Tp is approximately 20° C., the above-mentioned specific gradation range from the 0th gradation level to 128th gradation level, and the occupancy threshold value of 50% for the occupancy of the specific gradation range are merely examples (a plurality of specific gradation ranges may be prepared). For instance, according to temperature data of the panel thermistor 83, namely, the liquid crystal temperature Tp, at least one of the specific gradation range and the occupancy threshold value may be changed. Therefore, for example, also in the case of the liquid crystal temperature Tp as illustrated in FIG. 34, the specific gradation range may be set.

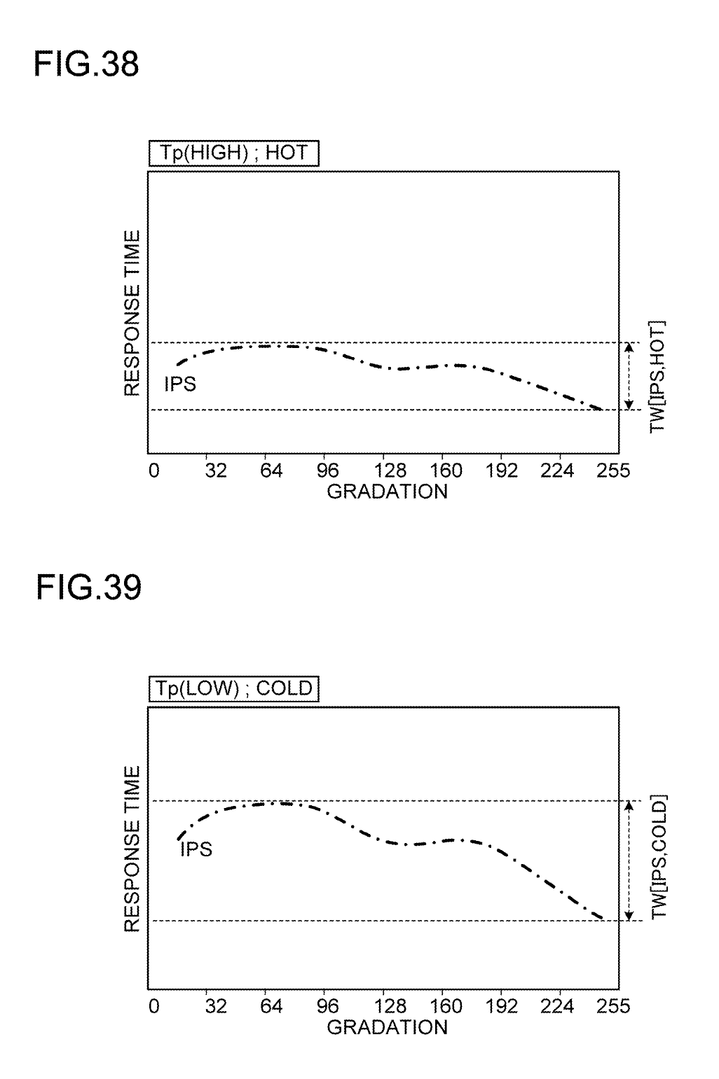

In addition, as illustrated in FIGS. 38 and 39, in the IPS mode liquid crystal 61, the difference TW between the maximum value and the minimum value of the response time is relatively small in both the case where the liquid crystal temperature Tp is high (see FIG. 38) and the case where the same is low (see FIG. 39) (note that, FIGS. 38 and 39 show, similarly to FIGS. 34 and 35, inclined response time of the liquid crystal molecules 61M that is changing gradation from the 0th gradation level to another gradation level). The point is that FIGS. 38 and 39 are flat graph lines compared with FIG. 35, for example.

In other words, a difference of the response time due to a gradation change is relatively small at both high and low liquid crystal temperatures Tp. Therefore, the specific gradation range in the image is set, and further the duty factor may not be changed according to the occupancy of the specific range. However, the duty factor may be changed according to the video signal support function in some cases.

(Combination of Various Functions)

By the way, the FRC processing function, the viewing mode setting function, the environmental support function, and the video signal support function described above may act in various combinations. In this case too, the duty factor may be changed.

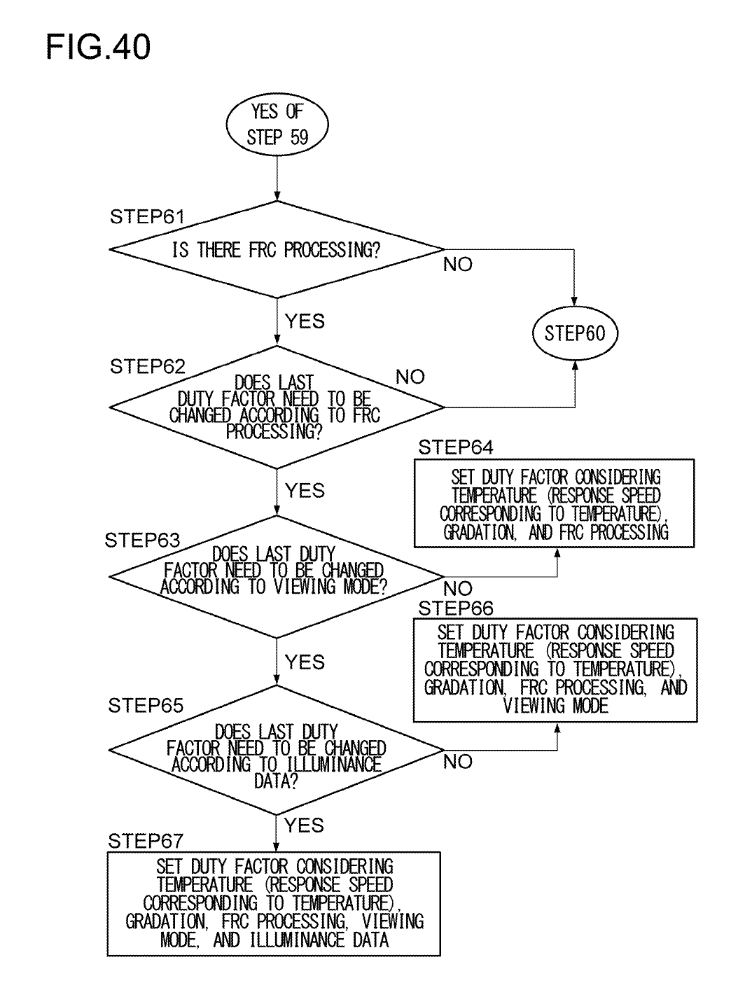

For instance, as illustrated in the flowchart of FIG. 36, if the duty factor is changed according to the video signal support function, after YES in STEP 59, as illustrated in the flowchart of FIG. 40, the duty factor setting portion 14 may judge presence or absence of the FRC processing (STEP 61). Then, if the FRC processing is not performed (in the case of NO in STEP 61), the duty factor setting portion 14 sets the duty factor considering the response speed Vr corresponding to the liquid crystal temperature Tp in STEP 60 and the gradation (STEP 60).

On the other hand, even if there is the FRC processing, the duty factor setting portion 14 judges whether or not the last duty factor needs to be changed corresponding to the FRC processing (STEP 62). Then, if the duty factor setting portion 14 judges that the last duty factor does not need to be changed (in the case of NO in STEP 62), the duty factor setting portion 14 sets the duty factor considering the response speed Vr corresponding to the liquid crystal temperature Tp in STEP 60 and the gradation (STEP 60).

On the other hand, if the duty factor setting portion 14 judges that the last duty factor needs to be changed (in the case of YES in STEP 62), the duty factor setting portion 14 next judges whether or not the last duty factor needs to be changed according to the viewing mode (for example, the motion picture level) (STEP 63). Then, if the duty factor setting portion 14 judges that the last duty factor does not need to be changed (in the case of NO in STEP 63), the duty factor setting portion 14 sets the duty factor considering the response speed Vr according to the liquid crystal temperature Tp, the gradation, and the FRC processing (STEP 64).

On the other hand, if the duty factor setting portion 14 judges that the last duty factor needs to be changed (in the case of YES in STEP 63), the duty factor setting portion 14 judges whether or not the last duty factor needs to be changed according to the illuminance data (STEP 65). Then, if the duty factor setting portion 14 judges that the last duty factor does not need to be changed (in the case of NO in STEP 65), the duty factor setting portion 14 sets the duty factor considering the response speed Vr according to the liquid crystal temperature Tp, the gradation, the FRC processing, and the viewing mode (STEP 66).

Then, if the duty factor setting portion 14 judges that the last duty factor needs to be changed (in the case of YES in STEP 65), the duty factor setting portion 14 sets the duty factor considering the response speed Vr according to the liquid crystal temperature Tp, the gradation, and the FRC processing, the viewing mode, and the illuminance data (STEP 67).

In other words, as illustrated in the flowchart of FIG. 40, even if the FRC processing function, the viewing mode setting function, the environmental support function, and the video signal support function are combined for action, the duty factor setting portion 14 can change the duty factor (note that, the current value AM may be changed according to the change of the duty factor).

In addition, the order of the functions is not limited to the order of the video signal support function, the FRC processing function, the viewing mode setting function, and the environmental support function as illustrated in the flowcharts of FIGS. 36 and 40. The order may be changed. In addition, the number of combinations of the functions is not limited to four including the video signal support function, the FRC processing function, the viewing mode setting function, and the environmental support function. The number may be three or smaller, or five or larger if there are other various functions.

<In Regard to Numerical Example about Duty Factor of PWM Dimming Signal>

Note that, 50% and 100% are mainly exemplified above as numerical examples of the duty factor. However, as a matter of course, these values are not limitations.

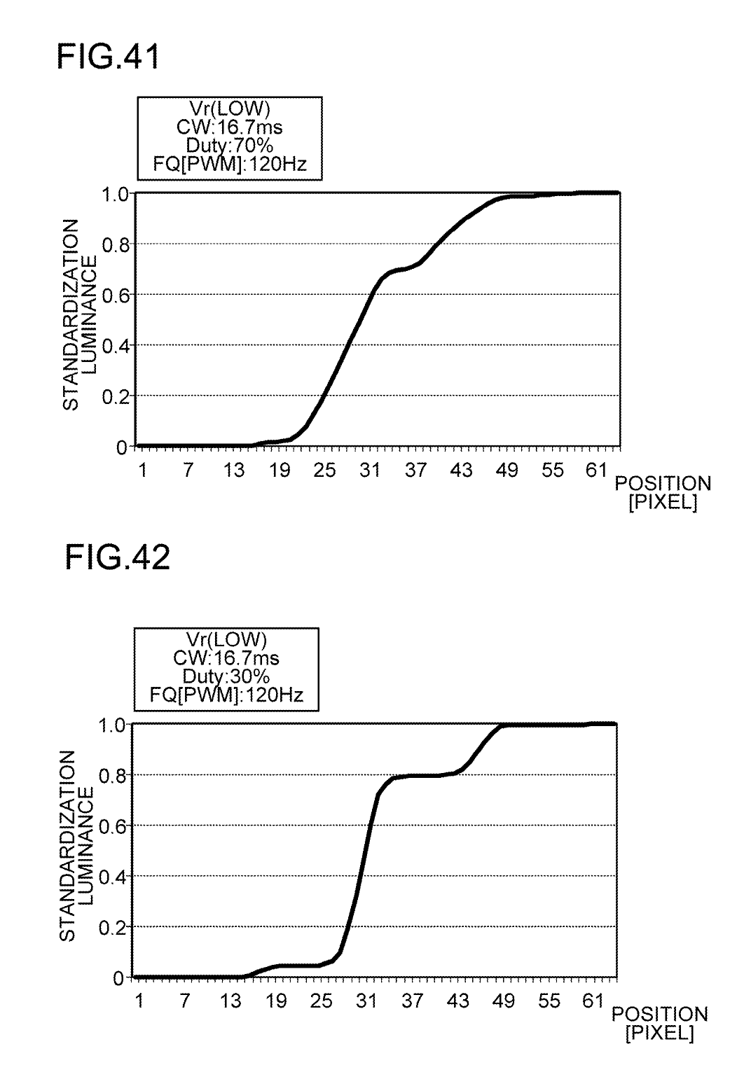

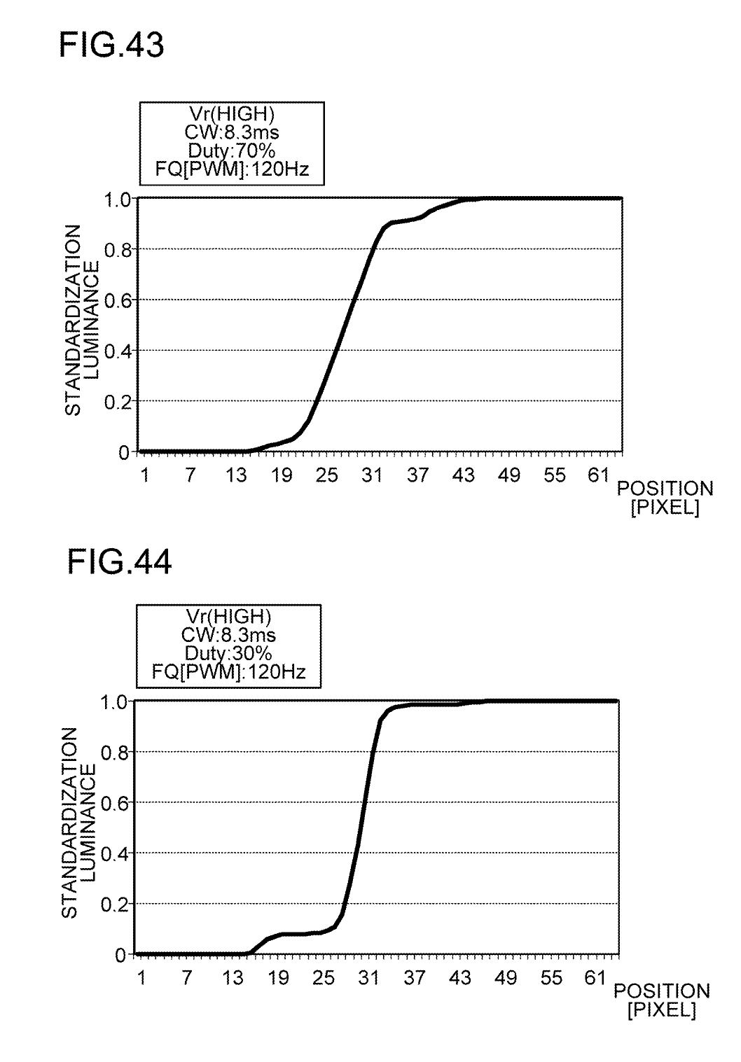

For instance, FIGS. 41 to 44 are graphs similar to FIGS. 14 to 17 (therefore, the scroll speed is 32 pixel/16.7 ms). FIG. 41 illustrates a case where the response speed Vr is relatively low and the duty factor is 70%, and FIG. 42 illustrates a case where the response speed Vr is relatively low and the duty factor is 30%. On the other hand, FIG. 43 illustrates a case where the response speed Vr is relatively high and the duty factor is 70%, and FIG. 44 illustrates a case where the response speed Vr is relatively high and the duty factor is 30%. Comparing these diagrams with FIGS. 14 to 17, followings can be said.

From comparison between FIG. 41 and FIG. 14, a step of the graph line that is not illustrated in FIG. 14 is confirmed in FIG. 41. In other words, in FIG. 41, there are continuous pixels having different integrated luminance change degrees (namely, inclinations of the graph line of FIG. 14). However, a difference of the integrated luminance change degree is not as large as illustrated in FIG. 15. Therefore, the multiple outlines are not generated.

On the contrary, in FIG. 42, the difference of the integrated luminance change degree is larger than in FIG. 15. Therefore, multiple outlines are generated more than in FIG. 15. Therefore, if the response speed Vr of the liquid crystal molecules 61M is relatively low, it is desired that the duty factor be larger than 50%, preferably 70% or larger, more preferably 100%. With this structure, the multiple outlines can be prevented.

In addition, comparing FIG. 43 with FIG. 18, the inclination of the graph line in FIG. 43 is larger than the inclination of the graph line in FIG. 18 (however, the afterimage is still visible). Further, comparing FIG. 44 with FIG. 17, the inclination of the graph line in FIG. 44 is larger than the inclination of the graph line in FIG. 17.

It is understood from these graphs that if the response speed Vr of the liquid crystal molecules 61M is relatively high, the effect of the black insertion becomes more conspicuous as the duty factor is smaller (for example, clearness or the like of the image quality is improved). In other words, if the response speed Vr of the liquid crystal molecules 61M is relatively high, it is preferred that the duty factor be 50% or smaller, preferably 30% or smaller.

### Second Embodiment

A second embodiment is described. Note that, a member having the same function as the member used in the first embodiment is denoted by the same numeral or symbol, and description thereof is omitted.

In the first embodiment, the duty factor of the PWM dimming signal, or the duty factor and the current value are changed variously for improving image quality. Other such control can be used to improve image quality. For instance, image quality can be improved by changing the drive frequency FQ[PWM] of the PWM dimming signal variously. Therefore, the liquid crystal display device 90 that performs such control is described below.

<In Regard to Liquid Crystal Display Device>

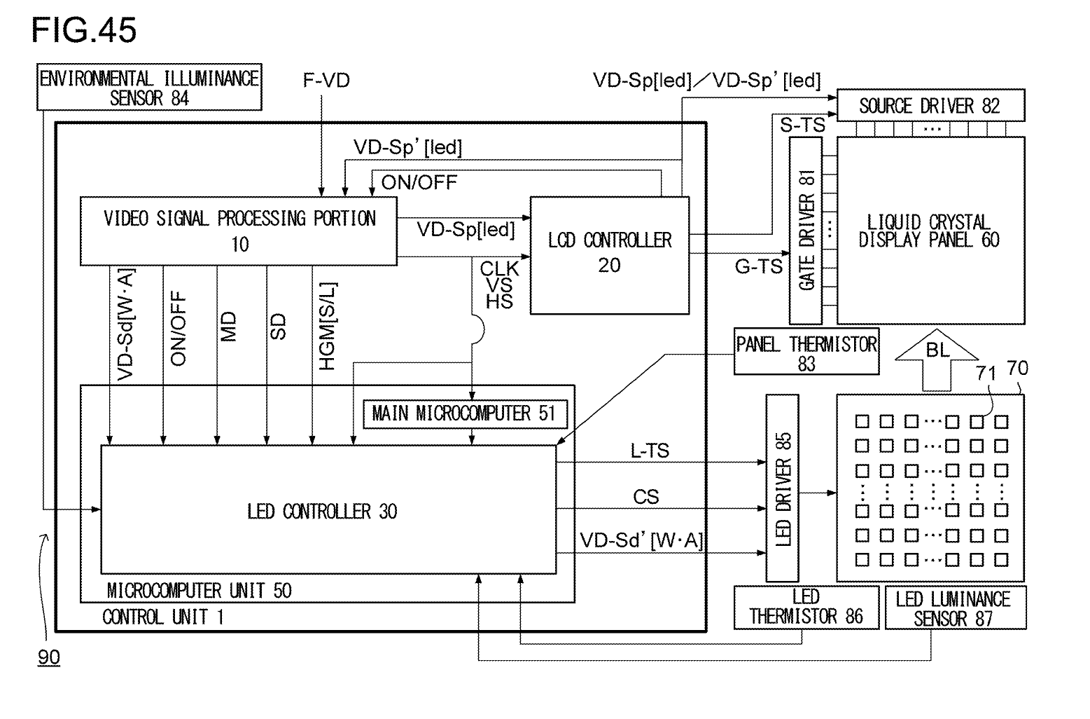

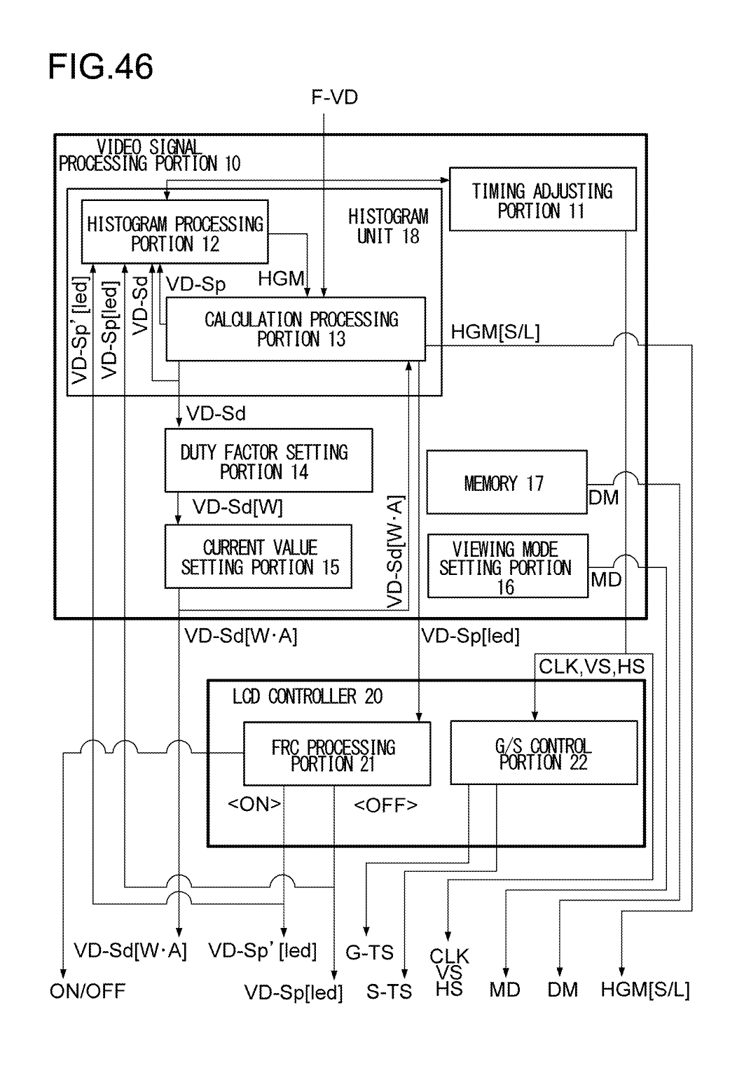

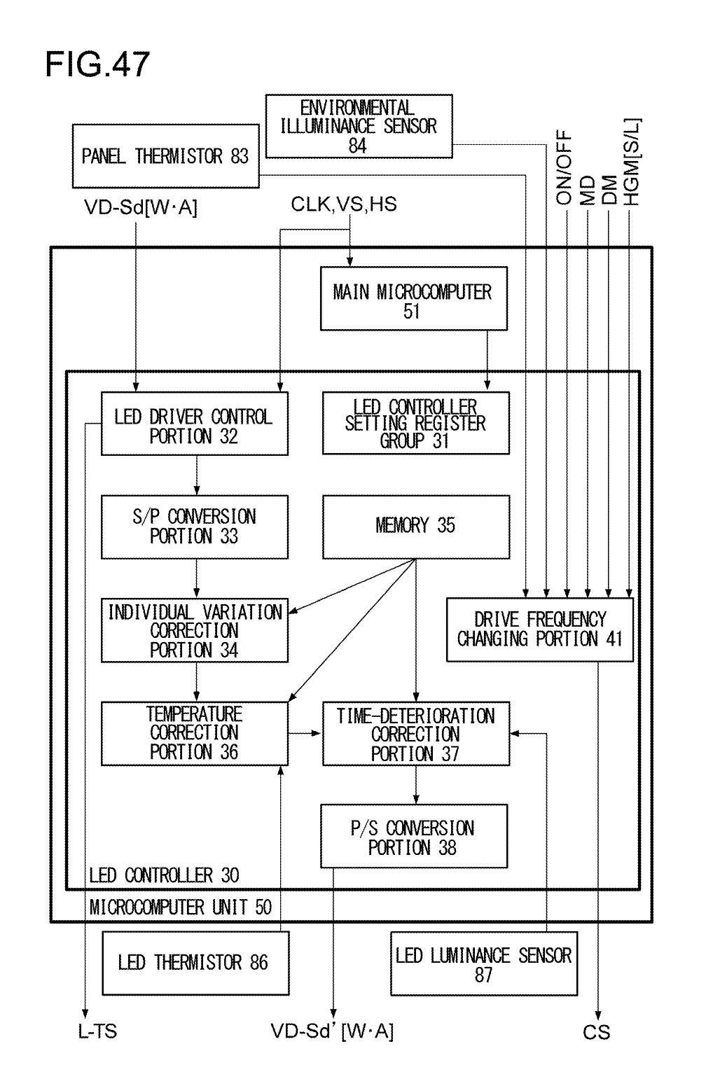

FIGS. 45 to 47 are block diagrams illustrating various members concerning a liquid crystal display device 90 (note that, FIGS. 46 and 47 are detailed block diagrams of parts extracted from FIG. 45). As one of differences between the liquid crystal display device 90 of the first embodiment and the liquid crystal display device 90 of the second embodiment, a set signal CS for setting the drive frequency of the LED 71 (drive frequency FQ[PWM] of the PWM dimming signal) is transmitted from the LED controller 30 to the LED driver 85 (see FIGS. 45 and 47).

In addition, as illustrated in FIGS. 46 and 47, the histogram data HGM(HGM[S]/HGM[L]) of the calculation processing portion 13, various data (memory data DM) stored in the memory 17, the mode type signal MD indicating a type of the viewing mode of the viewing mode setting portion 16, temperature data of the panel thermistor 83, and illuminance data of the environmental illuminance sensor 84 are not transmitted to the duty factor setting portion 14 but are transmitted to the control unit 1 (specifically, LED controller 30). In addition, the signal indicating presence or absence of the FRC processing from the FRC processing portion 21 (ON/OFF signal) is transmitted to the LED controller 30.

Specifically, the histogram data HGM, the memory data DM, the mode type signal MD, the temperature data, the illuminance data, and the ON/OFF signal are included in the LED controller 30 and are transmitted to a drive frequency changing portion 41 included in the LED controller 30. Then, the drive frequency changing portion 41 switches the drive frequency FQ[PWM] according to the liquid crystal temperature Tp.

For instance, if the frame frequency of the liquid crystal display panel 60 is 120 Hz, and the drive frequency FQ[PWM] of the PWM dimming signal is also 120 Hz (however, the duty factor is 50%), and if the liquid crystal temperature Tp is low, the multiple outlines may be generated as illustrated in FIG. 15. Therefore, in the first embodiment, the duty factor setting portion 14 controls the duty factor to be increased.

<In Regard to Image Quality Improvement Using Drive Frequency of PWM Dimming Signal for Light Emission Control of LED>

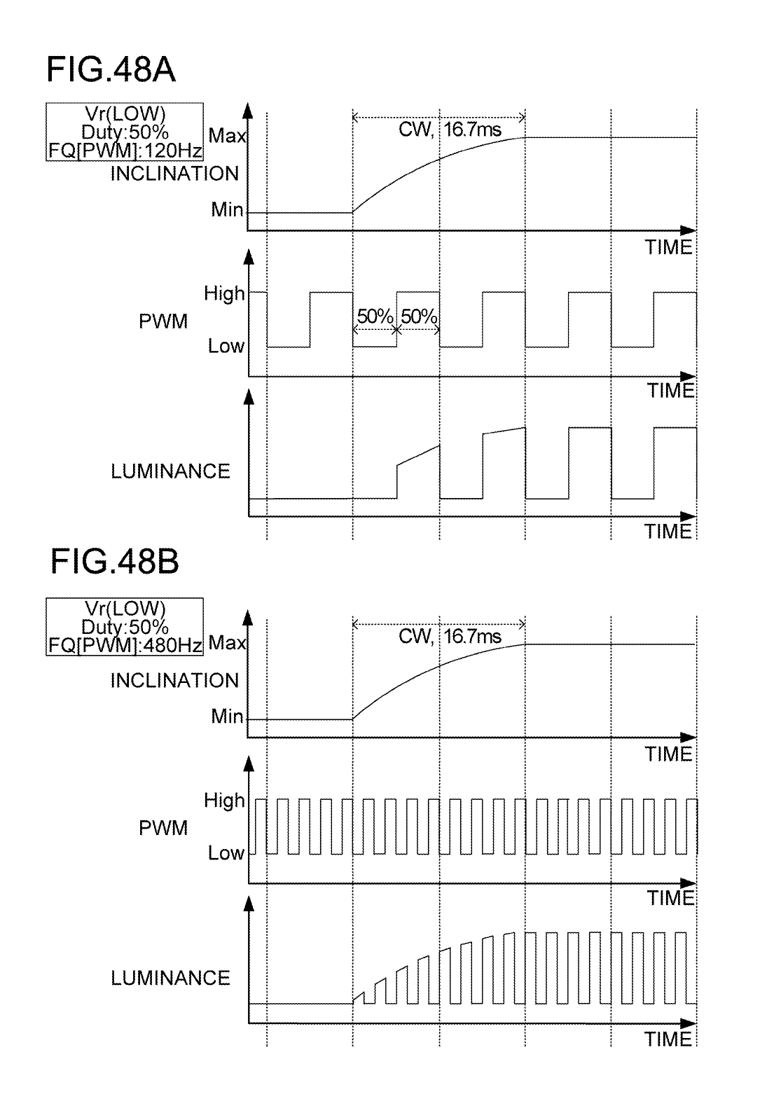

In the case of the second embodiment, the duty factor is not changed, but the drive frequency changing portion 41 changes the drive frequency FQ[PWM] of the PWM dimming signal to be a frequency higher than 120 Hz, for example, 480 Hz. Then, similarly to FIG. 48A corresponding to FIG. 15 (similar to FIG. 13B), even if the drive frequency FQ[PWM] is 480 Hz, light is supplied to the liquid crystal display panel 60 continuously with a predetermined interval in the response process time period CW (see FIG. 48B). Then, the luminance value of the supplied light is smaller than the maximum luminance value.

However, as apparent from comparison between FIGS. 48A and 48B, in the response period CW, the number of high level periods of the PWM dimming signal is increased more in the case where the drive frequency FQ[PWM] is 480 Hz than in the case where the drive frequency FQ[PWM] is 120 Hz.

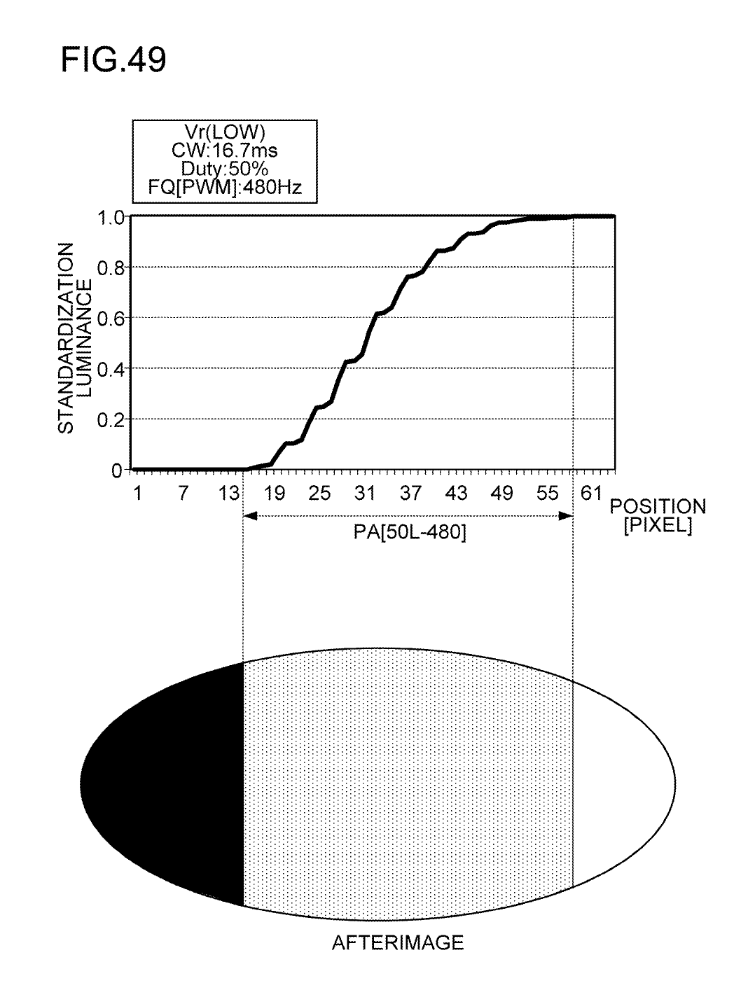

Then, as illustrated in FIGS. 12B to 12E, when the boundary between the black image and the white image is moved, the integrated luminance corresponding to the vicinity of the boundary becomes as illustrated in the graph of FIG. 49 (note that, the scroll speed is 32 pixel/16.7 ms). In other words, pixels receiving insufficient light for forming a complete white color image are generated in the vicinity of the boundary.

A pixel range PA [50L-480] in which such pixels are continuous is recognized as pixels having a problem (see the image diagram). Specifically, switching from the black image to the white image is not performed at high speed, and pixels having different integrated luminance change degrees (namely, inclinations of the graph line illustrated in FIG. 49) are included in the pixel range PA[50L-480].

However, unlike the case of FIG. 15, in the case of FIG. 49, the number of high level periods of the PWM dimming signal is large in the response process time period CW. Then, the number of steps of the graph line in FIG. 49 due to the integrated luminance change degree is larger than the number of steps of the graph line of FIG. 15. In this case, the graph line in FIG. 49 is the same as the graph line of FIG. 14 in pseudo manner. Therefore, in the case of FIG. 49, not the multiple outlines but only the afterimage is generated. In other words, it is possible to prevent occurrence of the multiple outlines that may be the largest cause of worst image quality deterioration.

<<Drive Frequency Change in PWM Dimming Signal>>

In view of the result illustrated in FIG. 49 as described above, if the drive frequency FQ[PWM] of the PWM dimming signal is changed according to the response speed Vr of the liquid crystal molecules 61M in the liquid crystal display device 90, it is possible to reflect the response characteristics of the liquid crystal molecules 61M so that quality of an image displayed on the liquid crystal display panel 60 can be improved (for example, occurrence of multiple outlines can be suppressed, while clearness or the like is improved).

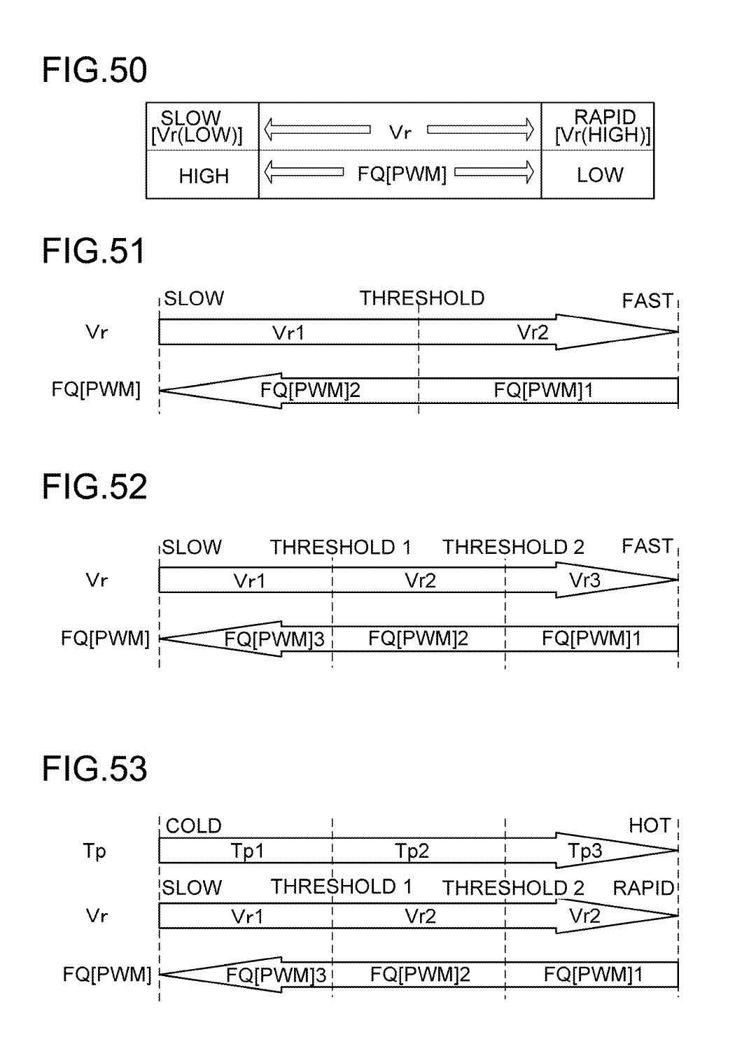

In other words, as shown in the table of FIG. 50, if the response speed Vr of the liquid crystal molecules 61M is relatively high, the LED 71 should be driven at relatively low drive frequency FQ[PWM]. On the other hand, if the response speed Vr of the liquid crystal molecules 61M is relatively low, the LED 71 should be driven at relatively high drive frequency FQ[PWM].

Note that, as described above in the first embodiment, the threshold value (response speed data threshold value) for determining high or low of the response speed Vr is set arbitrarily. Therefore, tables are generated using arrows similarly to FIGS. 20 and 21, and hence tables shown FIGS. 51 and 52 are obtained.

In other words, there is at least one arbitrary threshold value so that a plurality of ranges of arbitrary response speed Vr are set with a boundary of the threshold value, and the drive frequency FQ[PWM] should be changed for each range. With this structure, the response speed Vr of the liquid crystal molecules 61M is divided in steps, and image quality can be improved according to the step.

In particular, it is preferred to change the drive frequency FQ[PWM] for each range of the response speed Vr so as to have an opposite relationship with a magnitude relationship about the plurality of ranges of the response speed Vr. For instance, as illustrated in FIG. 51, if the value of the response speed Vr is a small value Vr1, the drive frequency FQ[PWM] should be a large value FQ[PWM] 2. If the value of the response speed Vr is a large value Vr2, the drive frequency FQ[PWM] should be a small value FQ[PWM] 1 (note that, a magnitude relationship of the data value of the response speed Vr is Vr1<Vr2, and a magnitude relationship of the data value of the drive frequency FQ[PWM] is FQ[PWM] 1<FQ[PWM] 2).

Here, one of variation factors of the response speed Vr of the liquid crystal molecules 61M in the liquid crystal display device 90 as one product is temperature Tp of the liquid crystal molecules 61M. Therefore, by adding a magnitude relationship of the data value of the temperature Tp to the table of FIG. 52, a table shown in FIG. 53 is obtained. Then, in order to obtain the data value of the response speed Vr from the temperature Tp of the liquid crystal molecules 61M, the control unit 1 of the liquid crystal display device 90 works as follows, for example.

Specifically, as illustrated in FIG. 47, the drive frequency changing portion 41 of the LED controller 30 included in the control unit 1 obtains the measured temperature data (temperature data) from the panel thermistor 83. Then, the drive frequency changing portion 41 obtains one of the memory data DM stored in the memory 17.

Specifically, this memory data DM is a data table of the response speed Vr of the liquid crystal molecules 61M depending on the temperature of the liquid crystal 61 (liquid crystal temperature Tp). In other words, the drive frequency changing portion 41 obtains the response speed Vr by associating the temperature data of the panel thermistor 83 with the liquid crystal temperature Tp of the data table.

Then, the drive frequency changing portion 41 sets the drive frequency FQ[PWM] of the PWM dimming signal corresponding to the obtained response speed Vr. Note that, this method of setting the drive frequency FQ[PWM] is not limited in particular. For instance, the drive frequency changing portion 41 may generate the set signal CS by its processing after obtaining the response speed Vr, to thereby set the drive frequency FQ[PWM], or may store by itself the data table of the drive frequency FQ[PWM] depending on the response speed Vr and generate the set signal CS by using the data table, to thereby set the drive frequency FQ[PWM].

<<In Regard to Other Factors>>

Here, the liquid crystal display device 90 also includes the video signal support function, the FRC processing function, the viewing mode setting function, and the environmental support function as described above in the first embodiment.

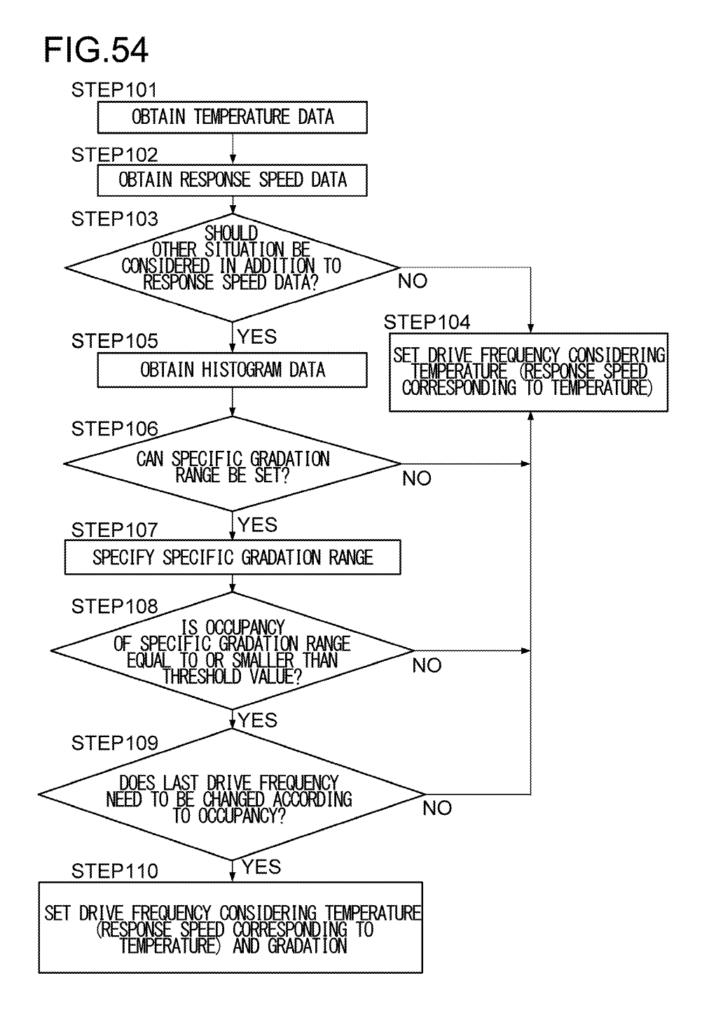

Further, there is a case where it is preferred that the drive frequency FQ[PWM] of the PWM dimming signal change according to the various functions. For instance, the drive frequency changing portion 41 of the LED controller 30 obtains the temperature data of the panel thermistor 83 as illustrated in the flowchart of FIG. 54 (STEP 101), and obtains the response speed Vr of the liquid crystal molecules 61M (STEP 102).

Therefore, the drive frequency changing portion 41 judges the response speed Vr (response speed data). Specifically, the drive frequency changing portion 41 judges whether or not setting of the drive frequency FQ[PWM] needs to be changed according to presence or absence of actions of the various functions (STEP 103). For instance, if the response speed Vr is high and if the drive frequency FQ[PWM] is set to be low regardless of presence or absence of actions of the various functions, in the case where the black insertion effect is obtained (in the case of NO in STEP 103), the drive frequency changing portion 41 sets the drive frequency FQ[PWM] to 120 Hz, for example, considering the response speed Vr corresponding to the liquid crystal temperature Tp (STEP 104). With this structure, motion picture performance or the like of the image quality is improved.

However, if the drive frequency changing portion 41 judges that it is desired to change setting of the drive frequency FQ[PWM] due to a fact that there are actions of various functions (in the case of YES in STEP 104), the drive frequency changing portion 41 sets the drive frequency FQ[PWM] considering the various functions. It is because image quality can be securely improved with this structure.

(Video Signal Support Function)

For instance, the drive frequency changing portion 41 may perform the judgment corresponding to luminance or the like of the video signal (average signal level ASL or the like). Usually, if the occupancy of the low gradation range is high in one frame image, for example, (namely, if the image is a relatively low gradation image), the light-on time of the LED 71 is set to be short (namely, the duty factor is small). On the other hand, if the occupancy of the low gradation range is low (namely, if the image is a relatively high gradation image), the light-on time of the LED 71 is set to be long (namely, the duty factor is large).

Then, if the image has a relatively high gradation, the liquid crystal molecules 61M may be conspicuous in the response process time period CW by light from the LED 71 (namely the backlight BL), and as a result, multiple outlines, afterimage, and the like can be generated.

Then, as illustrated in the flowchart of FIG. 54, the drive frequency FQ[PWM] is changed according to the occupancy of the gradation range in the image. Specifically, the drive frequency changing portion 41 obtains the histogram data HGM from the calculation processing portion 13 (STEP 105). Next, the drive frequency changing portion 41 obtains the gradation threshold value (gradation threshold value data) set according to the liquid crystal temperature Tp stored in the memory 17 in advance and judges whether or not the specific gradation range can be set (STEP 106).

It is because, as described above in the first embodiment, there is a case where the difference of the response time due to a gradation change at high liquid crystal temperature Tp is set to be allowable range as illustrated in FIG. 34, for example.

When this liquid crystal temperature Tp is high as in this case, it is unnecessary to set, using the histogram data HGM, a specific gradation range in which the drive frequency FQ[PWM] should be changed (in the case of NO in STEP 106). Therefore, in this case, the drive frequency changing portion 41 sets the drive frequency FQ[PWM] considering only the response speed Vr corresponding to the liquid crystal temperature Tp (STEP 104).

On the contrary, if the difference of the response time due to a gradation change when the liquid crystal temperature Tp is low is set to be outside the allowable range, the drive frequency changing portion 41 tries to change the drive frequency FQ[PWM] using the histogram data HGM (in the case of YES in STEP 106).

Specifically, the drive frequency changing portion 41 sets the specific gradation range in which the drive frequency FQ[PWM] should be changed from the histogram data HGM and the gradation threshold value set corresponding to the liquid crystal temperature Tp stored in the memory 17 (STEP 107). For instance, if the liquid crystal temperature Tp is low (for example, approximately 20° C.) in the MVA mode liquid crystal 61, a range from the 0th gradation level to 128th gradation level is set as the specific gradation range as illustrated in FIG. 35.

Further, the drive frequency changing portion 41 obtains the occupancy of the specific gradation range in the image (one frame image), and compares the occupancy with the threshold value concerning the occupancy of the specific gradation range (occupancy threshold value; for example, 50%) stored in the memory 17 (STEP 108).

Then, if the occupancy is not equal to or smaller than the threshold value (namely, if the occupancy is larger than the occupancy threshold value; in the case of NO in STEP 108), it can be said that the image is a low gradation image containing a high frequency of gradations in the specific gradation range from the 0th gradation level to 128th gradation level, for example. Then, the duty factor of the PWM dimming signal for a low gradation image is smaller than the duty factor of the PWM dimming signal for a high gradation image.

Therefore, the liquid crystal molecules 61M in the response process time period CW are hardly conspicuous by light from the LED 71, and as a result, multiple outlines, afterimage, and the like are hardly generated. Therefore, the drive frequency changing portion 41 sets the drive frequency FQ[PWM] considering only the response speed Vr corresponding to the liquid crystal temperature Tp to 120 Hz, for example (STEP 104).

On the contrary, if the occupancy is equal to or smaller than the threshold value (in the case of YES in STEP 108), it can be said that the image is a high gradation image containing only a small frequency of gradations in the specific gradation range from the 0th gradation level to 128th gradation level, for example. Then, the drive frequency changing portion 41 judges whether or not the last drive frequency FQ[PWM] needs to be changed according to the occupancy (STEP 109). It is because the last drive frequency FQ[PWM], namely the drive frequency FQ[PWM] set in STEP 104 may not be different from the drive frequency FQ[PWM] in the case where the occupancy is high (namely, in the case of a low gradation image).

Then, if the drive frequency changing portion 41 judges that the last drive frequency FQ[PWM] needs to be changed (in the case of YES in STEP 109), the drive frequency FQ[PWM] is set considering the response speed Vr corresponding to the liquid crystal temperature Tp and the gradations (namely, histogram data HGM) (STEP 110).

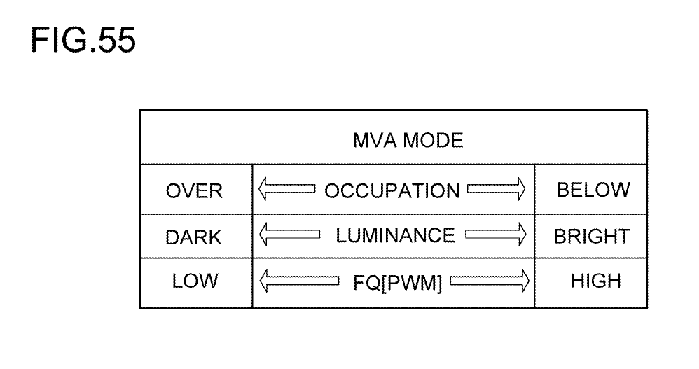

For instance, if a relatively high gradation image is displayed on the liquid crystal display panel 60 of the MVA mode liquid crystal display device 90, the drive frequency changing portion 41 sets a drive frequency FQ[PWM] to, for example, 480 Hz (note that, a tendency of the magnitude of the drive frequency changing portion 41 corresponding to a magnitude relationship of the occupancy is shown in the table of FIG. 55). With this structure, even if the duty factor is high for the high gradation image compared with the low gradation image, occurrence of the multiple outlines can be prevented.

On the other hand, if the drive frequency changing portion 41 judges that the last drive frequency FQ[PWM] does not need to be changed (in the case of NO in STEP 109), the drive frequency FQ[PWM] is set considering only the response speed Vr corresponding to the liquid crystal temperature Tp (STEP 104).

In other words, in the control unit 1, the histogram unit 18 generates a histogram of the video signal so as to generate histogram data HGM of a frequency distribution of the gradation. Further, the control unit 1 divides the entire gradation of the histogram data HGM and judges whether or not occupancy of at least one specific gradation range among the divided gradation ranges exceeds the occupancy threshold value.

Then, the drive frequency FQ[PWM] in the case where the occupancy threshold value is exceeded is set to be lower than the drive frequency in the case where the occupancy threshold value is not exceeded. On the other hand, the drive frequency in the case where the occupancy threshold value is not exceeded is set to be higher than the drive frequency in the case where the occupancy threshold value is exceeded.

Note that, in the MVA mode liquid crystal 61, in the case where the liquid crystal temperature Tp is approximately 20° C., the above-mentioned specific gradation range from the 0th gradation level to 128th gradation level, and the occupancy threshold value of 50% for the occupancy of the specific gradation range are merely examples as in the first embodiment (a plurality of specific gradation ranges may be prepared). In addition, the above-mentioned the drive frequencies FQ[PWM] of 480 Hz and 120 Hz are merely examples.

In addition, as illustrated in FIGS. 38 and 39, also in the case of the IPS mode liquid crystal 61, similarly to the first embodiment, the specific gradation range of the image is set, and further the drive frequency FQ[PWM] may not be changed according to the occupancy of the specific range. However, the drive frequency FQ[PWM] may be changed according to the video signal support function in some cases.

(FRC Processing Function)

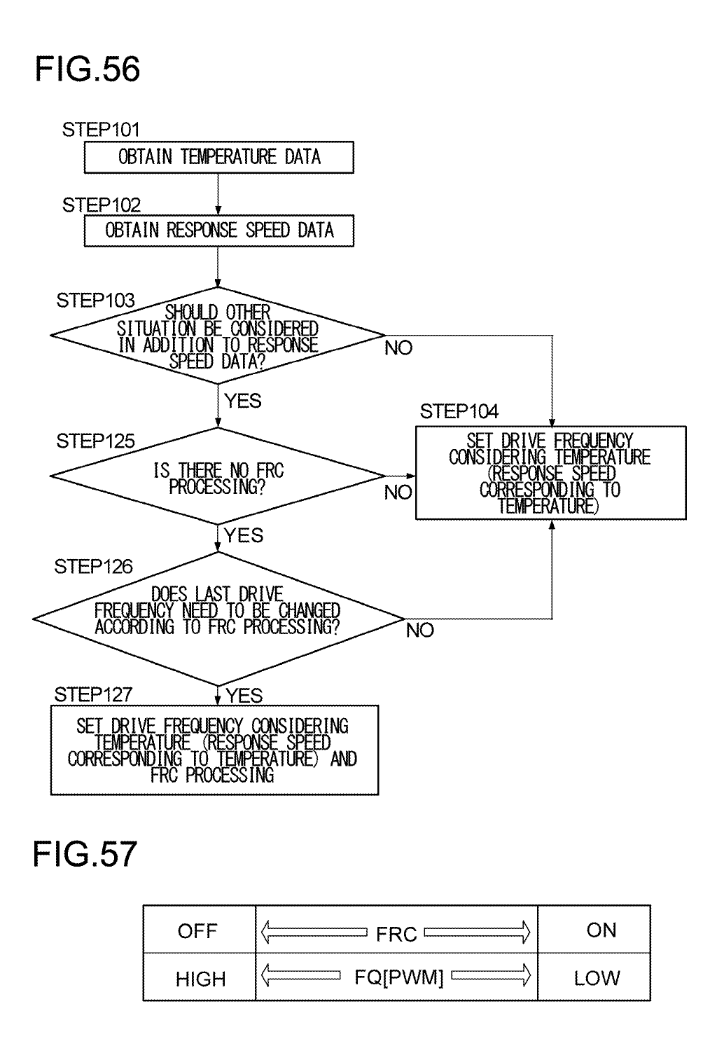

In addition, as illustrated in a flowchart of FIG. 56 (STEP 101 to STEP 104 are the same as described above), the drive frequency changing portion 41 may judge presence or absence of the FRC processing (STEP 105). Specifically, the drive frequency changing portion 41 receives a signal (ON/OFF signal) indicating presence or absence of the FRC processing from the FRC processing portion 21 of the LCD controller 20.

Then, if the FRC processing is performed (in the case of NO in STEP 125), the video change between frames is relatively modest. Therefore, the inclination of the liquid crystal molecules 61M in the response process time period CW is hardly conspicuous. Therefore, in order to make the motion picture performance conspicuous, the drive frequency changing portion 41 sets the drive frequency FQ[PWM] that is similar to the drive frequency FQ[PWM] considering the response speed Vr corresponding to the liquid crystal temperature Tp (STEP 104).

On the other hand, if the FRC processing is not performed (in the case of YES in STEP 125), the drive frequency changing portion 41 judges whether or not the last drive frequency FQ[PWM] needs to be changed according to the FRC processing (STEP 126). It is because there is a case where the last drive frequency FQ[PWM], namely the drive frequency FQ[PWM] set in STEP 104 may be the same as the drive frequency FQ[PWM] when the FRC processing is performed.

Then, if the drive frequency changing portion 41 judges that the last drive frequency FQ[PWM] needs to be changed (in the case of YES in STEP 126), the drive frequency FQ[PWM] is set considering the response speed Vr corresponding to the liquid crystal temperature Tp and the FRC processing (STEP 127). For instance, if there is no FRC processing, the drive frequency changing portion 41 improves the drive frequency FQ[PWM] (note that, a tendency of the magnitude of the drive frequency FQ[PWM] corresponding to the presence or absence of the FRC processing is shown in the table of FIG. 57). With this structure, occurrence of the multiple outlines can be prevented.

On the other hand, if the drive frequency changing portion 41 judges that the last drive frequency FQ[PWM] does not need to be changed (in the case of NO in STEP 126), the drive frequency FQ[PWM] is set considering only the response speed Vr corresponding to the liquid crystal temperature Tp (STEP 104).

In other words, the control unit 1 illustrated in FIG. 1 includes the FRC processing portion 21 that performs the frame rate control processing, and the control unit 1 (specifically, the drive frequency changing portion 41) changes the drive frequency FQ[PWM] according to presence or absence of the FRC processing by the FRC processing portion 21. Note that, the drive frequency FQ[PWM] in the case where the FRC processing is performed is lower than the drive frequency FQ[PWM] in the case where the FRC processing is not performed (see FIG. 57).

(Viewing Mode Setting Function)

In addition, the drive frequency changing portion 41 may perform the judgment according to the setting of the viewing mode. Specifically, the drive frequency changing portion 41 receives a mode type signal MD indicating a type of the viewing mode from the viewing mode setting portion 16 of the video signal processing portion 10, for example, a signal indicating Natural Mode having a relatively low motion picture level.

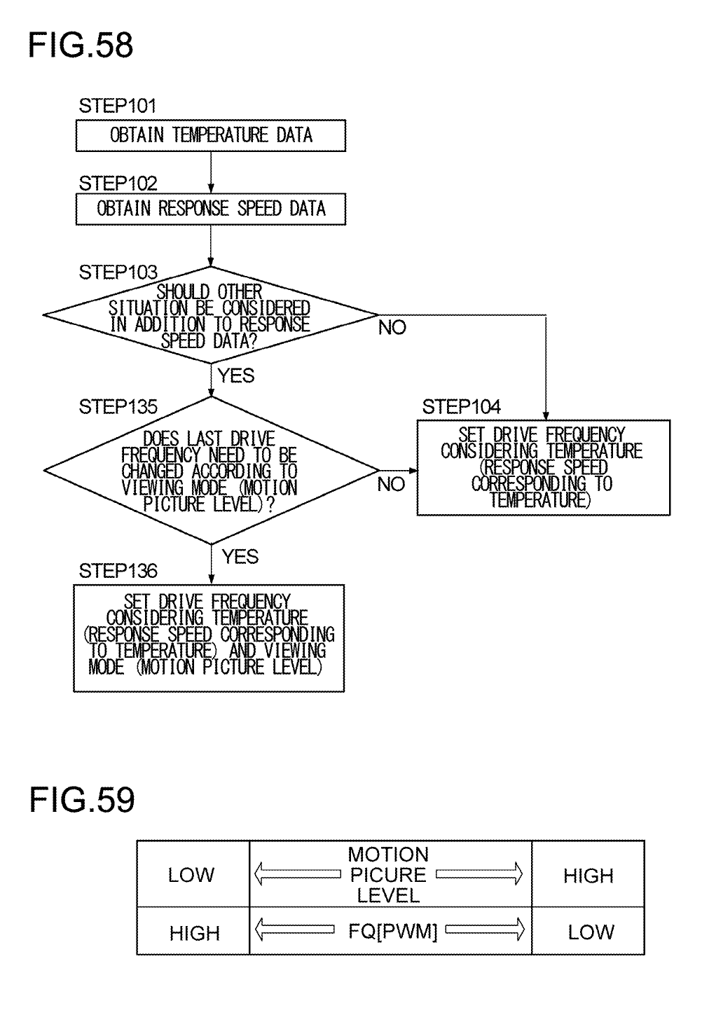

Then, as illustrated in the flowchart of FIG. 58 (STEP 101 to STEP 104 are the same as described above), the drive frequency changing portion 41 judges whether or not the last drive frequency FQ[PWM] needs to be changed according to the motion picture level (STEP 135). It is because the last drive frequency FQ[PWM], namely the drive frequency FQ[PWM] set in STEP 104 may be the same as the drive frequency FQ[PWM] in the case where the motion picture level is low.

Then, if the drive frequency changing portion 41 judges that the last drive frequency FQ[PWM] needs to be changed (in the case of YES in STEP 135), the drive frequency FQ[PWM] is set considering the response speed Vr corresponding to the liquid crystal temperature Tp and the motion picture level (STEP 136). For instance, if Natural Mode is set, the drive frequency changing portion 41 improves the drive frequency FQ[PWM] (note that, a tendency of the magnitude of the drive frequency FQ[PWM] corresponding to a magnitude relationship of the motion picture level is shown in the table of FIG. 59). With this structure, occurrence of the multiple outlines can be prevented.

On the other hand, if the drive frequency changing portion 41 judges that the last drive frequency FQ[PWM] does not need to be changed (in the case of NO in STEP 135), the drive frequency FQ[PWM] is set considering only the response speed Vr corresponding to the liquid crystal temperature Tp (STEP 104).

In other words, the control unit 1 includes the viewing mode setting portion 16 for switching the viewing mode of the liquid crystal display panel 60. When the viewing mode setting portion 16 switches the viewing mode, the control unit 1 (specifically, the drive frequency changing portion 41) changes the drive frequency FQ[PWM] according to the selected viewing mode.

Then, as an example of the drive frequency FQ[PWM] change, as described above, if the viewing mode setting portion 16 sets the high motion picture level viewing mode and the low motion picture level viewing mode according to the motion picture level of the video data, the drive frequency FQ[PWM] is changed for each selected viewing mode so as to have an opposite relationship with high or low (magnitude relationship) of the motion picture level in a plurality of viewing modes (see FIG. 59).

In addition, the drive frequency changing portion 41 may perform the judgment according to the setting of the viewing mode of a different contrast ratio. Specifically, the drive frequency changing portion 41 receives a signal mode type signal MD indicating a type of the viewing mode from the viewing mode setting portion 16, for example, a signal indicating Cinema Mode having a relatively low contrast ratio.

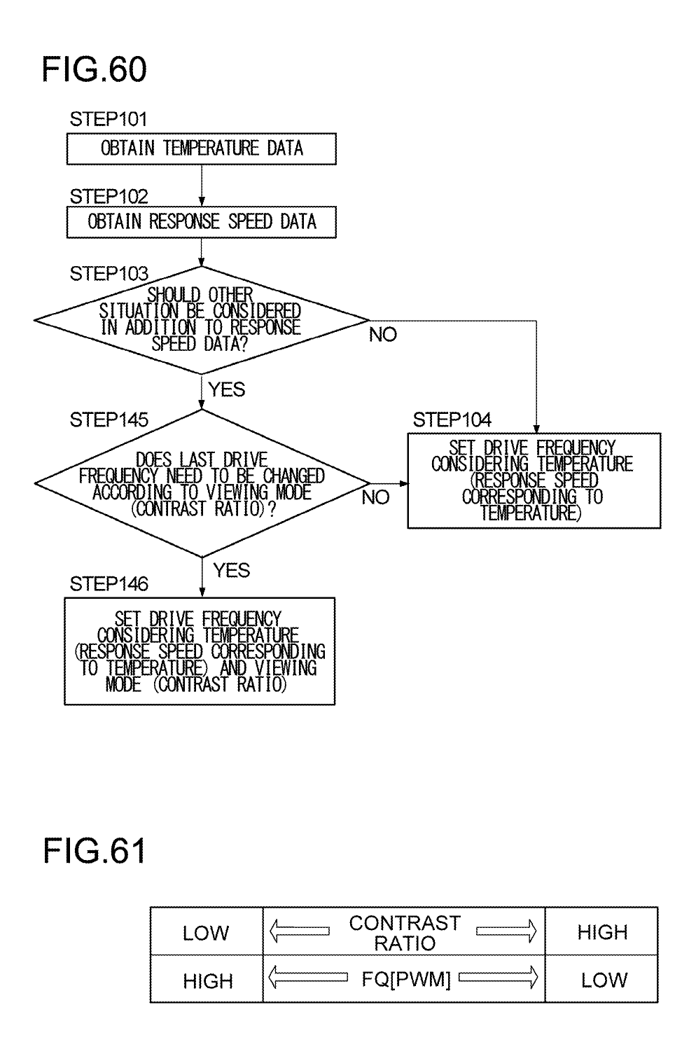

Then, as illustrated in the flowchart of FIG. 60 (STEP 101 to STEP 104 are the same as described above), the drive frequency changing portion 41 judges whether or not the last drive frequency changing portion 41 needs to be changed according to the contrast ratio (STEP 145). It is because the last drive frequency FQ[PWM], namely the drive frequency FQ[PWM] set in STEP 104 may be the same as the drive frequency FQ[PWM] in the case where the contrast ratio is low.

Then, if the drive frequency changing portion 41 judges that the last drive frequency FQ[PWM] needs to be changed (in the case of YES in STEP 145), the drive frequency FQ[PWM] is set considering the response speed Vr corresponding to the liquid crystal temperature Tp and the contrast ratio (STEP 146). For instance, if Cinema Mode is set, the drive frequency changing portion 41 improves the drive frequency FQ[PWM] (note that, a tendency of the magnitude of the drive frequency FQ[PWM] corresponding to a magnitude relationship of the contrast ratio is shown in the table of FIG. 61). With this structure, occurrence of the multiple outlines can be prevented.

On the other hand, if the drive frequency changing portion 41 judges that the last drive frequency FQ[PWM] does not need to be changed (in the case of NO in STEP 145), the drive frequency FQ[PWM] is set considering only the response speed Vr corresponding to the liquid crystal temperature Tp (STEP 104).

In other words, if the viewing mode setting portion 16 sets a high contrast level viewing mode and a low contrast level viewing mode according to a contrast level of the video data, the drive frequency FQ[PWM] is changed for each selected viewing mode so as to have an opposite relationship with high or low (magnitude relationship) of the contrast level in a plurality of viewing modes (see FIG. 61).

Note that, there are many types of viewing modes, and the drive frequency changing portion 41 may set the drive frequency FQ[PWM] in combination of the various modes. For instance, the drive frequency changing portion 41 receives the mode type signal MD indicating a type of the viewing mode from the viewing mode setting portion 16, for example, a signal indicating Natural Mode having a relatively low motion picture level and Cinema Mode having a relatively low contrast ratio.

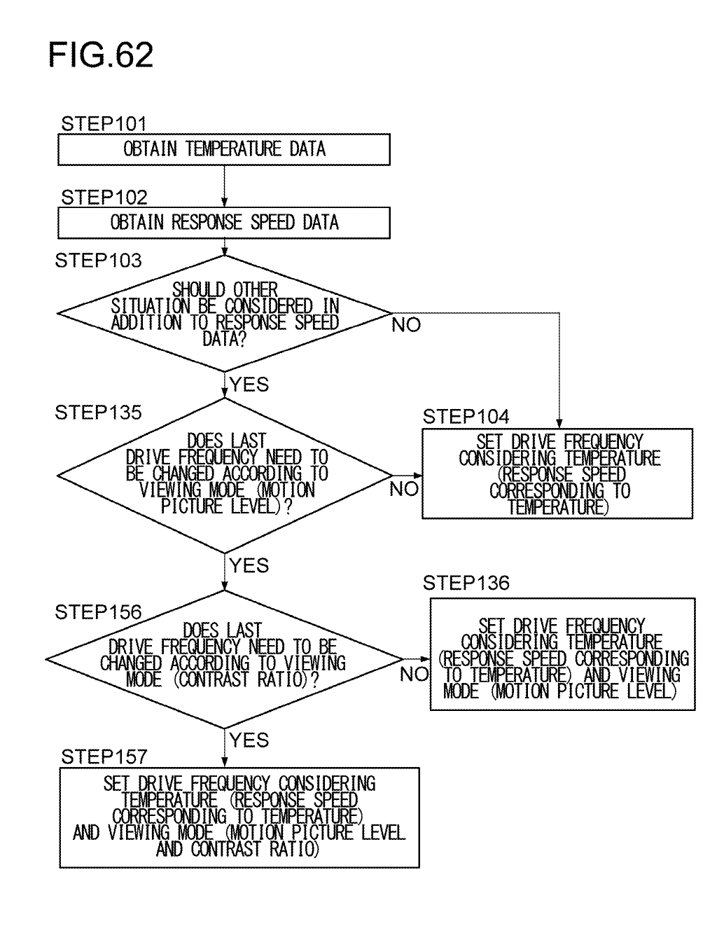

Then, as illustrated in the flowchart of FIG. 62 (STEP 101 to STEP 104 are the same as described above), the drive frequency changing portion 41 judges whether or not the last drive frequency FQ[PWM] needs to be changed according to the motion picture level, for example (STEP 135). Then, if it is judged that the last drive frequency FQ[PWM] does not need to be changed (in the case of NO in STEP 135), the drive frequency changing portion 41 sets the drive frequency FQ[PWM] considering only the response speed Vr corresponding to the liquid crystal temperature Tp (STEP 104).

On the other hand, if the drive frequency changing portion 41 judges that the last drive frequency FQ[PWM] needs to be changed (in the case of YES in STEP 135), it is further judged whether or not the last drive frequency FQ[PWM] needs to be changed according to the contrast ratio (STEP 156). Then, if the drive frequency changing portion 41 judges that the last drive frequency FQ[PWM] needs to be changed (in the case of YES in STEP 156), the drive frequency FQ[PWM] is set considering the response speed Vr corresponding to the liquid crystal temperature Tp, the motion picture level, and the contrast ratio (STEP 157).

On the other hand, if the drive frequency changing portion 41 judges that the last drive frequency FQ[PWM] does not need to be changed (in the case of NO in STEP 156), the drive frequency FQ[PWM] is set considering the response speed Vr corresponding to the liquid crystal temperature Tp and the motion picture level (STEP 136).

Note that, in the flowchart of FIG. 62, the motion picture level is considered first, and then the contrast ratio is considered, but this order may be different.

(Environmental Support Function)

In addition, the drive frequency changing portion 41 may perform the judgment according to brightness of the environment in which the liquid crystal molecules 61M are placed. Specifically, the drive frequency changing portion 41 receives illuminance data of the environmental illuminance sensor 84 (namely, the drive frequency changing portion 41 judges brightness of the place where the liquid crystal display device 90 is placed, based on illuminance measured by the environmental illuminance sensor 84 that measures external illuminance).

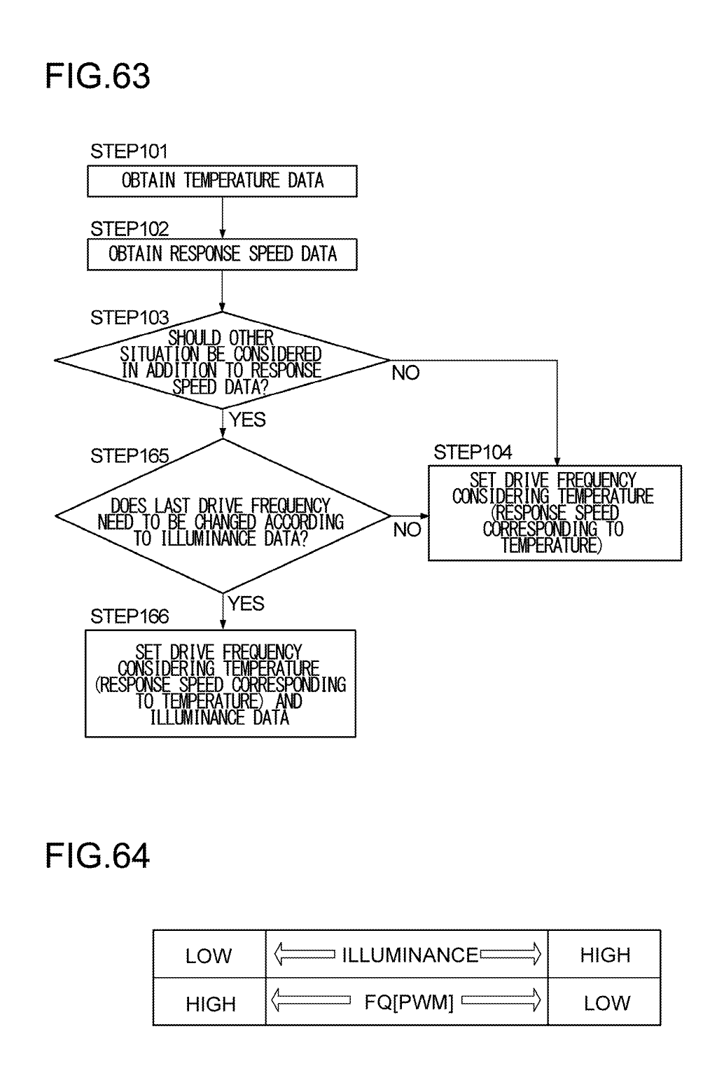

Then, as illustrated in the flowchart of FIG. 63 (STEP 101 to STEP 104 are the same as described above), the drive frequency changing portion 41 judges whether or not the last drive frequency FQ[PWM] needs to be changed according to the illuminance data (STEP 165). It is because the last drive frequency FQ[PWM], namely the drive frequency FQ[PWM] set in STEP 104 may be the same as the drive frequency FQ[PWM] in the case where the illuminance data is high (namely, in the case where the environment is relatively bright).

Then, if the drive frequency changing portion 41 judges that the last drive frequency FQ[PWM] needs to be changed (in the case of YES in STEP 165), the drive frequency FQ[PWM] is set considering the response speed Vr corresponding to the liquid crystal temperature Tp and the illuminance data (STEP 166). For instance, if the liquid crystal display device 90 is placed in a relatively dark environment, the drive frequency changing portion 41 improves the drive frequency FQ[PWM] (note that, a tendency of the magnitude of the drive frequency FQ[PWM] corresponding to the a magnitude relationship of the illuminance data is shown in the table of FIG. 64). With this structure, occurrence of the multiple outlines can be prevented.

On the other hand, if the drive frequency changing portion 41 judges that the last drive frequency FQ[PWM] does not need to be changed (in the case of NO in STEP 165), the drive frequency FQ[PWM] is set considering only the response speed Vr corresponding to the liquid crystal temperature Tp (STEP 104).

In other words, the control unit 1 illustrated in FIG. 1 obtains the external illuminance data and changes the drive frequency FQ[PWM] according to the illuminance data. Note that, the drive frequency FQ[PWM] is changed for each illuminance data range so as to have an opposite relationship to the magnitude relationship of the data value in each of a plurality of illuminance data ranges (see FIG. 64).

(Combination of Various Functions)

By the way, the video signal support function, the FRC processing function, the viewing mode setting function, and the environmental support function described above may act in various combinations. In this case too, the drive frequency FQ[PWM] may be changed.

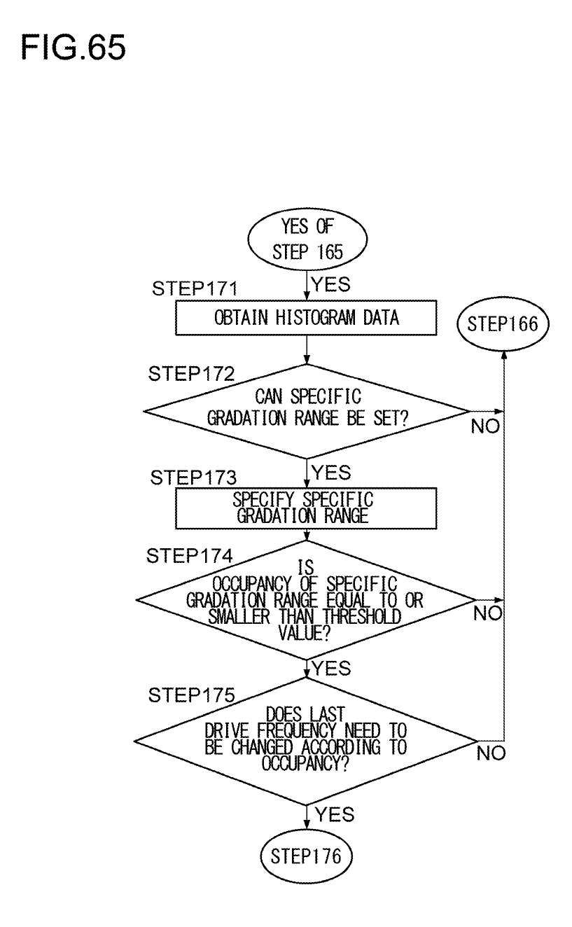

For instance, as illustrated in the flowchart of FIG. 63, if the drive frequency FQ[PWM] is changed according to the environmental support function, after YES in STEP 165, as illustrated in the flowchart of FIG. 65, the drive frequency changing portion 41 may perform the judgment on the video signal support function. In other words, the drive frequency changing portion 41 obtains the histogram data HGM from the calculation processing portion 13 (STEP 171), and further obtains the gradation threshold value (gradation threshold value data) that is set corresponding to the liquid crystal temperature Tp stored in the memory 17 in advance. Thus, the drive frequency changing portion 41 judges whether or not the specific gradation range can be set (STEP 172).

Then, if it is judged that the setting of a specific gradation range is not necessary (in the case of NO in STEP 172), the drive frequency changing portion 41 sets the drive frequency FQ[PWM] considering the response speed Vr corresponding to the liquid crystal temperature Tp and the illuminance data (STEP 166).

On the other hand, if the specific gradation range can be set (in the case of YES in STEP 172), the drive frequency changing portion 41 sets the specific gradation range (STEP 173), and further obtains the occupancy of the image in the specific gradation range (one frame image). Then, the drive frequency changing portion 41 compares the occupancy with the threshold value of the occupancy of the specific gradation range stored in the memory 17 (STEP 174).

Then, if the occupancy is not equal to or smaller than the threshold value (in the case of NO in STEP 174), it can be said that the image is a low gradation image containing a high frequency of gradations in the specific gradation range from the 0th gradation level to the 128th gradation level, for example. Therefore, the liquid crystal molecules 61M in the response process time period CW are hardly conspicuous by the light from the LED 71, and as a result, the multiple outlines, the afterimage, and the like can hardly be generated. Therefore, the drive frequency changing portion 41 sets the drive frequency FQ[PWM] considering the response speed Vr corresponding to the liquid crystal temperature Tp and the illuminance data (STEP 166).

On the contrary, if the occupancy is equal to or smaller than the threshold value (in the case of YES in STEP 174), it can be said that the image is a high gradation image containing a low frequency of gradations in the specific gradation range from the 0th gradation level to 128th gradation level, for example. Then, the drive frequency changing portion 41 judges whether or not the last drive frequency FQ[PWM] needs to be changed according to the occupancy (STEP 175).

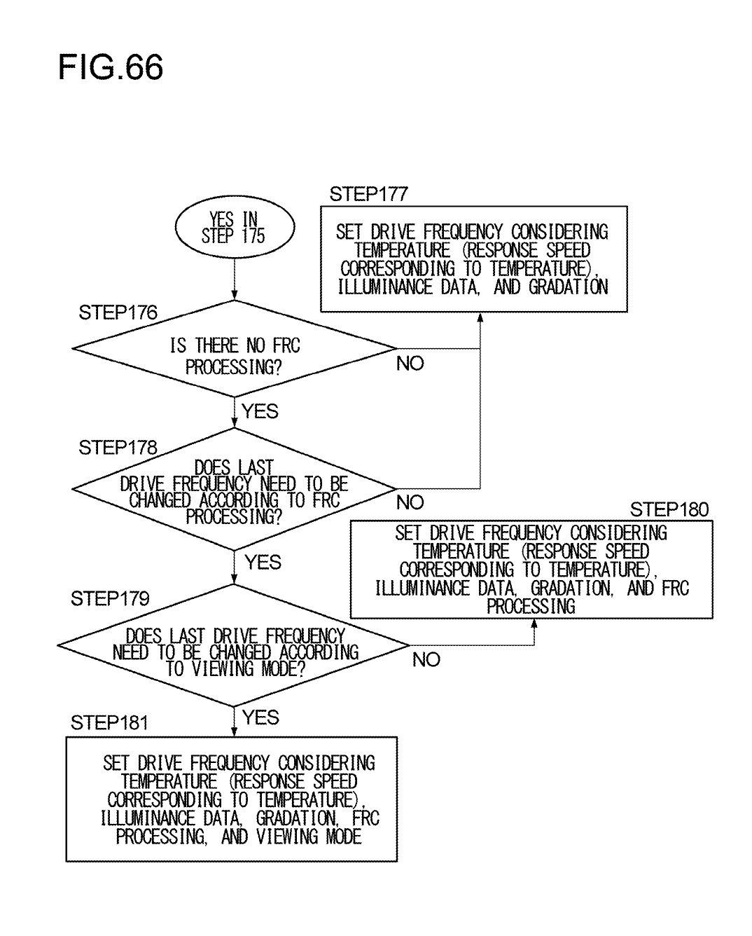

Then, if the drive frequency changing portion 41 judges that the last drive frequency FQ[PWM] needs to be changed (in the case of YES in STEP 175; followed by the flowchart of FIG. 66), presence or absence of the FRC processing is judged (STEP 176). Then, if the FRC processing is not performed (in the case of NO in STEP 176), the drive frequency changing portion 41 sets the drive frequency FQ[PWM] considering the response speed Vr corresponding to the liquid crystal temperature Tp, the illuminance data, and the gradation (STEP 177).

On the other hand, if the FRC processing is performed, the drive frequency changing portion 41 judges whether or not the last drive frequency FQ[PWM] needs to be changed (STEP 178). Then, if the drive frequency changing portion 41 judges that the last drive frequency FQ[PWM] does not need to be changed (in the case of NO in STEP 178), the drive frequency changing portion 41 sets the duty factor considering the response speed Vr corresponding to the liquid crystal temperature Tp, the illuminance data, and the gradation (STEP 177).

On the other hand, if the drive frequency changing portion 41 judges that the last drive frequency FQ[PWM] needs to be changed (in the case of YES in STEP 178), it is judged next whether or not the last drive frequency FQ[PWM] needs to be changed according to the viewing mode (for example, the motion picture level) (STEP 179). Then, if the drive frequency changing portion 41 judges that the last drive frequency FQ[PWM] does not need to be changed (in the case of NO in STEP 179), the drive frequency changing portion sets the duty factor considering the response speed Vr corresponding to the liquid crystal temperature Tp, the illuminance data, the gradation, and the FRC processing (STEP 180).

On the other hand, if the drive frequency changing portion 41 judges that the last drive frequency FQ[PWM] needs to be changed (in the case of YES in STEP 179), the drive frequency changing portion 41 sets the duty factor considering the response speed Vr corresponding to the liquid crystal temperature Tp, the illuminance data, the gradation, the FRC processing, and the viewing mode (STEP 181).

As illustrated in the flowcharts of FIGS. 63, 65, and 66, even if the environmental support function, the video signal support function, the FRC processing function, and the viewing mode setting function are combined for action, the drive frequency changing portion 41 can change the drive frequency changing portion 41.

In addition, the order of the functions is not limited to the order of the environmental support function, the video signal support function, the FRC processing function, and the viewing mode setting function as illustrated in the flowcharts of FIGS. 63, 65, and 66. The order may be changed. In addition, the number of combinations of the functions is not limited to four including the environmental support function, the video signal support function, the FRC processing function, and the viewing mode setting function. The number may be three or smaller, or five or larger if there are other various functions.

<<In Regard to Value of Drive Frequency of PWM Dimming Signal>>

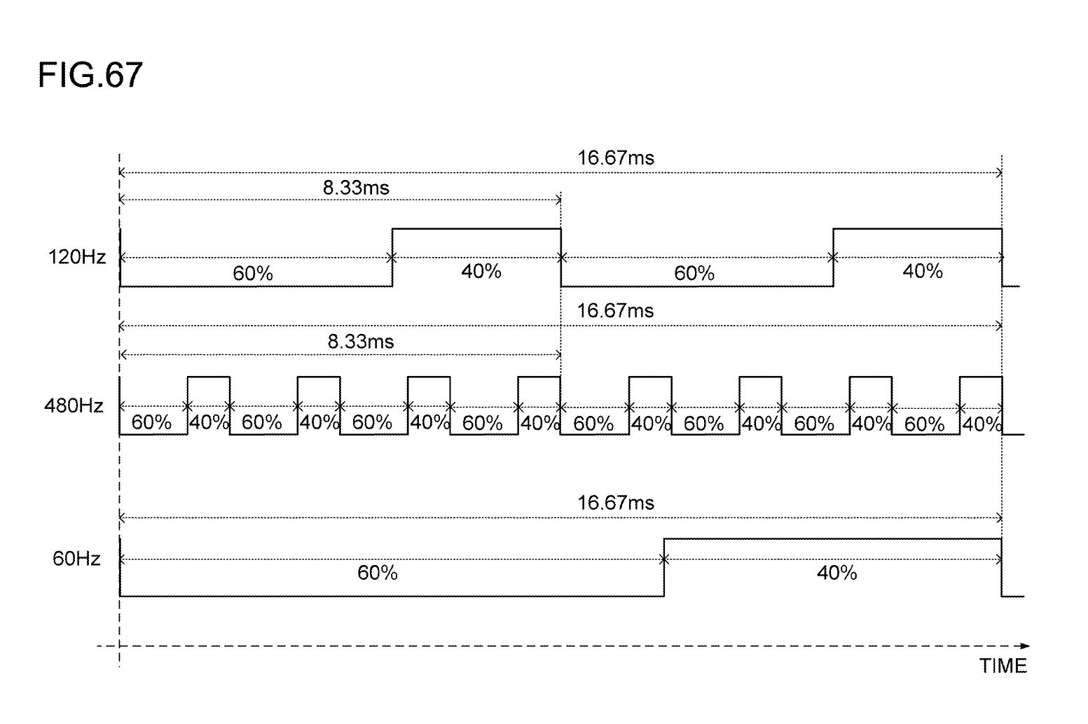

By the way, the above description is directed to an example in which, when the frame frequency is 120 Hz, the drive frequency FQ[PWM] of the PWM dimming signal is 120 Hz or 480 Hz as illustrated in FIG. 67 (note that, the duty factor of the PWM dimming signal is 40% in FIG. 67). However, this is not a limitation.

For instance, the drive frequency FQ[PWM] may be a value lower than 480 Hz and higher than 120 Hz, such as 240 Hz or 360 Hz, or may be a value higher than 480 Hz (namely, the drive frequency FQ[PWM] may be the same as the frame frequency or higher). However, it is desired that the drive frequency FQ[PWM] be an integral multiple of the frame frequency because synchronization between the frame frequency and the drive frequency FQ[PWM] can be easily obtained.

Note that, if the deterioration of the image quality does not occur excessively, the drive frequency FQ[PWM] may be smaller than the frame frequency. For instance, the drive frequency FQ[PWM] of the LED 71 may be 120 Hz for the liquid crystal display panel 60 that is driven at the frame frequency of 240 Hz, which has become widespread in the market.

Note that, in this case, the control unit 1 matches a low level period of the PWM dimming signal with at least one frame period in the continuous frames. It is because deterioration of image quality does not occur excessively.

In addition, the drive frequency FQ[PWM] of the LED 71 may be 60 Hz (see FIG. 67) for the liquid crystal display panel 60 that is driven at the frame frequency of 120 Hz. In this case of the drive frequency FQ[PWM] at 60 Hz, although flickers are conspicuous a little, the effect of the black insertion becomes remarkable (note that, in the case of the drive frequency FQ[PWM] at 120 Hz or 480 Hz, no flicker is conspicuous).

In addition, as illustrated in FIG. 48B, it is desired that the last timing in one frame period be synchronized with the last timing of the high level period in the PWM dimming signal (note that, the frame frequency of the liquid crystal display panel 60 is also 120 Hz, and one section along the time axis between dotted lines indicates one frame).

With this structure, similarly to FIGS. 13A to 13D, the low level period of the PWM dimming signal corresponds to a time period in which the liquid crystal molecules 61M start to be inclined (the beginning of the response process time period CW), and light from the LED 71 does not enter. Therefore, an image quality deterioration degree due to the inclination of the liquid crystal molecules 61M can be reduced.

### Other Embodiments

Note that, the present invention is not limited to the embodiments described above, and various modifications are possible in the scope without deviating from the spirit of the present invention.

<<Overdrive>>

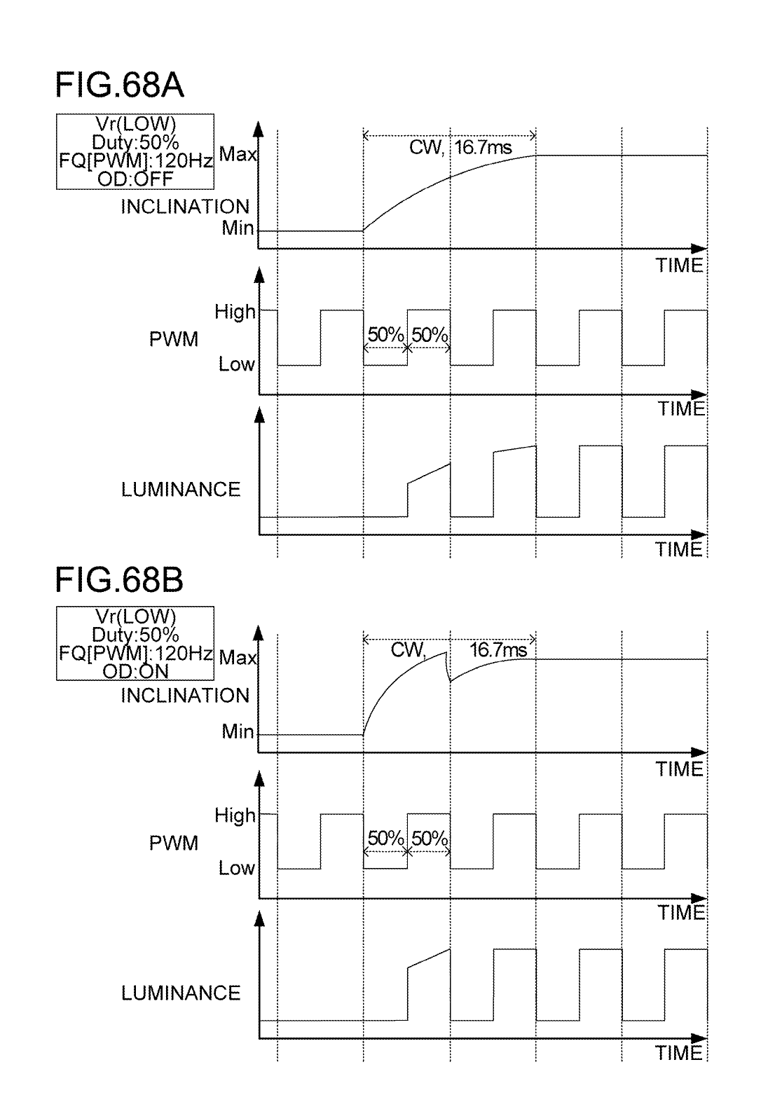

For instance, in the liquid crystal display device 90, an overdrive voltage may be applied to the liquid crystal 61 in order to increase the response speed Vr of the liquid crystal 61. In other words, as illustrated in FIG. 68A (similar to FIG. 13B), even when the response speed Vr is relatively low, if the applied voltage to the liquid crystal 61 is an overdrive (OD) voltage, the upper graph of FIG. 68B is obtained.

Specifically, as is clear from comparison between the response speed Vr illustrated in FIG. 68B and the response speed Vr illustrated in FIG. 68A, the response speed Vr of FIG. 68B corresponding to the first half of the response process time period CW is increased more rapidly than the response speed Vr of FIG. 68A. Further, the response speed Vr of FIG. 68B corresponding to the second half of the response process time period CW is increased a little more rapidly than the response speed Vr of FIG. 68A (namely, the graph line of the upper graph of FIG. 68B shows an overshoot in the first half of the response process time period CW).

With this structure, as illustrated in the lower graph of FIG. 68B, the luminance value in the response process time period CW is higher than the luminance value in the lower graph of FIG. 68A. Therefore, multiple outlines or the like as illustrated in FIG. 15 are hardly generated. In other words, in the liquid crystal display device 90, even if the control unit 1 performs the overdrive of the applied voltage to the liquid crystal 61 according to the response speed of the liquid crystal molecules 61M, image quality can be improved (for example, clearness of image quality of motion picture can be improved).

The point is that the control unit 1 has a function of performing the overdrive of the applied voltage to the liquid crystal 61. Then, the control unit 1 changes the duty factor of the PWM dimming signal according to presence or absence of the overdrive. Note that, the duty factor in the case where the overdrive processing is performed is lower than the duty factor in the case where the overdrive processing is not performed (note that, the current value AM may be changed according to the change of the duty factor).

In addition, the control unit 1 may change the drive frequency FQ[PWM] of the PWM dimming signal according to presence or absence of the overdrive. Note that, the drive frequency FQ[PWM] in the case where the overdrive processing is performed is lower than the drive frequency FQ[PWM] in the case where the overdrive processing is not performed. Then, if the control unit 1 performs any one of the controls described above, image quality of the liquid crystal display device 90 can be improved.

<In Regard to Liquid Crystal Display Device>

In the first embodiment, the duty factor setting portion 14 and the current value setting portion 15 are included in the video signal processing portion 10 of the control unit 1. However, those portions may be included in the LED controller 30, rather than in the video signal processing portion 10. In other words, the LED controller 30 may change the duty factor of the PWM dimming signal, or the duty factor and the current value thereof, using the duty factor setting portion 14 and the current value setting portion 15.

In addition, in the second embodiment, the drive frequency changing portion 41 is included in the LED controller 30. However, the drive frequency changing portion 41 may be included in the video signal processing portion 10, rather than in the LED controller 30. In other words, the video signal processing portion 10 may change the drive frequency FQ[PWM] of the PWM dimming signal using the drive frequency changing portion 41.

In addition, in the above description, the control unit 1 receives video and audio signals such as a television broadcasting signal, and the video signal in the video and audio signals is processed by the video signal processing portion 102. Therefore, a reception apparatus including the liquid crystal display device 90 is a television broadcasting reception apparatus (so-called liquid crystal television set). However, the video signal processed by the liquid crystal display device 90 is not limited to the television broadcasting. For instance, the video signal may be a video signal contained in a recording medium that records contents such as movies, or a video signal transmitted via the Internet.

The point is that the duty factor setting portion 14, the current value setting portion 15, and the drive frequency changing portion 41 may be included in any part of the control unit 1, and should be designed so as to be able to act most efficiently (namely, flexibility of designing the control unit 1 is high).

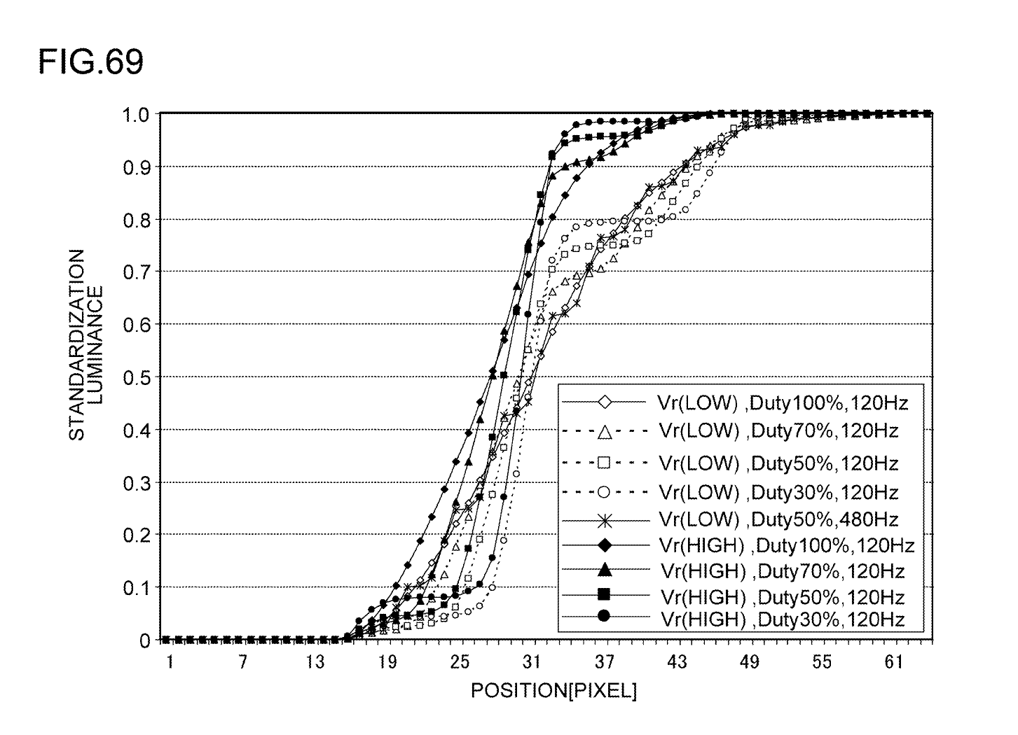

Note that, FIG. 69 illustrates a graph that integrates the graphs concerning the vicinity of the boundary between the black image and the white image displayed on the liquid crystal display panels 60 according to the first and second embodiments (in which the horizontal axis represents a pixel position in the horizontal direction HL of the liquid crystal display panel 60, and the vertical axis represents the normalized luminance of the integrated luminance normalized by the maximum value) (namely, FIG. 69 is a graph integrating FIGS. 14 to 17, FIGS. 41 to 44, and FIG. 49).

In view of this graph, the liquid crystal display device 90 is designed so as to decrease the duty factor for performing the black insertion if the response speed Vr of the liquid crystal molecules 61M is high, and to increase the duty factor for preventing the multiple outlines if the response speed Vr of the liquid crystal molecules 61M is low. In addition, in order to prevent the multiple outlines, the liquid crystal display device 90 is designed so as to set the PWM dimming signal FQ[PWM] of the LED 71 to be higher than the drive frequency (frame frequency) of the liquid crystal display panel 60.

In other words, it is sufficient that the liquid crystal display device 90 has at least one of the functions, that is, the function described above in the first embodiment for changing the duty factor concerning the PWM dimming signal, or the duty factor of the PWM dimming signal and the current value thereof, and the function described above in the second embodiment for changing the drive frequency FQ[PWM] concerning the PWM dimming signal.

<In Regard to Local Dimming>

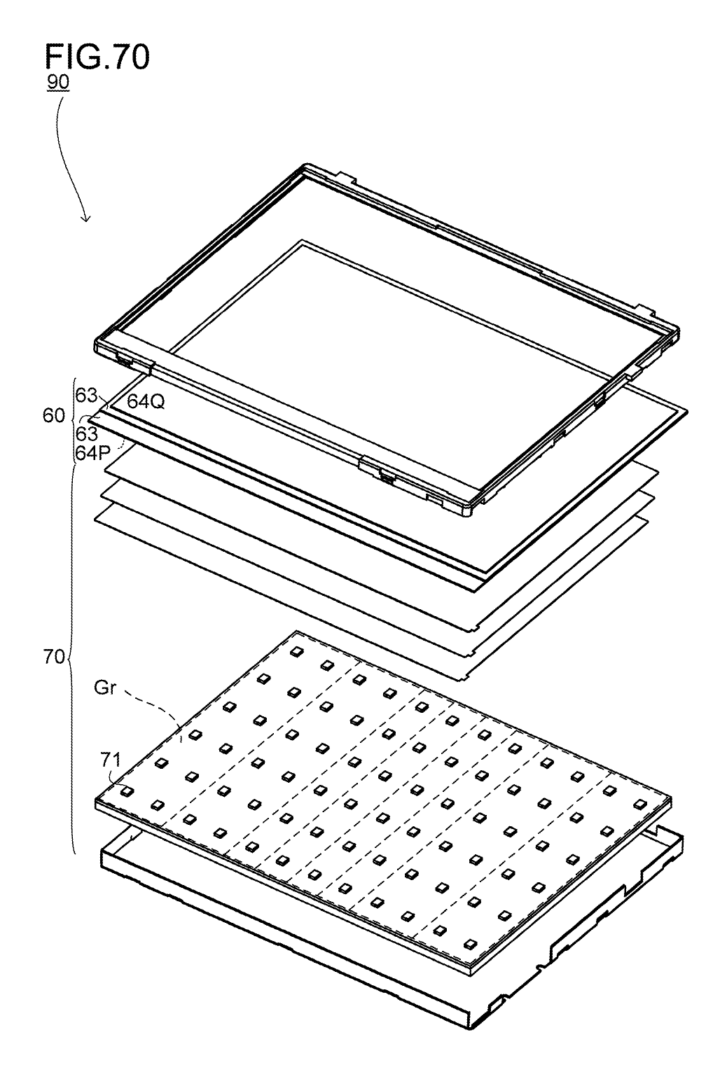

In addition, an exploded perspective view of the liquid crystal display device 90 is illustrated in FIG. 70. As illustrated in the figure, the liquid crystal display device 90 includes the backlight unit 70 in which a plurality of LEDs 71 are arranged in matrix. Then, the control unit 1 can control all the LEDs 71 entirely. However, not limiting to this, light emission can be controlled for each LED 71 (this technology is referred to as local dimming).

Further, the control unit 1 can also divide the plurality of LEDs 71 into sections and control the light emission for one or more LEDs 71 in the divided section (see the section divided by broken lines; note that, the divided section of LEDs 71 is referred to as divided section of light sources Gr). In other words, in this backlight unit 70, the LEDs 71 are arranged so as to be capable of supplying light to a part of the surface of the liquid crystal display panel 60.

Therefore, in the liquid crystal display device 90 of the first embodiment, the control unit 1 may change the duty factor, or the duty factor and the current value for each divided section of the LEDs 71. In addition, similarly, in the liquid crystal display device 90 of the second embodiment, the control unit 1 may change the drive frequency FQ[PWM] for each divided section of the LEDs 71.

Note that, as an example, if there are a plurality of LEDs 71 in the divided section (divided section of light sources Gr), the LEDs 71 may emit light in a line in a plane of the liquid crystal display panel 60, may emit light in a block divided regularly in the plane, or further may emit light according to a part area in the plane.

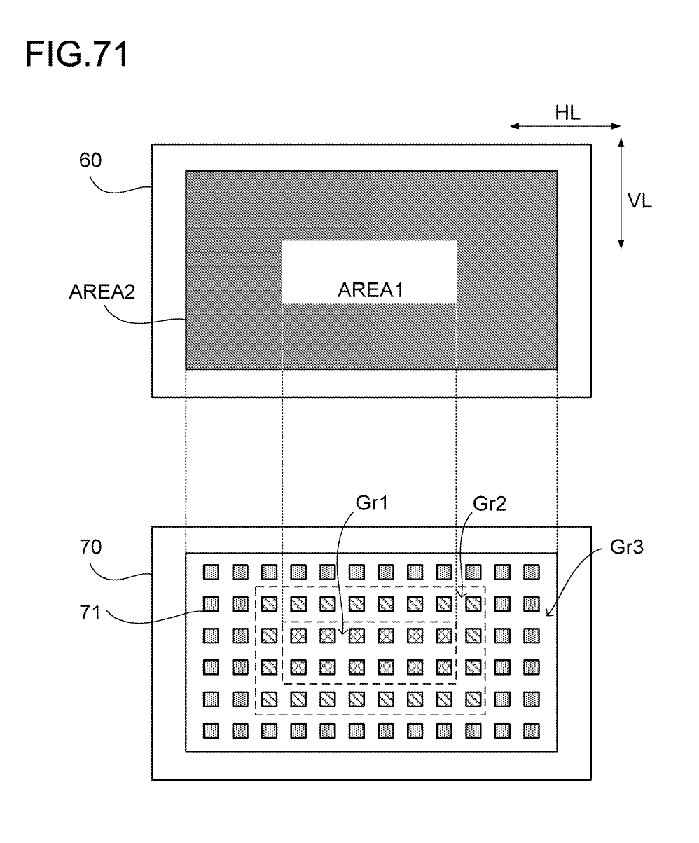

Note that, a specific example is as illustrated in FIG. 71. In the liquid crystal display panel 60 illustrated in the upper side of FIG. 71, it is supposed that a high luminance image (for example, a white image; AREA 1) is displayed in the center, and a low luminance image (for example, a gray color image; AREA 2) is displayed in the other region of the liquid crystal display panel 60. The LEDs 71 of the backlight unit 70 corresponding to such liquid crystal display panel 60 are illustrated in the lower side of FIG. 71.

It is supposed that the drive frequency FQ[PWM] for a group of LEDs 71 corresponding to AREA 1 (Gr1; LEDs 71 with cross hatching) among the LEDs 71 of the backlight unit 70 is set to 480 Hz, for example, corresponding to the white image. On the other hand, the remaining LEDs 71 correspond to the gray color image corresponding to AREA 2. Therefore, it is considered to set the frequency to 120 Hz. However, all the remaining LEDs 71 are set not to be driven at the drive frequency FQ[PWM] of 120 Hz.

Specifically, a group of LEDs 71 (Gr2; LEDs 71 with hatching) corresponding to the vicinity of the boundary between the white image (AREA 1) and the gray color image (AREA 2) is set to have the drive frequency FQ[PWM] lower than 480 Hz, for example, 360 Hz, and the other LEDs 71 (Gr3; LEDs 71 with dots) are set to be driven at the drive frequency FQ[PWM] of 120 Hz.

Usually, in the vicinity of the boundary between the white image and the gray color image, light resulting from the high drive frequency FQ[PWM] corresponding to the white image is apt to enter the side of the gray color image. In this case, even if the LED 71 is to be driven at a low drive frequency FQ[PWM] for the gray color image so as to obtain the black insertion effect, the light resulting from the high drive frequency FQ[PWM] enters the side of the gray color image. As a result, the black insertion effect can be hardly obtained.

However, if a group of LEDs 71 (Gr2) corresponding to the vicinity of the boundary between the white image and the gray color image is driven at the drive frequency FQ[PWM] of 360 Hz, the drive frequency FQ[PWM] is lower than the frequency for a group of LEDs 71 (Gr1) corresponding to the white image. Therefore, a decrease of the black insertion effect can be reduced.

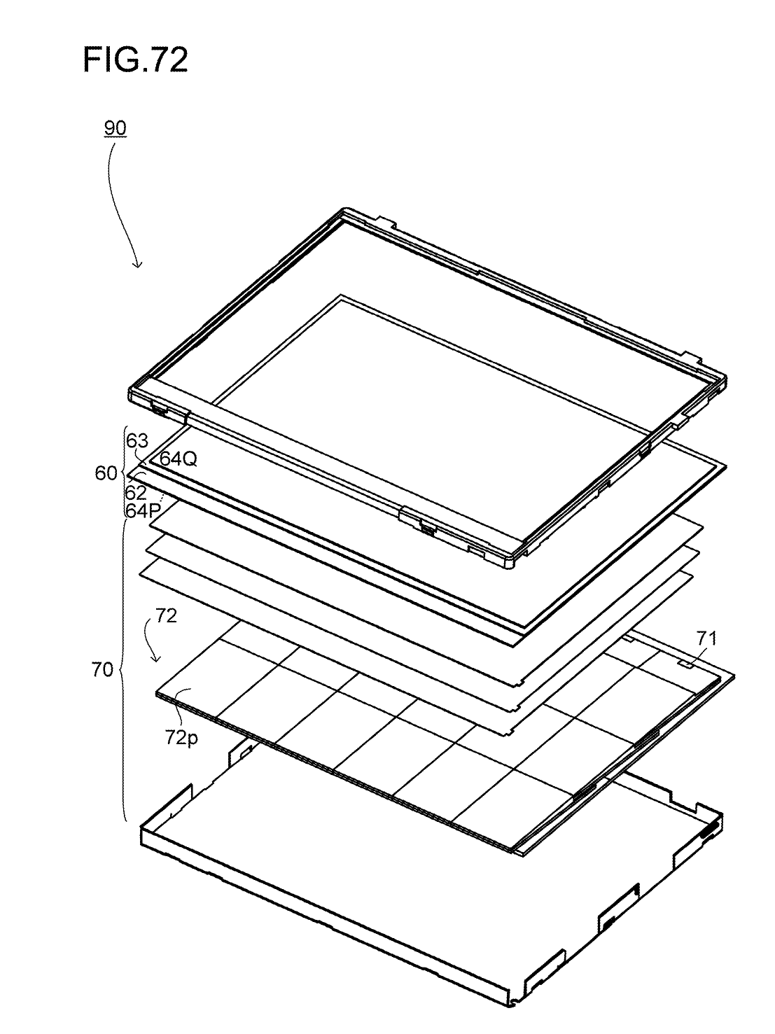

Note that, as an example of the local dimming backlight unit 70, a so-called direct type backlight unit 70 is exemplified. However, this is not a limitation. For instance, as illustrated in FIG. 72, it is possible to use a backlight unit (tandem type backlight unit) 70 including a tandem type light guide plate 72 formed by arranging wedge-shaped light guide pieces 72p.

It is because even this backlight unit 70 can control exiting light for each of the light guide pieces 72p and hence can irradiate partially a display region of the liquid crystal display panel 60. Then, because any local dimming (active area type) backlight unit 70 can irradiate the liquid crystal display panel 60 partially, power consumption can be reduced. In addition, because the duty factor or the duty factor and the current value can be changed locally, partial light intensity control can be performed. Therefore, a variation of the luminance level can be reduced, and an optimal image quality can be provided.

<Other Modes of Liquid Crystal>

In addition, in the above description, the TN mode, the VA mode, the IPS mode, the OCB mode, and the like are exemplified as modes of the liquid crystal 61, and the MVA mode as an example of the VA mode is described with reference to FIGS. 5 to 8, and further the IPS mode is described with reference to FIGS. 9 and 10. However, other liquid crystal modes may be adopted.

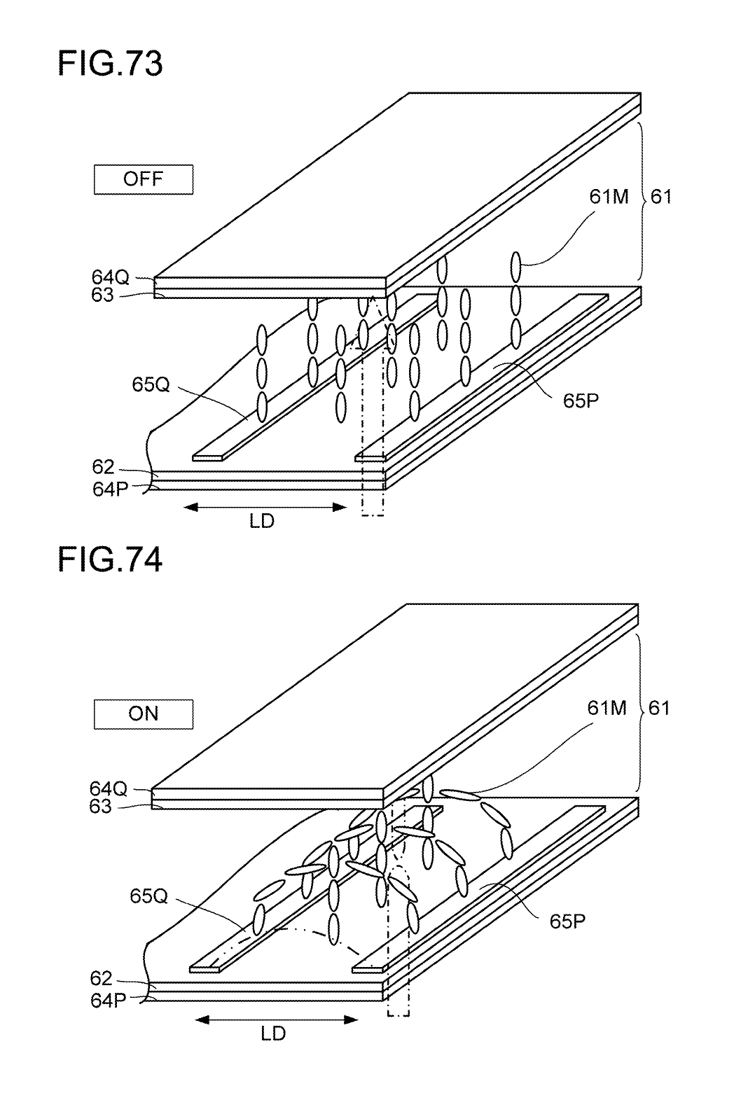

For instance, a mode of the liquid crystal 61 as illustrated in FIGS. 73 and 74 may be adopted (note that, this mode is referred to as a vertical alignment-in-plane switching (VA-IPS) mode). The liquid crystal 61 containing the liquid crystal molecules 61M illustrated in these diagrams is positive type liquid crystal having positive dielectric anisotropy (note that, arrows formed of dashed dotted lines in these diagrams indicate light).

Then, the linear pixel electrodes 65P and the linear counter electrodes 65Q are formed on one surface of the active matrix substrate 62 facing the liquid crystal 61. In particular, the electrodes 65P and 65Q are arranged to face each other (note that, the shape of the electrodes 65P and 65Q is not limited to the linear shape but may be the comb-like shape as illustrated in FIG. 11).

Further, as illustrated in FIG. 73, the liquid crystal molecules 61M are oriented so that the major axis direction thereof is along the direction perpendicular to the substrates 62 and 63 (the direction in which the substrates 62 and 63 are arranged in parallel) (for example, orientation film material (not shown) having an orientation regulating force is applied to the electrodes 65P and 65Q so that initial orientation in no electric field is designed).

Then, if the polarizing film 64P and the polarizing film 64Q are in cross-Nicol arrangement, the backlight BL that has passed through the active matrix substrate 62 does not exit to the outside (namely, the liquid crystal display panel 60 is in a normally black mode).

On the other hand, if a voltage is applied between the pixel electrode 65P and the counter electrode 65Q, the liquid crystal molecules 61M tend to incline along the direction of the electric field generated between the electrodes 65P and 65Q. Then, the electric field direction is an arcuate along the direction LD in which the pixel electrode 65P and the counter electrode 65Q are disposed in parallel (namely, an arcuate electric flux line is generated along the direction LD in which the pixel electrode 65P and the counter electrode 65Q are disposed in parallel with extension of the curve directed to the counter substrate 63; see double dot and dashed line in FIG. 74).

Then, the liquid crystal molecules 61M whose initial orientation is set to be along the direction perpendicular to the substrates 62 and 63 are affected by the arcuate electric field direction to be as follows. Specifically, as illustrated in FIG. 74, the liquid crystal molecules 61M close to an intermediate portion between the electrodes 65P and 65Q remain to be along the direction perpendicular to the substrates 62 and 63, while most other liquid crystal molecules 61M are oriented so that the major axis direction thereof is along the arcuate electric field direction (note that, though not illustrated, the liquid crystal molecules 61M close to the intermediate portion between the electrodes 65P and 65Q remain to be along the direction perpendicular to the substrates 62 and 63).

Then, if the liquid crystal molecules 61M are oriented in this manner, a part of the backlight BL that has passed through the active matrix substrate 62 exits to the outside as light along the transmission axis of the polarizing film 64Q, due to the inclination of the liquid crystal molecules 61M.

In other words, though the liquid crystal molecules 61M in the VA-IPS mode are positive type similarly to the IPS mode, if no voltage is applied to the electrodes 65P and 65Q, the liquid crystal molecules 61M are oriented so that the major axis direction thereof is along the direction perpendicular to the two substrates 62 and 63 (to be the homeotropic orientation).

Then, even if a voltage is applied to the both electrodes 65P and 65Q, some of the liquid crystal molecules 61M are oriented so that the major axis direction thereof is along the direction perpendicular to the two substrates 62 and 63, but other liquid crystal molecules 61M are oriented so that the major axis direction thereof is along the arcuate electric field direction between the electrodes 65P and 65Q when a voltage is applied to the both electrodes 65P and 65Q. As a result, when the voltage is applied, arcuately oriented liquid crystal molecules 61M and liquid crystal molecules 61M oriented like an arrow with respect to the arcuate shape (liquid crystal molecules 61M along the direction perpendicular to the substrates 62 and 63) are mixed in the liquid crystal display panel 60.

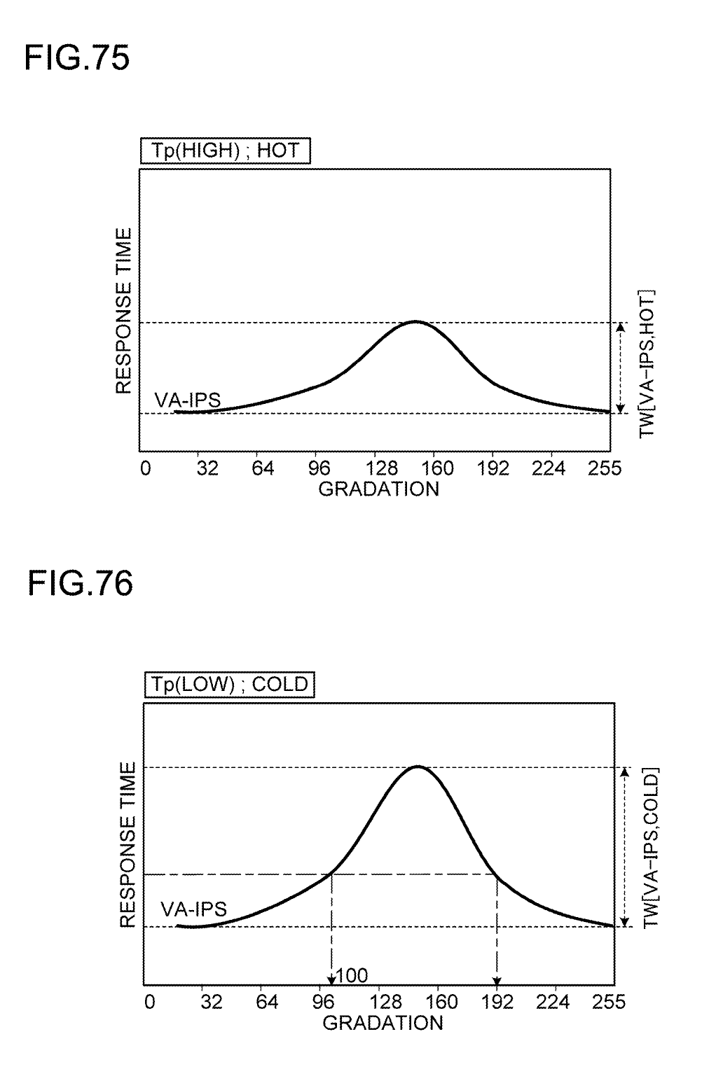

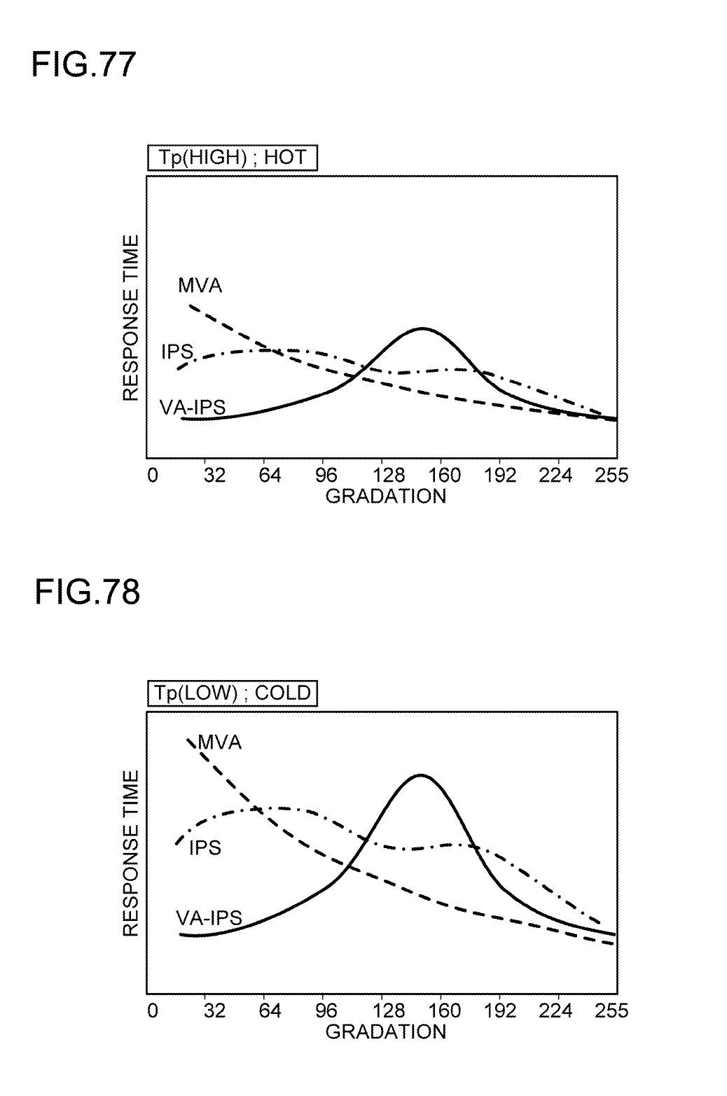

Then, due to the orientation pattern of the liquid crystal molecules 61M, a variation of the response speed Vr among gradations of the liquid crystal molecules 61M is different between the MVA mode and the IPS mode. Therefore, FIGS. 75 and 76 illustrate graphs indicating response time in inclination of the liquid crystal molecules 61M that are changing the gradation from the 0th gradation level to another gradation level in the VA-IPS mode liquid crystal 61. Note that, FIG. 75 corresponds to relatively high liquid crystal temperature Tp, and FIG. 76 corresponds to relatively high liquid crystal temperature Tp. Further, the response time in the MVA mode and the response time in the IPS mode in addition to the VA-IPS mode are illustrated in the graphs of FIGS. 77 and 78 (note that, FIG. 77 corresponds to relatively high liquid crystal temperature Tp, and FIG. 78 corresponds to relatively high liquid crystal temperature Tp).

As shown in the graphs of FIGS. 77 and 78, in the MVA mode, there is a tendency that the response time becomes shorter as the display image has higher gradation. This is because the voltage applied to the liquid crystal molecules 61M becomes relatively high in order to incline the liquid crystal molecules 61M more largely.

On the other hand, though the IPS mode also has the same tendency as the MVA mode, because of the characteristic that the liquid crystal molecules 61M are rotated, a response speed difference among gradations is smaller than the MVA mode.

However, in the case of the VA-IPS mode, the response time corresponding to the low gradation and the high gradation is relatively short, and the response time corresponding to the intermediate gradation is relatively long. The reason is as follows.

When a high gradation image is displayed in the VA-IPS mode, a relatively high voltage is applied to the liquid crystal molecules 61M similarly to the MVA mode and the IPS mode. Therefore, the response time becomes short.

In addition, if a low gradation image is displayed, though the applied voltage to the liquid crystal molecules 61M is relatively low, the liquid crystal molecules 61M are apt to incline in an arcuate shape along the arcuate electric field direction. In this case, a flow of the liquid crystal acts so as to accelerate the orientation change. Therefore, the response time becomes short (note that, a flow effect is generated also in the case of high gradation).

On the other hand, if the intermediate gradation image is displayed, the liquid crystal molecules 61M are apt to incline in a more arcuate manner than in the case where a low gradation image is displayed. In a vicinity of the intermediate portion between the electrodes 65P and 65Q (specifically, a portion close to the center of the arcuate electric field), there are liquid crystal molecules 61M that are always along the direction perpendicular to the substrates 62 and 63.

Therefore, if other liquid crystal molecules 61M are inclined to lean to the liquid crystal molecules 61M along the direction perpendicular to the substrates 62 and 63, energy density is increased in the region where the liquid crystal molecules 61M are gathered. Then, if the energy density is increased in this way, more energy is necessary to incline the liquid crystal molecules 61M. Therefore, the response speed Vr becomes low.

Because of the above-mentioned reason, in the case of the VA-IPS mode, there is illustrated the graph line different from those in the MVA mode and the IPS mode. Note that, even in the VA-IPS mode, as shown in FIG. 75 and FIG. 76, it is understood that a difference TW between a maximum value and a minimum value of the response time is different depending on the liquid crystal temperature Tp (the difference TW[VA-IPS, HOT] at high liquid crystal temperature Tp is smaller than the difference TW[VA-IPS, COLD] at low liquid crystal temperature Tp).

Therefore, in the case where the difference TW is large in the graph line, if there is a difference among occupancy of a low gradation range, occupancy of an intermediate gradation range, and occupancy of a high gradation range in an image (one frame image), image quality deterioration may occur depending on characteristics of the backlight BL.

For instance, if the occupancy of the intermediate gradation range is high (for example, the gradation range of 100 or larger and 192 or smaller in the entire gradation range of 0 or larger and 255 or smaller) at the low liquid crystal temperature Tp of approximately 20° C., the response speed Vr of the liquid crystal molecules 61M becomes relatively low. If the duty factor of the PWM dimming signal is set to be low for such liquid crystal molecules 61M, multiple outlines may occur as illustrated in FIG. 15. Therefore, in this case, the duty factor of the PWM dimming signal is set to be high.

On the contrary, if the occupancy of the low gradation range and the occupancy of the high gradation range are high, the response speed Vr of the liquid crystal molecules 61M becomes relatively high. Therefore, in this case, the duty factor of the PWM dimming signal should be set to be low (namely, so that the black insertion effect of the PWM dimming signal can be obtained conspicuously).

Therefore, even in the VA-IPS mode, similarly to the MVA mode described above in the first embodiment, the control unit 1 preferably sets the duty factor of the PWM dimming signal using the histogram data HGM.

In other words, the control unit 1 divides the entire gradation of the histogram data HGM and judges whether or not occupancy of at least one specific gradation range among the divided gradation ranges exceeds the occupancy threshold value. Then, the duty factor in the case where the occupancy threshold value is exceeded is set to be higher than the duty factor in the case where the occupancy threshold value is not exceeded. On the other hand, the duty factor in the case where the occupancy threshold value is not exceeded is set to be lower than the duty factor in the case where the occupancy threshold value is exceeded (the current value AM may be changed according to the change of the duty factor).

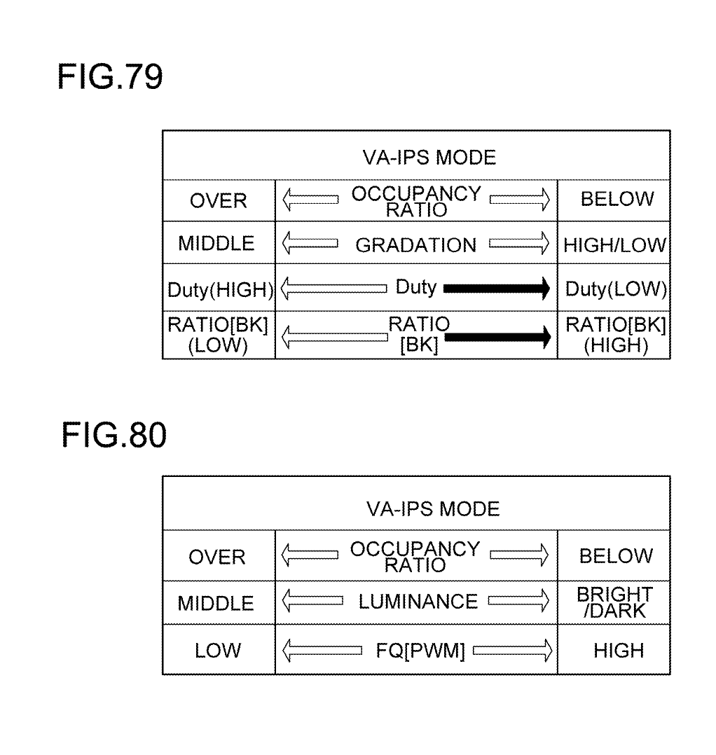

For instance, in the VA-IPS mode liquid crystal 61, if the liquid crystal temperature Tp is approximately 20° C. and if the occupancy of a specific gradation range from 100th gradation level to 192nd gradation level exceeds 50% (namely, if the occupancy threshold value is 50%, and if the occupancy threshold value is exceeded), the duty factor is set to be relatively high, such as 100% or 70%. On the other hand, if the occupancy is 50% or smaller, the duty factor is set to be relatively low, such as 50% or 30% (note that, a tendency of the magnitude of the duty factor corresponding to a magnitude relationship of the occupancy is shown in a table of FIG. 79).

Further, even in the VA-IPS mode, similarly to the MVA mode described above in the second embodiment, the control unit 1 preferably sets the drive frequency FQ[PWM] of the PWM dimming signal using the histogram data HGM.

In other words, as described above, the control unit 1 divides the entire gradation of the histogram data HGM and judges whether or not occupancy of at least one specific gradation range among the divided gradation ranges exceeds the occupancy threshold value. Then, the drive frequency FQ[PWM] in the case where the occupancy threshold value is exceeded is set to be lower than the drive frequency in the case where the occupancy threshold value is not exceeded. On the other hand, the drive frequency FQ[PWM] in the case where the occupancy threshold value is not exceeded is set to be higher than the drive frequency in the case where the occupancy threshold value is exceeded.

For instance, in the VA-IPS mode, if the liquid crystal temperature Tp is approximately 20° C. and if the occupancy of a specific gradation range from 100th gradation level to 192nd gradation level exceeds 50%, in order to improve motion picture performance, the drive frequency FQ[PWM] is set to be low, such as 120 Hz. On the other hand, the drive frequency FQ[PWM] in the case where the occupancy is 50% or smaller is set to be high, such as 480 Hz, so as to prevent the multiple outlines (note that, a tendency of the magnitude of the drive frequency FQ[PWM] corresponding to a magnitude relationship of the occupancy is shown in a table of FIG. 80).

Note that, similarly to the MVA mode and the IPS mode, even in the case of the VA-IPS mode, at least one of the specific gradation range and the occupancy threshold value may be changed according to temperature data of the panel thermistor 83 (namely, according to the liquid crystal temperature Tp). For instance, even in the case of the liquid crystal temperature Tp as shown in FIG. 75, the specific gradation range may be set.

<In Regard to Program>

By the way, setting of the duty factor for the PWM dimming signal, or setting of the duty factor and the current value, or further setting of the drive frequency FQ[PWM] is realized by an LED control program (light source control program). Then, this program is a program that can be executed by a computer and may be recorded on a recording medium that can be read by a computer. It is because the program recorded on the recording medium can be portable.

Note that, as the recording medium, there are a tape system such as a separative magnetic tape or a cassette tape, a disc system such as a magnetic disk or an optical disc including a CD-ROM, a card system such as an IC card (including a memory card) or an optical card, and a semiconductor memory system such as a flash memory.

In addition, the control unit 1 may obtain the LED control program by communication via a communication network. Note that, the communication network may be a wired or wireless network including the Internet, an infrared communication, or the like.

### REFERENCE SIGNS LIST

1 control unit
10 video signal processing portion
11 timing adjusting portion
12 histogram processing portion
13 calculation processing portion
14 duty factor setting portion
15 current value setting portion
16 viewing mode setting portion
17 memory
18 histogram unit
20 LCD controller
30 LED controller
31 LED controller setting register group
32 LED driver control portion
33 serial to parallel conversion portion
34 individual variation correction portion
35 memory
36 temperature correction portion
37 time-deterioration correction portion
38 parallel to serial conversion portion
41 drive frequency changing portion
50 microcomputer unit
51 main microcomputer
60 liquid crystal display panel
61 liquid crystal
61M liquid crystal molecule
62 active matrix substrate
63 counter substrate
64P polarizing film
64Q polarizing film
65P pixel electrode (first electrode/second electrode)
65Q counter electrode (second electrode/first electrode)
66P slit (first slit/second slit)
66Q slit (second slit/first slit)
67P rib (first rib/second rib)
67Q rib (second rib/first rib)
70 backlight unit
71 LED (light source, light emitting element)
81 gate driver
82 source driver
83 panel thermistor (first temperature sensor)
84 environmental illuminance sensor (illuminance sensor)
85 LED driver
86 LED thermistor
87 LED luminance sensor
90 liquid crystal display device

1. A liquid crystal display device, comprising:
a liquid crystal display panel that displays an image using liquid crystal whose orientation is changed in response to voltage application;
a backlight unit incorporating a PWM dimming type light source that emits light to be supplied to the liquid crystal display panel; and
a control unit that controls the liquid crystal display panel and the backlight unit,
wherein the control unit obtains response speed data of orientation change of the liquid crystal molecules in the liquid crystal and changes a duty factor of a PWM dimming signal according to the response speed data.

2. A liquid crystal display device according to claim 1, wherein the control unit has at least one arbitrary response speed data threshold value, sets a plurality of arbitrary response speed data ranges with respect to the at least one response speed data threshold value as a boundary, and changes the duty factor for each of the plurality of response speed data ranges.

3. A liquid crystal display device according to claim 2, wherein the duty factor is changed for the each of the plurality of response speed data ranges so as to have an opposite relationship to a magnitude relationship of data values in the plurality of response speed data ranges.

4. A liquid crystal display device according to claim 3, wherein, when the control unit sets two response speed data ranges with respect to one response speed data threshold value, the control unit is configured to;
drive the light source at a duty factor of arbitrary X % or smaller if the response speed data is contained in higher one of the two response speed data ranges which is equal to or larger than the response speed data threshold value; and
drive the light source at a duty factor of more than the arbitrary X % if the response speed data is contained in lower one of the two response speed data ranges which is smaller than the response speed data threshold value.

5. A liquid crystal display device according to claim 4, wherein the X % is 50%.

6. A liquid crystal display device according to claim 1, wherein:
the light source is of PWM dimming type and is also of current dimming type; and
the control unit changes a current value according to the duty factor to drive the light source.

7. A liquid crystal display device according to claim 6, wherein the control unit changes the current value of the PWM dimming signal in a case of driving at a duty factor other than 100%, so that an integrated amount of light emission in one cycle period of the PWM dimming signal is equal to an integrated amount of light emission at a duty factor of 100% in a period corresponding to the one cycle period.

8. A liquid crystal display device according to claim 1, further comprising a first temperature sensor that measures temperature of the liquid crystal,
wherein the control unit includes a storing portion that stores the response speed data of the liquid crystal molecules depending on liquid crystal temperature and stores at least one piece of the response speed data as a response speed data threshold value, and associates temperature data of the first temperature sensor with the liquid crystal temperature to obtain the response speed data.

9. A liquid crystal display device according to claim 1, wherein:
the control unit includes a histogram unit that generates a histogram of video data, to thereby generate histogram data indicating a frequency distribution for gradation;
the control unit divides the entire gradation of the histogram data and judges whether or not occupancy of at least one specific gradation range among divided gradation ranges exceeds an occupancy threshold value; and
the control unit is configured to:
set the duty factor in a case where the occupancy threshold value is exceeded to be higher than the duty factor in a case where the occupancy threshold value is not exceeded, and set the duty factor in the case where the occupancy threshold value is not exceeded to be lower than the duty factor in the case where the occupancy threshold value is exceeded; or
set the duty factor in the case where the occupancy threshold value is exceeded to be higher than the duty factor in the case where the occupancy threshold value is not exceeded, and set the duty factor in the case where the occupancy threshold value is not exceeded to be lower than the duty factor in the case where the occupancy threshold value is exceeded, and further change a current value of the PWM dimming signal according to the duty factor.

10. A liquid crystal display device according to claim 9, further comprising a first temperature sensor that measures temperature of the liquid crystal,
wherein the control unit includes a storing portion that stores the occupancy threshold value, and changes at least one of the specific gradation range and the occupancy threshold value of the occupancy according to temperature data of the first temperature sensor.

11. A liquid crystal display device according to claim 1, wherein:
the control unit includes an FRC processing portion that performs frame rate control processing; and
the control unit changes the duty factor, or the duty factor and a current value of the PWM dimming signal according to presence or absence of the frame rate control processing of the FRC processing portion.

12. A liquid crystal display device according to claim 11, wherein the duty factor in a case where the frame rate control processing is present is lower than the duty factor in a case where the frame rate control processing is absent.

13. A liquid crystal display device according to claim 1, wherein:
the control unit includes a viewing mode setting portion that switches a viewing mode of the liquid crystal display panel; and
when the viewing mode setting portion switches the viewing mode, the control unit changes the duty factor, or the duty factor and a current value of the PWM dimming signal according to the selected viewing mode.

14. A liquid crystal display device according to claim 13, wherein, when the viewing mode setting portion sets a high motion picture level viewing mode and a low motion picture level viewing mode according to a motion picture level of video data, the duty factor is changed for each of the selected viewing modes so as to have an opposite relationship to a magnitude relationship of the motion picture level in a plurality of the viewing modes.

15. A liquid crystal display device according to claim, wherein, when the viewing mode setting portion sets a high contrast level viewing mode and a low contrast level viewing mode according to a contrast level of video data, the duty factor is changed for each of the selected viewing modes so as to have an opposite relationship to a magnitude relationship of the contrast level in a plurality of the viewing modes.

16. A liquid crystal display device according to claim 1, wherein the control unit obtains external illuminance data and changes the duty factor, or the duty factor and a current value of the PWM dimming signal according to the external illuminance data.

17. A liquid crystal display device according to claim 16, wherein the duty factor is changed for each of a plurality of the illuminance data ranges so as to have an opposite relationship to a magnitude relationship of a data value of each of the plurality of illuminance data ranges.

18. A liquid crystal display device according to claim, further comprising an illuminance sensor that measures external illuminance,
wherein the illuminance data comprises illuminance measured by the illuminance sensor.

19. A liquid crystal display device according to claim 1, wherein:
the liquid crystal is interposed between two substrates included in the liquid crystal display panel;
one of the two substrates has one surface facing the liquid crystal side, on which a first electrode is mounted;
another one of the two substrates has one surface facing the liquid crystal side, on which a second electrode is mounted;
liquid crystal molecules contained in the liquid crystal are of negative type; and
at least a part of the liquid crystal molecules is oriented so that a major axis direction thereof is along a direction perpendicular to the two substrates when no voltage is applied to the first electrode and the second electrode, and the major axis direction thereof crosses a direction of an electric field between the first electrode and the second electrode when a voltage is applied to the first electrode and the second electrode.

20. A liquid crystal display device according to claim 19, wherein:
the first electrode has a first slit or a first rib formed therein;
the second electrode has a second slit or a second rib formed therein; and
the direction of the electric field between the first electrode and the second electrode crosses the direction perpendicular to the two substrates.

21. A liquid crystal display device according to claim 1, wherein:
the liquid crystal is interposed between two substrates included in the liquid crystal display panel;
one of the two substrates has one surface facing the liquid crystal side, on which a first electrode and a second electrode are arranged to be opposed to each other; and
liquid crystal molecules contained in the liquid crystal are of positive type and are oriented so that a major axis direction thereof is along an in-plane direction of the one surface and crosses a direction in which the first electrode and the second electrode are disposed in parallel when no voltage is applied to the first electrode and the second electrode.

22. A liquid crystal display device according to claim 1, wherein the control unit synchronizes a last timing of one frame period with a last timing of a high level period of the PWM dimming signal.

23. A liquid crystal display device according to claim 1, wherein the control unit matches a low level period of the PWM dimming signal with a period of at least one frame in continuous frames.

24. A liquid crystal display device according to claim 1, wherein:
a plurality of the light sources are arranged so as to be capable of supplying light to a part of a surface of the liquid crystal display panel; and
provided that the plurality of the light sources are divided into sections so that one or more light sources in the divided section are regarded as divided section of light sources, the control unit changes the duty factor, or the duty factor and a current value of the PWM dimming signal for each divided section of light sources.

25. A liquid crystal display device according to claim 24, wherein, when a number of light sources in the divided section is plural, the divided section of light sources emits light in a line in a plane of the liquid crystal display panel, in a block divided regularly in the plane, or in a part area in the plane.

26. A liquid crystal display device according to claim 1, wherein the control unit has a function of performing an overdrive of an applied voltage to the liquid crystal, and changes the duty factor, or the duty factor and a current value of the PWM dimming signal according to presence or absence of the overdrive.

27. A light source control method for a liquid crystal display device comprising:
a liquid crystal display panel including liquid crystal whose orientation is changed in response to voltage application; and
a backlight unit incorporating a PWM dimming type light source that emits light to be supplied to the liquid crystal display panel,
the light source control method comprising the step of obtaining response speed data of orientation change of the liquid crystal molecules in the liquid crystal and changing a duty factor of a PWM dimming signal according to the response speed data.
